(19) United States
(12) Patent Application Publication
(10) Pub. No.: US 2022/0361653 A1
(43) Pub. Date: Nov. 17, 2022

(54) ORAL HYGIENE DEVICE

(71) Applicant: TRISA HOLDING AG, Triengen (CH)

(72) Inventors: Peter GROSS, Sempach-Stadt (CH); Martin ZWIMPFER, Luzern (CH)

(73) Assignee: TRISA HOLDING AG, Triengen (CH)

(21) Appl. No.: 17/767,121

(22) PCT Filed: Oct. 9, 2020
(86) PCT No.: PCT/EP2020/078465

§ 371 Date: Apr. 7, 2022

(30) Foreign Application Priority Data
Oct. 9, 2019 (EP) 19202289.5

(51) Int. Cl. A46B 5/00; A46B 5/02

(52) U.S. Cl. CPC A46B 5/0095; A46B 5/026; A46B 2200/1066

(57) ABSTRACT

An oral hygiene device, in particular a toothbrush, includes at least one application unit and includes at least one handle unit which is connected to the application unit and which has at least one material volume body, wherein the handle unit includes at least one essential hollow-space structure, which is at least substantially delimited by the material volume body and which extends at least over a substantial portion of a main extent of the at least one handle unit.

### PRIOR ART

The invention concerns an oral hygiene device.

An oral hygiene device, in particular a toothbrush, has already been proposed, with at least one application unit and with at least one handle unit which is connected to the application unit and which comprises at least one material volume body.

The objective of the invention is in particular to provide a generic device having improved characteristics regarding material efficiency, ergonomics and/or ecology. The objective is achieved according to the invention by the features of patent claim 1 while advantageous implementations and further developments of the invention may be gathered from the subclaims.

### ADVANTAGES OF THE INVENTION

The invention is based on an oral hygiene device, in particular a toothbrush, with at least one application unit and with at least one handle unit which is connected to the application unit and which comprises at least one material volume body. It is proposed that, in particular in at least one implementation variant, the handle unit comprises at least one essential hollow-space structure, which is at least substantially delimited by the material volume body and which extends at least over a substantial portion of a main extent of the at least one handle unit.

The oral hygiene device preferably consists of an application unit with bristles and of the handle unit, wherein the application unit in particular comprises a neck region which connects the application unit to the handle unit. All sub-elements may be implemented of at least one hard component and/or of one or several soft component/s. Customary hard components and/or soft components as well as sustainable hard components and/or soft components may be used. It is in particular intended to create an oral hygiene device providing a contribution to sustainability and/or ecology. For this purpose the following criteria are proposed, individually or in combination:
(i) Sustainable materials are used for the handle unit and/or for the application unit and/or for the bristles.
(ii) The used resources, respectively the quantity of the material employed, is minimized, thus reducing an amount of energy required for the production as well as a quantity of plastic waste. Moreover, a particularly lightweight handle unit is proposed.
(iii) The materials utilized for the handle unit, the application unit and the bristles are minimized. Preferably only one, two or three materials are utilized.

The implementation of the oral hygiene device according to the invention allows providing advantageous characteristics in regard to sustainability and ergonomics of the oral hygiene device. In particular, advantageous grippability of the handle unit over the entire handle region is achievable. Furthermore, in this way in particular a material volume of the handle unit can be kept small, in particular without affecting ergonomics of the oral hygiene device, in particular without affecting grippability. It is in particular possible to keep a material input for the oral hygiene device at a low level. This in particular allows providing an advantageously ecological and/or sustainable oral hygiene device.

An “oral hygiene device” is in particular to mean a toothbrush and/or an interdental cleaner and/or a flosser and/or a tongue cleaner and/or a toothpick. Advantageously the oral hygiene device is realized as a toothbrush, in particular a manual toothbrush, preferentially a children's or grown-up toothbrush, advantageously a purely manual toothbrush. In particular, the oral hygiene device differs from an electric toothbrush. The oral hygiene device may herein be a one-way toothbrush, a re-usable toothbrush or an exchangeable-head toothbrush. However, generally the oral hygiene device may also be implemented by a brush product. By a “brush product” are/is in particular an oral hygiene brush and/or a cosmetic brush and/or a hairbrush and/or a household brush to be understood. For example, manual toothbrushes like re-usable brushes, exchangeable-head toothbrushes, one-way toothbrushes or single-tuft brushes, electrical toothbrushes as well as hybrid toothbrushes, interdental cleaners, in particular interdental cleaners with twisted-in bristles (also referred to as interdental brushes), in an injection-molded form or as flossers, tongue cleaners and/or dental floss, are conceivable as oral hygiene brushes. For example, mascara brushes, nail polish brushes, face brushes, applicators, in particular hair tint applicators, massaging apparatuses, makeup brushes, shaving brushes and/or wet-shavers or other bodycare products are conceivable as cosmetic brushes. For example, dishwashing brushes, floor mops and/or brooms are conceivable as household brushes.

The oral hygiene device in particular has a longitudinal axis, which is advantageously arranged at least substantially parallel to a main extent direction of the oral hygiene device. Preferentially the longitudinal axis extends at least section-wise within the oral hygiene device, and in particular through the center of mass of the oral hygiene device. In particular, the longitudinal axis of the oral hygiene device is a central axis of the oral hygiene device and/or a central axis of the handle unit. By a “central axis” of an object is here in particular an imaginary axis to be understood which extends within the object parallel to a main extent direction of the object, intersecting with the object in maximally two points. “At least substantially parallel” is here in particular to mean an orientation of a direction relative to a reference direction, in particular in a plane, wherein the direction has a deviation from the reference direction that is in particular smaller than 8°, advantageously smaller than 5°, and especially advantageously smaller than 2°. By a “main extent direction” of an object is here in particular a direction to be understood which extends parallel to a longest edge of a smallest imaginary rectangular cuboid just still completely enclosing the object. A “main extent” of an object is in particular to mean, in this context, an extent of a longest edge of a smallest imaginary rectangular cuboid just still enclosing the object.

In particular, the oral hygiene device has a length, in particular parallel to the longitudinal axis of the oral hygiene device and measured parallel to a support surface, of 140 mm to 210 mm and preferably of 165 mm to 185 mm, wherein other lengths, in particular longer or shorter lengths, are of course also conceivable. In particular, the oral hygiene device has a maximum width, in particular parallel to a width axis of the oral hygiene device, advantageously perpendicularly to the longitudinal axis and/or parallel to a main extent plane of the oral hygiene device and/or of the handle unit, of 10 mm to 20 mm and preferably of 12 mm to 17 mm. Furthermore, the oral hygiene device with inserted filaments/bristles in particular has a height, in particular measured parallel to a height axis and perpendicularly to the support surface, of 12 mm to 25 mm and preferably of 15 mm to 19 mm. A pure body thickness of the oral hygiene device, in particular parallel to the height axis, is in particular 4 mm to 15 mm and preferably 5 mm to 12 mm. Here the term “height” in particular refers to a state of the oral hygiene device in which it is deposited, for example on a surface like a tabletop, a washbasin, an upper side of a piece of furniture, or the like, in particular such that the longitudinal axis is arranged parallel to the surface. By a “main extent plane” of an object is in particular a plane to be understood which is parallel to a largest side surface of a smallest imaginary rectangular cuboid just still enclosing the object completely, and which extends through the center point of the rectangular cuboid.

Advantageously the application unit comprises at least one cleaning zone, which is configured for a tooth-cleaning and/or tongue-cleaning application, in particular in an oral cavity of a user. Preferably the cleaning region comprises at least one cleaning unit, in particular at least one brush head, advantageously a toothbrush head, preferentially with several bristles and/or bristle bundles and/or injection-molded cleaning elements, respectively injection-molded bristles, and/or soft-elastic cleaning elements. However, the cleaning unit may, for example, also be realized as an interdental brush and/or as a single tuft (e. g. a single large bristle bundle) and/or as a bow tensioned with dental floss, in particular a flosser, or something like that. Advantageously the application unit further comprises at least the neck element, which is preferentially, in particular directly and/or integrally, connected with the cleaning zone. “Integrally” is in particular to mean at least connected by substance-to-substance bond, for example by a welding process, a gluing process, an injection-molding process and/or any other process that is deemed expedient by someone skilled in the art, and/or advantageously formed in one piece, like for example by a production from a cast and/or by a production in a one-component or multi-component injection-molding procedure, and advantageously from a single blank. “Configured” is in particular to mean specifically designed and/or equipped. By an object being configured for a certain function is in particular to be understood that the object fulfills and/or executes said certain function in at least one application state and/or operation state.

The oral hygiene device in particular has a front side and a rear side, which are in particular arranged facing away from each other. Preferably the cleaning zone is arranged at the front side of the oral hygiene device. The front side is in particular a side of the oral hygiene device visible in a view direction that is perpendicular to the longitudinal axis of the oral hygiene device and perpendicular to the width axis of the oral hygiene device. In particular, the side of the brush which the thumb is laid upon is referred to as the front side of the oral hygiene device. Usually the front side is also the side of the brush which the bristle field is directed to. The rear side is advantageously equivalent to a side of the oral hygiene device that is visible in view direction that is opposed thereto. The side of the toothbrush that is opposed to the bristle field is referred to as the rear side of the oral hygiene device. In particular, a side situated on the left in a perpendicular view onto the front side of the oral hygiene device is referred to as the lefthand side of the oral hygiene device. In particular, a side situated on the right in a perpendicular view onto the front side of the oral hygiene device is referred to as the righthand side of the oral hygiene device. In particular, an end of the oral hygiene device in which the cleaning zone is arranged is referred to as the upper side. In particular, an end of the oral hygiene device situated opposite the upper side and closest to the handle region is referred to as the underside.

Preferably the handle unit comprises at least one handle element, which is advantageously configured to be held with a hand. Preferentially the handle element is realized so as to be at least partly waisted. This advantageously permits secure holding and optimizes ergonomics. Particularly preferentially the handle element is implemented in an elongate fashion, a longitudinal axis of the handle element advantageously corresponding to the longitudinal axis of the oral hygiene device. The handle element is implemented at least partly, in particular completely, of at least one hard component. It would also be conceivable that the handle element is additionally implemented of one or several soft components. Preferably the material volume body is implemented at least largely, in particular completely, of at least one hard component. In particular, the handle element advantageously comprises at least one thumb-gripping region and/or at least one hand gripping region. Advantageously the thumb-gripping region is arranged on the front side of the oral hygiene device, and in particular on a front side of the handle element. It is conceivable that the thumb-gripping region and/or the hand gripping region comprise/s at least one element and/or at least one surface structuring of at least one soft component and/or of at least one hard component.

Advantageously the handle region comprises at least one hand gripping element. Preferably a main extent direction of the hand gripping element is arranged at least substantially parallel to the longitudinal axis of the oral hygiene device. Advantageously the hand gripping element comprises at least one surface structure element, especially advantageously a plurality of surface structure elements, which are realized so as to be at least substantially identical or at least geometrically similar to the above-described surface structure elements of the thumb-gripping region. Preferably the surface structure elements of the hand gripping element are arranged—in particular at least in pairs—in each case behind one another along the longitudinal axis of the oral hygiene device.

The components utilized for the production may in particular be categorized in the following manner:
Customary materials: materials, essentially new materials, which are mostly petrol-based.
Sustainable materials: as listed below and described later on, preferably bio-based, degradable and/or recycled.
   Bio-based materials: materials made of renewable resources by more than 40%, in particular by more than 60%, preferably by more than 80% and particularly preferentially by more than 100%.
   A possible further feature of bio-based materials is in particular that bio-based materials are bio-degradable. Preferably these materials are not based on nutrients, like in particular corn, sugarcane, etc.
   Bio-degradable materials: materials which are bio-degradable according to usual standards, one of which is in particular (industrial or non-industrial) compostability. Herein materials made of renewable raw materials, like in particular petrochemical raw materials, may have this feature.
   Recycled materials: materials originating from a recycling process, like for example post-consumer recycled materials, post-industrial recycled materials, ocean waste plastics or social plastic.

Degradability of the material components is often considered in a context of industrial compostability in accordance with standards. Standards applied in this context are, among others, EN 13432, ISO 17088, DIN EN 14995 and/or ASTM D 6400.

The utilized materials may be recyclable materials. Advantageously there is an opportunity of recycling for recyclable materials after usage. Particularly preferentially materials are utilized which are capable of joining an existing recycling stream, like polyester, polyethylene (PE), polypropylene (PP).

In the context of the present disclosure almost any hard components and soft components are possible, which will be purposefully and appropriately combined and/or selected by someone skilled in the art. Possible hard components are, for example styrene polymerizates like styrene-acrylonitrile (SAN), polystyrene (PS), acrylonitrile butadiene styrene (ABS), styrene methyl methacrylate (SMMA), styrene-butadiene (SB) or the like. A hard component may furthermore comprise polyolefins like polypropylene (PP), polyethylene (PE) or the like, in particular also in the form of high-density polyethylene (HDPE) or low-density polyethylene (LDPE). There may furthermore be polyesters, like for example polyethylene terephthalate (PET), in particular in the form of acid-modified polyethylene terephthalate (PETA), glycol-modified polyethylene terephthalate (PETG), polybutylene terephthalate (PBT), acid-modified polycyclohexylenedimethylene terephthalate (PCT-A), glycol-modified polycyclohexylenedimethylene terephthalate (PCT-G) or something like that. Furthermore, a usage of cellulose derivatives is conceivable, like for example cellulose acetate (CA), cellulose acetate butyrate (CAB), cellulose propionate (CP), cellulose acetate phthalate (CAP), cellulose butyrate (CB) or something like that. A hard component may furthermore comprise, for example, polyamides (PA) like PA 6.6, PA 6.10, PA 6.12 or something like that; polymethylmethacrylate (PMMA), polycarbonate (PC), polyoxymethylene (POM), polyvinyl chloride (PVC), polyurethane (PUR), polyimide (PA) or more of these. In particular, polyethylene (PE) and/or polyurethane (PUR) are usable as a hard component and/or as a soft component. In particular, a hard component has an elasticity modulus of at least 1,000 N/mm² and advantageously of at least 1,300 N/mm², and/or of maximally 2,400 N/mm² and advantageously of maximally 1,800 N/mm². Preferentially polypropylene (PP) is used as a hard component. At least some of the materials listed under hard-component materials may be sustainable materials. In particular, materials having a cellulose fraction are at least partially bio-based.

Advantageously hard components are used for stable and/or structure-bearing elements, in particular in the handle element and/or in a carrier element of the application unit and/or of a fastening unit or the like. Preferably the oral hygiene device or at least a base body of the oral hygiene device comprises a single hard component, which may be implemented of one of the materials mentioned or of a mixture of such materials. However, combinations of different hard components are also conceivable, wherein these may, for example, be processed in a two-component and/or multi-component injection molding and/or glued and/or welded with, in particular ultrasound-welded, with each other.

Alternatively or additionally several hard components may be employed which do not form a material connection in a two-component and/or multi-component injection molding. It is in particular conceivable that in such a case a form-fit connection is created, which is for example realized as at least one undercut and/or at least one breakthrough and/or at least one at least partial overmold or the like between hard components. It is in particular conceivable, for example, that after an injection-molding process a second hard component, which is in particular injection-molded onto a first hard component, dwindles and/or shrinks and advantageously forms a shrink connection. Suitable combinations may be, for example, polypropylene-polyester, polypropylene-sustainable material, polypropylene-styrene acrylonitrile or other combinations. In such a combination propylene serves for creating a substance-to-substance bond to the soft component.

Soft components may be, for example, thermoplastic styrene elastomers (TPE-S), like for example a styrene-ethylene-butylene-styrol copolymer (SEBS), a styrene-butadiene-styrene copolymer (SBS), or something like that. It is moreover conceivable to use thermoplastic polyurethane elastomers (TPE-U), thermoplastic polyamide elastomers (TPE-A), thermoplastic polyolefin elastomers (TPE-O), thermoplastic polyester elastomers (TPE-E), or something like that. It is also possible for a soft component to contain, for example, at least one silicone. Advantageously a soft component has a Shore A hardness of maximally 90, advantageously maximally 50 and especially advantageously no more than 30. Preferably at least one soft component forms a material connection with at least one hard component, in particular in at least one two-component and/or multi-component injection molding, advantageously via at least one overmolding and/or insert-molding. The materials listed for the soft component may be at least partly sustainable materials. The soft component may be a material mixture of a sustainable material and a non-sustainable soft component. For example, the soft component may be mixture of recycled polypropylene and a soft component. Recycled polypropylene may be a raw material for producing a soft component. The weight proportion of recycled polypropylene in the soft component is more than 10%, preferentially more than 20%, particularly preferentially more than 30%.

Advantageously it is conceivable that a hard component used and a soft component used have different colors, thus allowing a realization of surface structures, letterings, motifs, and the like by a suitable implementation of base body and soft element.

It is furthermore proposed that the at least one application unit comprises a brush head, in particular a toothbrush head. The application unit advantageously comprises at least one cleaning unit, in particular a toothbrush head, with bristles. Advantageously the cleaning unit moreover comprises at least one bristle carrier, for example a brush head base body. Advantageously at least some of the bristles or all the bristles are customarily extruded bristles. Bristles may herein in particular comprise at least one hard component and/or at least one soft component. Preferably the bristles are made at least partly or entirely of polyamide (PA) and/or of polyester (PBT, PET), wherein any other materials (hard component or soft component) are conceivable, and sustainable materials, e. g. chitosan, are also possible. The bristles may also be made of a degradable material. It is further conceivable that at least some of the bristles have a tapering and/or a variable cross section. Preferably the bristles are made of a single material, in particular a mixed material. However, bristles that are made of several components, respectively materials, are also conceivable, which may in particular be producible and/or produced via at least one co-extrusion. The bristles may, for example, be producible and/or produced via extrusion, cutting to length and/or subsequent processing. Differently than with injection-molded bristles or rubber-elastic massaging and cleaning elements produced via injection-molding, customary bristles are extruded, cut, processed and inserted at the toothbrush handle by means of an adapted procedure, like for example by means of the anchor-punching method, the AFT (Anchor-Free-Tufting) method, the PTt method and/or the IMT method.

In particular, cylindrical or tapering bristles are feasible, wherein any other cross sections, for example polygonal, triangular, rectangular, square, elliptic, star-shaped, trapezoid-shaped, parallelogram-shaped, rhomb-shaped or any other cross sections, are conceivable. In particular, while different bristles may be used in a bristle bundle, it is also possible that different bristle bundles, in particular in each case with a certain type of bristles, are used. Bristles and/or bristle bundles may herein be arranged in a regular, but also in an irregular, fashion. In particular, bristles and/or bristle bundles which are arranged in groups or neighboring one another may, in particular alternatingly, differ in regard to at least one characteristic, like for example a length, a diameter, a material, a color, a material hardness, a geometry, a tapering, or the like. Preferably the bristles have a diameter, in particular perpendicularly to their longitudinal axis, of at least 0.075 mm and/or of maximally 0.25 mm. Advantageously the bristles have a cross-section area, in particular perpendicularly to their longitudinal axis, of at least 0.002 mm² and/or of maximally 0.2 mm². In the case of bristles applied in the field of cosmetics, for example bristles of an additional application element, it is also possible to use thinner bristles and/or bristles having a smaller diameter, in particular bristles having a diameter, in particular perpendicularly to their longitudinal axis, of at least 0.025 mm and/or of maximally 0.2 mm, and/or having a cross-section area, in particular perpendicularly to their longitudinal axis, of at least 0.001 mm² and/or of maximally 0.15 mm². For tapered bristles in particular polyester (PBT, PET) is suitable as a material, sustainable materials being also possible and a tapering being created mechanically and/or chemically. However, further materials are also conceivable. Preferably the bristles are straight in a longitudinal direction, but wave-shaped and/or twiddled and/or helical and/or twisted bristles are also conceivable as well as in particular combinations of different bristles. Furthermore, bristles having a smooth surface are conceivable as well as bristles having a textured surface.

Beyond this, the bristles are processed, in particular fastened to the bristle carrier, in particular as a bristle bundle, preferably by means at least of an anchor-punching method, an anchor-free-tufting method (AFT), an in-mold-tufting method (IMT), a PTt method, or the like. Preferably the bristle carrier comprises a plurality of, in particular drilled and/or injection-molded, bristle receptacles, in particular holes for bristle bundles. In the case of anchor punching, it is for example conceivable that first of all a base body, preferably of the brush head, is made—in particular of a hard component—by means of injection-molding, wherein advantageously blind holes for bristle bundles are formed during injection-molding. Subsequent drilling of blind holes is of course also conceivable. Preferably then bristles, respectively bristle bundles, are folded and are fastened in respectively one blind hole by means of at least one anchor, in particular via punching-in. Sling punching is also conceivable.

Alternatively, as has been mentioned, anchor-free methods are also conceivable, wherein advantageously bristles, respectively bristle bundles, are not folded. In such a case, bristles, respectively bristle bundles, have approximately half a length as compared to anchor punching. Here it is for example conceivable that the bristle bundles are first singulated, are melted, and/or in particular their bristle ends are then overmolded for fastening. Herein bristle bundles may advantageously be brought together. Herein manufacturing with the in-mold-tufting method is possible, wherein advantageously a base body, e. g. a base body of the brush head and/or of the handle unit and/or of the fastening unit, is formed with the overmolding of the bristle ends. It is as well conceivable that, in particular in the context of an integrated-anchorless-production, bristles are first overmolded with platelets or the like, and these platelets are then overmolded in their turn, for example in order to form the brush head and/or the handle unit.

It is also conceivable that the application unit is composed of a base body and a bristle platelet that is studded with bristles and/or alternative cleaning elements. For this purpose, via injection-molding, firstly bristle platelets are manufactured with through holes which then bristles are guided through. After that, the bristles are preferably connected, in particular melted, in particular with one another and/or with the respective bristle platelet, on a rear side. Bristle platelets furnished with bristles in this way may then be welded and/or glued, preferably via ultrasound welding, with a base body, in particular a brush head. For this the base body, in particular the brush head, in particular comprises a recess which the bristle platelet may be inserted in. In this context, the anchor-free-tufting method may be referred to as a known production method, which in particular allows bringing bristle bundles together. In particular, a side of the bristle platelet that is laid into a recess of the base body, pointing toward the rear side of the oral hygiene device, is referred to as an underside of the bristle platelet. Correspondingly the upper side of the bristle platelet points toward the upper side of the oral hygiene device.

A further possible method for an anchor-free furnishing with bristles is a manufacturing, in particular injection-molding, of a brush head with through holes for bristles. Bristles may afterwards be passed through the through holes and melted—in particular with one another and/or with the brush head—on a rear side. Preferably this is followed by an overmolding of the melted regions and/or of the brush head, in particular with at least one soft component.

It is further conceivable to manufacture first a brush head with blind holes, for example via injection-molding and/or by drilling the blind holes. Bristles are in such a case in particular laid together to form bundles, and are melted and/or otherwise connected at one end. Then the brush head is heated, in particular to a glass transition temperature of its material. After that, advantageously bristle bundles can be introduced into the blind holes and can be anchored by pressing to the brush head. Herein, in particular, the heated blind holes, respectively their surroundings, are deformed, such that the bristle bundles get anchored in the blind holes.

Alternatively or additionally to punched and/or welded and/or glued-on bristles, injection-molded bristles are also conceivable. These may in particular be manufactured during a multi-component injection-molding procedure together with the application unit, the handle unit and/or the fastening unit, or they may be injection-molded to a base body of the application unit later on.

A further possible method for furnishing the brush head with bristles is twisting in. Herein, for example, a filament is fed in from a roll, wherein in particular several filament strands are wound on a roll. For machine loading in each case several rolls are pre-tensioned because each filament in the brush corresponds to a filament strand. The filaments are correctly spread in regard to a width, such that they have the width in which they are inserted into the brush. The filaments are pulled forward in such a way that they are then exposed for the next step, which means that a wire can be guided above them. After that a wire is fed from a roll to the machine, i. e. the wire is wound off and is entered into the process. The wire is cut to a length that is greater than the wound-off length of the twisted-in brush, wherein the final cutting-to-length is done after twisting-in. The wire is bent to form a U-shape, such that the open side can then be pushed over the filaments in order to thread the bristles in. The wire is held at the bottom of the U. Then the open wire end is clamped such that the filaments are held between the wire portions. The filaments are cut to a length that is greater than the final length in the brush, such that the brush may be cut correctly later on when the filaments have been twisted in. The wire is rotated such that the filaments are clamped between the wire and are thus fixed. When the filaments have been fixed with the wire, the filaments are cut to the correct length and profiled. When the brush portion has been completed, excess wire is cut off.

Preferably, during an injection-molding procedure, in particular a two-component and/or multi-component injection-molding, materials of injection-molded bristles do not enter into a material connection with other soft components and/or hard components and/or sustainable materials of the oral hygiene device. Preferentially injection-molded bristles are instead connected to soft components and/or hard components via a form-fit connection, for example by at least one undercut and/or at least one breakthrough and/or via at least one at least partial overmolding, wherein in particular an atrophy connection and/or a shrinkage connection are conceivable. However, a connection via at least one material connection is also conceivable.

For all injection-molding procedures mentioned principally a one-component, two-component and/or multi-component injection molding is conceivable. Herein, as has been mentioned before, materials that are used, in particular materials of different soft components and/or hard components, may be connected and/or get connected by substance-to-substance bond and/or by form-fit connection. It is also conceivable that articulate, respectively mobile or flexible, connections are formed by means of suitable injection-molding steps. Principally, for example, hot-runner procedures, cold-runner procedures and/or co-injection-molding procedures are possible.

Alternatively, an injection-stamping process may be used for a manufacturing instead of the injection-molding process. The injection-stamping process is in particular very suitable for applications with PET as a hard component or soft component. Using suitably selected geometries enables favorably thin-wall properties, wherein material distribution is optimally controllable.

Alternatively or additionally to a brush head furnished with bristles the application unit may also comprise at least one tongue cleaner and/or at least one alternative cleaning and/or massaging element. These may in each case be producible and/or produced of a soft component, of a hard component, of a combination of soft component and hard component, and/or advantageously via injection molding.

Preferably injection-molded bristles are implemented at least partially, advantageously completely, of a thermoplastic polyurethane elastomer (TPE-U). Herein a utilization of a modified polyurethane elastomer (TPE-U) is conceivable, which may be modified in particular in regard to improved flowing characteristics and/or to quick consolidation, in particular quick crystallization, advantageously already at rather high temperatures. Of course other materials are also conceivable, for example thermoplastic polyester elastomers (TPE-E), thermoplastic polyamide elastomers (TPE-A), polyethylene (PE), for example in the forms of low density polyethylene (LDPE) or linear low density polyethylene (LLDPE), or the like. Materials for injection-molded bristles advantageously have a Shore D hardness of at least 0, particularly advantageously of at least 30, and/or of maximally 100 and advantageously of maximally 80. In particular, a Shore D hardness of a material of injection-molded bristles is advantageously higher than a Shore D hardness of other soft components used, for example, for handle elements, massaging elements, further cleaning elements or the like. The materials applied for the production of injection-molded bristles may be sustainable materials.

Beyond this, it is principally conceivable to use water-soluble polymers, for example for hard components, soft components, injection-molded bristles or other elements of the oral hygiene device.

It is also possible to make use of sustainable materials, in particular bioplastics, which are in particular obtainable from renewable raw materials, for the hard component, for the soft component and/or for the material for injection-molded bristles. Raw materials may here in particular be corn, hemp, sugar, castor oil, palm oil, potatoes, wheat, sugar cane, sugar beets, rice husks, caoutchouc, wood, the castor oil plant, and the like. Respective possible base materials could be, for example, cellulose, starch, lactic acid (PLA), glucose, chitin, chitosan, lignin, casein, gelatin, or the like, from which in particular corresponding bioplastics can be synthesized.

By a “material volume body” is in particular, in this context, a body to be understood which forms the handle unit and which is in particular implemented of a solid material. Preferably the volume body forms a support structure of the handle unit. Preferably the material volume body consists to a large extent of one or several hard components and optionally also of one or several soft components. Furthermore, in this context, a “hollow-space structure” is in particular to mean a hollow space or several hollow spaces which adjoin one another and/or are section-wise interrupted, which is/are at least partly, in particular to a large extent, delimited and/or enclosed by a support structure, in particular the material volume body of the handle unit. Thus 1, 2, 3, 4, 5, 6, 7, 8, 9, 10, 11 or 12 hollow spaces may be used which are connected to one another or separate from one another. Preferably at least 30%, preferably at least 50% and particularly preferentially at least 70% of an outer surface of the hollow-space structure are delimited by the support structure, in particular the material volume body of the handle unit. Preferentially for any point of the hollow-space structure there is an imaginary straight line through the point, which intersects with the material volume body, then goes through the point and then goes through the material volume body once again. By an “essential hollow-space structure” is in particular, in this context, a hollow-space structure to be understood whose volume is equivalent to at least 20%, preferably at least 30% and particularly preferentially at least 40% of a volume of the handle unit, in particular from the underside to the thumb-gripping region and including the thumb-gripping region. A “substantial portion” is to mean in particular 30%, preferably at least 50% and particularly preferentially at least 70% of a whole. Furthermore, in this context a “main extent” is in particular to mean an extent of an object along a main extent direction. By a “main extent direction” is here in particular a direction to be understood that extends parallel to a longest edge of a smallest geometric rectangular cuboid just still completely enclosing the object. Preferably, the volume of the handle unit, in particular from the underside to the thumb-gripping region and including the thumb-gripping region, is equivalent to a total of the volumes of the enclosed hollow-space structure and the material volume body.

Preferably the volume of the enclosed hollow-space structure is in particular between 4 cm³ and 13 cm³, and preferably between 6 cm³ and 10 cm³. The volume of the material volume body may advantageously vary over a large range as there may be huge differences between implementations. The volume of the material volume body is therefore preferentially between 3 cm³ and 12 cm³, and preferably between 5 cm³ and 9 cm³. Preferably the volume of the handle unit, in particular a completely enclosed volume, in particular from the underside to the thumb-gripping region and including the thumb-gripping region, is in particular between 7 cm³ and 22 cm³, and preferably between 11 cm³ and 19 cm³. Regarding the enclosed hollow-space structure, the material volume body and also the volume of the handle unit, in particular the volumes from the underside to and including the thumb-gripping region have been taken into account.

It is generally proposed to realize the material volume body advantageously in a preferably lightweight manner. Preferentially the weight of the oral hygiene device is preferably less than 18 g. Preferably the weight of the oral hygiene device is in particular in a range between 4 g and 18 g, and preferentially in a range between 6 g and 14 g, particularly preferentially in a range between 6 g and 10 g. This allows the user an advantageously simple and advantageously precise guidance as a rather small mass must be moved. In addition, an injury risk due to mishandling or faulty movements is reduced as a result.

A wall thickness of the material volume body is in particular in a range from 0.6 mm to 5.5 mm, and preferably in a range from 1.5 mm to 4 mm.

Creating hollow-space structures allows saving a volume of 30% to 75%, preferably between 40% and 65%, relative to a filled volume. This is calculated as a created empty volume relative to a filled continuous volume. The hollow-space structures mostly concern the handle unit.

It is further proposed that the material volume body has an at least substantially bionic structure, which at least partially delimits the hollow-space structure directly. Preferably the bionic structure adjoins the hollow-space structure directly. A “bionic structure” is in particular to mean, in this context, a structure, in particular support structure, that is based on bionics, in particular construction bionics. The structure, in particular support structure, is herein in particular inspired by or resembles a structure from nature. In particular, a shape of the structure, in particular support structure, resembles a structure that exists in nature. Herein different bionic structures deemed expedient by someone skilled in the art are conceivable, like for example a lattice structure, a honeycomb structure, a reticulate structure, or the like. The structures preferably form certain regularities. The structures are preferably symmetrical with respect to the longitudinal axis. This in particular allows keeping a material volume of the handle unit at a low level, in particular affecting neither the ergonomics of the oral hygiene device, in particular its grippability, nor its stability. In particular, a material input for the oral hygiene device can be kept at a low level. It is thus in particular possible to provide an advantageously ecological and/or sustainable oral hygiene device.

It is furthermore proposed that the material volume body has an at least substantially bionic structure extending at least over a substantial portion of the at least one handle unit. Preferably the bionic structure extends over at least 30%, preferably over at least 50% and particularly preferentially over at least 70% of the main extent of the at least one handle unit. The bionic structure may here in particular be realized such that it is section-wise interrupted. Particularly preferentially at least 30 vol. %, preferably at least 50 vol.% and particularly preferentially at least 70 vol. % of the material volume body are realized by the bionic structure. This in particular allows keeping a material volume of the handle unit at a low level, in particular affecting neither the ergonomics of the oral hygiene device, in particular its grippability, nor its stability. It is in particular possible to keep a material input for the oral hygiene device at a low level. As a result, it is in particular possible to provide an advantageously ecological oral hygiene device.

It is moreover proposed that the material volume body has an at least substantially bionic structure that is formed by a lattice structure. By a “lattice structure” is in particular, in this context, a structure to be understood which delimits a plurality of, in particular regularly arranged, recesses, which are realized separately from one another due to the structure. The structure in particular comprises a plurality of, in particular regularly arranged, webs delimiting a recess in each case on its sides. The webs are in particular connected to form a pattern. The webs are in particular implemented integrally. The recesses are in particular arranged in a defined grid pattern and have an at least substantially identical cross section shape. Different cross section shapes are conceivable which are deemed expedient by someone skilled in the art, like for example circular, oval, elliptic, rectangular, rhombic, triangular, n-angular, lozenge-shaped, parallelogram-shaped or the like. The cross section of the recesses is in particular formed by a closed contour, wherein the recesses may be realized in a curved manner due to an outer contour of the handle unit. It is in particular also possible to create elongate contours, like for example similar to an egg-whisk shape at the rear handle end. The arrangement of the recesses in particular forms a pattern. Herein in particular regular patterns, like in particular in the manner of a lattice, or irregular patterns are conceivable. In the case of irregular patterns, in particular different shapes may be combined such that, for example, a pattern may be continued and/or the patterns realize images. The recesses are preferably formed by through holes, in particular in thin-walled portions of the material volume body. Through holes are in particular advantageous for hygienic reasons as they may be washed out or washed through. It is however also conceivable that the recesses are formed at least partly of blind holes. At least the handle unit has a bionic structure that is formed by a lattice structure. Alternatively or additionally it would also be conceivable that, in particular in a thumb-gripping region or in a neck region, the application unit has a bionic structure that is formed by a lattice structure. The bionic structure formed by a lattice structure may be realized by a continuous structure, in particular a continuous lattice, as well as by several separate substructures, in particular several separate lattices. For example, it would be conceivable that the handle unit comprises two substructures, each of which may be realized by a separate lattice, wherein a platform for a lettering may be formed in between. Between 5 and 18 parallel webs, preferably 7 to 13 webs, are arranged per substructure. For example, it would also be conceivable that the handle unit comprises a continuous bionic structure that is formed by a lattice structure, and the application unit comprises—in particular in the neck region—a bionic structure that is formed by a lattice structure. Particularly preferentially only the handle unit comprises the lattice structure. This in particular allows keeping a material input for the oral hygiene device at a low level. At the same time in particular a high degree of stability of the oral hygiene device is achievable. It is thus in particular possible to provide an advantageously ecological oral hygiene device.

The lattice structure may in particular be implemented with different material components. Preferably the lattice structure is formed of one or several hard components also forming the remaining portion of the handle unit. It would furthermore be feasible to form the lattice structure of a second material component that differs from a first hard component, for example, of a further hard component or of a soft component. The hard component may advantageously also form a basis and form the base structure of the lattice, which is then overmolded with a soft component.

It is further proposed that the material volume body comprises at least one thumb-gripping region, wherein the hollow-space structure is at least substantially open towards a rear side that faces away from the thumb-gripping region. Preferably the bionic structure, which is in particular realized as a lattice structure, is at least partly arranged in the region of the thumb-gripping region. In particular, a substructure of the bionic structure forms a surface structure of the thumb-gripping region. Preferably the material volume body engages around the hollow-space structure in a plane that is perpendicular to the main extent direction of the handle unit at least substantially in a C shape. In particular, a geometric center of the hollow-space structure is surrounded by the material volume body at least over an angle range of at least 180°, preferably at least 200° and particularly preferentially at least 220°. A volume of the hollow-space structure is in particular larger than a volume of the material volume body, wherein in particular in each point of the hollow-space structure there is a straight line through the point, which intersects with the material volume body, then goes through the point and then goes once again through the material volume body. The material volume body is in particular realized in a thin-walled fashion. Preferably a substantial portion of the material volume body, in particular of the handle region, respectively of the plate-shaped region, is realized with a substantially uniform wall thickness, preferably with a maximum deviation of +/−30%. The material volume body is in particular formed like a bent, respectively formed, plate. Preferably the material volume body is formed in an injection-molding procedure. The material volume body is in particular implemented by some type of bent, respectively formed, plate. The bend is in particular transversal to the longitudinal axis of the handle unit. The material volume body in particular has a mostly bent cross section shape, such that once more a voluminous outer shape is created. Preferably the material volume body has a substantially C-shaped cross section, in particular in a plane that is perpendicular to the main extent direction, which is open rearwards. Preferentially the material volume body is in particular recessed from the rear, the recess being formed by the hollow-space structure. The hollow-space structure is in particular formed by the bending of the material volume body. However, alternatively or additionally it would also be conceivable that the material volume body is recessed, respectively open, from the front or from a side, the hollow-space structure being oriented accordingly with its direction. In particular, one or several recess/es is/are provided which form the hollow-space structure, wherein the orientation of the recesses, in particular an orientation of the cross sections of the recesses, may be lengthwise or transversal. The hollow-space structure extends at least in the handle unit but it would also be conceivable that the hollow-space structure additionally continues via the neck region into the application unit. Thus, for example, a wave-shaped structure could be formed in the neck region. However, the head region of the application unit is preferably realized as a solid body, in particular for a bristle fixation in an anchor punching or for welding. An exception therefrom is the AFT bristling technology with a corresponding hollow space in the head region. Furthermore, the material volume body optionally in particular comprises a stabilizing rim on a free edge. The rim may in particular have a greater material thickness than the remaining material volume body. The material volume body in particular has a thin wall thickness. The thin wall thickness in particular extends into the neck region of the application unit. The thin wall thickness is created, for example, by recesses on the front side and/or rear side. Preferably the wall thickness of the material volume body is in particular in a range from 0.6 mm to 5.5 mm, preferably in a range from 1.5 mm to 4 mm and particularly preferentially in a range from 2 mm to 3.5 mm. This in particular allows realizing low material thickness and a lightweight implementation. It is in particular possible to keep a material input for the oral hygiene device at a low level. At the same time, a high degree of stability of the oral hygiene device is achievable, in particular due to its shaping. High stability is obtained in particular by the (substantially C-shaped) bending and the rim. This in particular allows providing an advantageously ecological oral hygiene device. It is moreover possible to favorably provide a certain gripping volume and thus a gripping despite a reduced material volume. If bio-degradable plastics are used, the thin wall thickness moreover permits an advantageously quicker degradation.

It is also proposed that the material volume body engages around the hollow-space structure, in a plane that is perpendicular to the main extent direction of the handle unit, at least substantially in a C shape. Furthermore, it is proposed that the material volume body is realized in a thin-walled fashion, wherein a substantial portion of the material volume body is realized having a substantially uniform wall thickness. Due to the low wall thickness in the handle unit, the greatest material accumulations may occur in the application unit, respectively in the head region. For an optimum filling of this portion with plastic, it is proposed to provide the injection-molding point for at least one hard component in the head region, in contrast to known customary toothbrushes which have their greatest material accumulation in the handle unit. It is further proposed that a volume of the hollow-space structure is greater than a volume of the material volume body. This in particular allows realizing low material thickness and a lightweight implementation. It is in particular possible to keep a material input for the oral hygiene device at a low level. At the same time a high degree of stability of the oral hygiene device is achievable, in particular due to the shaping.

Beyond this it is proposed that the material volume body forms, on a side facing away from the at least one thumb-gripping region, a substantially concave receiving region which delimits the hollow-space structure. The material volume body in particular has a cross-section shape that is mostly bent concavely towards a rear side, thus once more creating a voluminous outer shape. The hollow-space structure is in particular formed by the concave bending of the material volume body. This in particular allows realizing a thin material thickness. It is in particular possible to keep a material input for the oral hygiene device at a low level. At the same time, a high degree of stability of the oral hygiene device is achievable, in particular due to the shaping. High stability is obtained in particular by the bending and the rim. This allows providing an advantageously ecological, respectively sustainable, oral hygiene device. It is moreover possible to faultlessly provide a certain holding volume and thus a hold despite a reduced material volume.

It is further proposed that the hollow-space structure is at least substantially closed on a front side facing toward the thumb-gripping region. Preferably the hollow-space structure is on a front side at least substantially delimited by the material volume body. An exception may be the thumb-gripping region, which may also form a concave region on a front side. In this region the cross section may form an M-shape, in particular in a plane that is perpendicular to the main extent direction. One or several through holes may be provided in the thumb-gripping region. In the thumb-gripping region a thumb support may be provided that is implemented of a soft component. The soft component may extend from the front side to the rear side.

The material volume body is in particular shaped like a bent plate. Preferably the material volume body has an at least substantially C-shaped cross section, in particular in a plane that is perpendicular to the main extent direction, the cross section being open toward the rear. Preferentially the material volume body is in particular recessed from behind, the recess being formed by the hollow-space structure. The hollow-space structure may taper once or several times in the main extent direction, forming something like a wave shape. This in particular allows realizing low material requirements, the front side being at the same time substantially closed. As a result, a certain gripping volume—and thus gripping despite a reduced material volume—may be provided in a faultless manner. It is furthermore in particular possible to keep a material input for the oral hygiene device at a low level.

It is further proposed that the material volume body has an at least substantially bionic structure comprising in at least one region at least three strand elements which are twisted relative to one another. Alternatively, 4, 5 or 6 strand elements may be used. Preferably the strand elements form a reticulate structure. The strand elements are in particular at least partly intertwined. Preferentially the strand elements enclose the hollow-space structure at least partially. The strand elements are in particular implemented by webs which form an outer envelope of the hollow-space structure. The strand elements in particular form an outer envelope of the material volume body. In particular, the strand elements extend at least partly through the hollow-space structure. Preferably the strand elements are in particular formed by fine webs having a small cross section.

The strand elements may have quite different cross sections. Possible cross-section shapes are in particular circular, oval, elliptic, rectangular, lozenge-shaped, triangular, n-angular, rhombic, parallelogram-shaped, wherein the edges/corners formed in the longitudinal direction may be rounded or “sharp”. The cross section may moreover change over its longitudinal course and may merge from one shape into a further shape, this may occur several times. Preferentially the strand elements have a cross-section area that is in particular in a range from 3 mm² to 10 mm², and preferably in a range from 5 mm² to 8 mm². Preferably the width is here in particular in a range from 1 mm to 5 mm, and preferably in a range from 1 mm to 3 mm, and the height is in particular in a range from 1 mm to 5 mm, and preferably in a range from 1 mm to 3 mm.

An orientation of the strand elements is in particular realized substantially in the longitudinal direction of the handle unit. Preferentially the strand elements intersect along the longitudinal direction of the handle unit, thus forming nodal points in the main extent direction. In nodal points strand elements may form a material connection and/or a form-fit connection with one another. In nodal points strand elements may be in touch but do not form connections with each other. It is possible that strand elements do not touch in nodal points. It is possible that strand elements at least partly penetrate each other in nodal points. Preferably the material volume body further comprises at least one platform that is arranged between the strand elements. The at least one platform in particular serves for a marking. The at least one platform in particular serves as a finger support, preferably as a thumb support, in particular for improving ergonomics. The platform in particular forms a thumb-gripping region. Preferably the platform is realized by a filled body, which is integrated in the bionic structure or is fitted to the bionic structure. It is in particular conceivable that the platform and the bionic structure are made of one component, in particular a hard component, and therefore the body of the platform as well as the bionic structure are made of the same component. It would however also be conceivable that the body of the platform is made at least partially of a further component, in particular a hard component and/or a soft component. It would in particular be conceivable that an outer envelope of the body of the platform is made of a soft component. In particular, the thumb-gripping region or other elements might thus be formed of a further material component. The surface of the platform may herein be provided with surface structures, which offer an advantageously better hold for the fingers. Examples for such structures are lamellae, nubs, in particular in a large variety of cross sections, hollows, etc. In particular if there are further material components, the necessary connection to the bionic structure may be created by breakthroughs or entwinements. If the materials do not connect, i. e. in particular if they do not form a material connection, the breakthroughs serve to create a form-fit connection. The bionic structure may in particular in a termination be realized in such a way that it forms the necessary breakthroughs while at the same time enabling the injection-molding, and/or a sealing relative to the further contour. The further material component may in particular also be a soft component. Different arrangements of the at least one platform are conceivable which are deemed expedient by someone skilled in the art. For example, it would be conceivable that the handle unit comprises two platforms, a first platform being arranged on a rear end of the handle unit, a second platform realizing the thumb-gripping region and the bionic structure being arranged between the two platforms. The neck region may then be realized as a solid body and may also have a bionic structure. The head region of the application unit is preferably realized as a solid body. Furthermore, a plateau may be built into the bionic structure of the handle unit, the plateau being in particular formed quasi planarly between two strand elements. The plateau may in particular be used for a lettering and/or for a marking, or may in particular serve ergonomics, in particular for improved holding. This in particular allows keeping a material input for the oral hygiene device at a low level. It is in particular possible to provide a voluminous handle unit. Thus in particular an advantageously ecological oral hygiene device may be provided. Moreover, a certain holding volume—and thus holding despite a reduced material volume—may be provided in a faultless manner. In particular a dynamic implementation is obtainable. The handle region may in particular be implemented ergonomically and may have a certain flexibility, respectively pliability, due to the construction with strand elements.

It is also possible, with a suitable geometric implementation taking account of manufacturing issues, that certain strand elements are made of a different material component than the others. Thus strand elements may, for example, be implemented of different hard components and/or soft components. Different strand elements may also be provided with different additives, thus presenting different characteristics/functions.

A variety of methods, deemed expedient by someone skilled in the art, are conceivable for producing the bionic structure, in particular with the strand elements. In particular, the bionic structure is produced in an injection-molding process. The bionic structure is in particular produced via mutually contacting cores and additional core pullings. It is in particular conceivable that the bionic structure, in particular with the strand elements, is no longer demoldable in only one axis, thus requiring additional core pullings. Alternatively, 3D-printing methods, respectively additive methods, would be conceivable for the production. Alternatively or additionally, it would be conceivable that the strand elements are essentially injection-molded in parallel, thus forming an egg-whisk and/or a rake. After that the strand elements can be shaped and, if applicable, connected. Alternatively or additionally, it would be conceivable that the strand elements are built as a framework.

It is further proposed that the at least three strand elements are spaced apart from one another in at least one cross section that is perpendicular to a main extent direction of the handle unit. Furthermore, in at least one cross section that is perpendicular to a main extent direction of the handle unit, the at least three strand elements are connected to one another at least partially. It is also possible to use 4, 5 or 6 strand elements. Preferably the strand elements intersect in at least one point, the strand elements being interconnected in a nodal point and/or intersection point. This in particular allows providing a stable connection of the strand elements as well as a stable handle. As a result, in particular a material input for the oral hygiene device may be kept at a low level. Furthermore, it is in particular possible to provide a voluminous handle unit. In particular, it is thus possible to provide an advantageously ecological oral hygiene device. Furthermore, a certain holding volume, and thus holding despite a reduced material volume, can be provided in a faultless manner. In particular, a dynamic implementation is achievable.

Beyond this it is proposed that in at least one cross section that is perpendicular to a main extent direction of the handle unit, the hollow-space structure is surrounded by the material volume body, the volume body having at least one recess via which the hollow-space structure is connected to an environment. In this way in particular improved ergonomics are achievable. As a result, a material input for the oral hygiene device can be kept at a low level. Furthermore, it is in particular possible to provide a voluminous handle unit. This in particular allows providing an advantageously ecological oral hygiene device. It is moreover possible to provide a certain holding volume, and thus holding despite a reduced material volume, in a faultless manner. In particular, a dynamic, optically pleasant implementation is achievable. The design is suitable for a bio-degradable brush, in particular because of its low material requirements. Preferably the material volume body has defined recesses. Preferentially herein in particular between 3 and 10 recesses, and preferably between 4 and 8 recesses, are realized per side. Preferentially, with the exception of the recesses, the material volume body delimits the hollow-space structure completely. The recesses are in particular realized having no interconnections, and in each case have an area of maximally 2 cm², preferably of maximally 1 cm² and particularly preferentially of maximally 0.5 cm². The hollow-space structure is in particular arranged at least in the voluminous portions of the handle unit. Preferably the material volume body has a low wall thickness in a region delimiting the hollow-space structure. The recesses may in particular have different orientations. In particular, the recesses may be introduced relative to the longitudinal axis length-wise (i. e. parallel), transversely or at an angle. The angle may herein be between 0° and 90°. The recess may thus have any angle between a longitudinal orientation and a transverse orientation. Furthermore, different shapes of the recesses, deemed expedient by someone skilled in the art, are conceivable, like for example circular, oval, elliptic, rectangular, lozenge-shaped, triangular, polygonal, rhomb-shaped, parallelogram-shaped, or the like. The recesses may in particular be arranged on the oral hygiene device in different positions, like in particular on the handle unit, for example the thumb-gripping region, and/or on the application unit, for example the neck region or the head region, in particular the brush head. In particular, in this context a multi-component implementation, in particular of the material volume body, is also conceivable. Preferably, portions of the outer structure may be made of a soft component. A corresponding oral hygiene device is in particular producible in a method, in particular an injection-molding method, according to WO 2007/030958 A1.

Therefore the method described in the document WO 2007/030958 A1 shall in particular be considered as part of the disclosure of the present invention.

It is moreover proposed that in at least one plane that is parallel to a main extent plane of the handle unit, the hollow-space structure is completely surrounded by the material volume body. Preferably the hollow-space structure is completely surrounded by the material volume body in the main extent plane of the handle unit. Preferentially the material volume body is formed at least partly by a ring extending around the hollow-space structure. Preferably the hollow-space structure is realized by a slit that is encompassed by the material volume body. The slit is in particular oriented along the longitudinal axis of the handle unit. Preferably the slit is delimited by the material volume body from the front side to the rear side and from the lefthand side to the righthand side. The material volume body is in particular realized by two lateral longitudinal webs, which are respectively connected in at least one end, in particular in a front end and a rear end. The frame formed by the material volume body, which encloses the hollow-space structure, is in particular realized in a closed fashion. In particular, there are no open ends, like for example fork-like implementations.

The ring may have a variety of cross sections. Possible cross-section shapes are circular, oval, elliptic, rectangular, lozenge-shaped, triangular, polygonal, rhomb-shaped, parallelogram-shaped, wherein the edges/corners formed in a longitudinal direction may be rounded or “sharp”. The cross section may furthermore change over the longitudinal course and may merge from one shape into a further shape, which may also occur several times. Preferentially the ring may have a cross-section area that is in particular in a range of 15 mm² to 30 mm², preferably in a range of 20 mm² to 27 mm². Preferably the width is herein in particular in a range of 1 mm to 7 mm, preferably in a range of 3 mm to 6 mm, and the height may in particular be in a range of 1 mm to 7 mm, preferably in a range of 3 mm to 6 mm.

In a view from above, the slit may have a variety of cross sections. The cross-section shape may be uniform in a longitudinal direction or may present changes in the form of narrowings. A narrowing may, for example, be used to form a thumb-gripping region in a slightly offset fashion. Further possible cross-section shapes are elliptic, lozenge-shaped, parallelogram-shaped, rectangular, triangular. The corners and edges of the cross-section shapes are preferably realized in a rounded manner, wherein the edges/corners formed in a longitudinal direction may be rounded or “sharp”. Preferentially, measured in the middle of a height, the cross section has an area that is in particular in a range of 15 mm² to 30 mm², and preferably in a range of 20 mm² to 27 mm². Preferably the width is herein in particular in a range of 5 mm to 15 mm, and preferably in a range of 8 mm to 12 mm.

The cross section that is perpendicular to the longitudinal axis is preferably realized so as to be directly adjacent to the shape of the ring.

The application unit, in particular the neck region and the head region, is herein in particular realized as a solid body. Preferably the material volume body may have a surface structure, in particular in the region of the hollow-space structure, preferably in the inlets of the slit. In particular, the material volume body may have a height profile on its front side and/or on its rear side. For example, something like a thumb indent may be formed. In particular, the shape of the material volume body is in this implementation realized in at least in a rounded shape, in particular having no sharp edges. On the surface of the material volume body, surface structure elements may be formed, which are also referred to as projections, like in particular nubs, lamellae, deepenings, etc., and which improve holding of the body in an advantageous manner. The hollow-space structure that is realized as a slit in particular has a length of 30 mm to 180 mm, preferably of 60 mm to 150 mm. The hollow-space structure that is realized as a slit in particular has a width of 3 mm to 15 mm, preferably of 5 mm to 10 mm. A height of the hollow-space structure that is realized as a slit in particular corresponds at least to the thickness of the brush as the hollow space is realized throughout. This in particular allows keeping a material input for the oral hygiene device at a low level. In particular, it is in this way possible to provide an advantageously ecological oral hygiene device.

The invention is furthermore based on an oral hygiene means according to the preamble of claim 1, in particular according to one of claims 1 to 11. It is proposed that the material volume body of the handle unit is implemented at least to a large extent of a bio-degradable, in particular compostable, material and/or of a recycled and/or recyclable material. Preferably the material is in particular implemented of a plastic. Preferably one or several sustainable materials is/are used. Preferably the bio-degradable, in particular compostable, and/or recycled and/or recyclable material is implemented by a bioplastic, in particular by a plastic material that is based on renewable raw materials and/or of a bio-degradable plastic. The material may therefore in particular be fossil-based and bio-degradable, like for example PVOH, PCL, PBAT, PET or PBS, it may be based on renewable raw materials and bio-degradable, like for example PLA, PHA, PBS, cellophane, chitosan, or starch blends, or it may be based on renewable raw materials and not be bio-degradable, like for example Ca, Bio-PE, Bio-PP, Bio-PA, Bio-PET. A variety of bioplastics are conceivable which are deemed expedient by someone skilled in the art, like for example starch-based bioplastics, cellulose-based bioplastics, polyhydroxyalkanoates, like in particular polyhydroxy-butyric acid (PHB), polylactic acid (PLA), aliphatic and/or aromatic co-polyesters, or further bioplastics, like for example lignin-based bioplastics. Preferentially the application unit is also to a large extent implemented of a bio-degradable, in particular compostable, material and/or of a recycled material. Preferably the oral hygiene device is made of only one component. In particular, the oral hygiene device comprises a hard component. Preferably the material volume body of the handle unit is at least to a large extent implemented of the hard component. The hard component and/or the soft component and/or the material for injection-molded bristles is in particular implemented of a bioplastic, which may in particular be obtained from renewable raw materials. Possible raw materials are herein in particular corn, hemp, sugar, castor oil, palm oil, potatoes, wheat, sugar cane, rice husks, caoutchouc, wood, the castor plant, and the like. Corresponding possible base materials could be, for example, cellulose, starch, lactic acid (PLA), glucose, chitin, chitosan or the like, also in a mixed form, from which in particular corresponding bioplastics may be synthesized. This in particular allows providing an advantageously ecological oral hygiene device. In particular, an environmentally aware disposal of the oral hygiene device is achievable.

In particular, a sustainability concept is provided for the oral hygiene device. Different materials, deemed expedient by someone skilled in the art, are conceivable for a base body, respectively for the handle unit, of the oral hygiene device, like for example wood, a hybrid construction with a base body made of wood and plant-based plastic, bio-degradable plastic or recycled plastic. Plant-based plastics are, for example, polyamide based on the castor plant, respectively castor beans, polypropylene based on sugar cane, ABS based on sugar cane, glucose acetate or cellulose acetate based on wood. Recycled plastics are, for example, PET, in particular post-consumer recycled PET, which may in particular be utilized for the handle unit as no new resources are required, polypropylene, in particular post-consumer recycled PP, which is also utilizable for the handle unit, as no new resources are required, for example from a recycling collection, ocean-waste plastic or social plastic. Furthermore different materials, deemed expedient by someone skilled in the art, are conceivable for the bristles of the oral hygiene device, like for example 100% plant-based material that is based on castor oil or 60% plant-based material that is based on castor oil and polyamide or is generally based on chitosan. Moreover, a variety of packagings, deemed expedient by someone skilled in the art, are conceivable for the oral hygiene device, like a cardboard packaging made of recycled or recyclable cardboard or a blister packaging made of recyclable cardboard and a plastic blister with a high percentage of recyclate, for example a PET film with a recyclate percentage that is preferably 80% to 100%, particularly preferentially 100%. Possible special material characteristics for the oral hygiene device are, for example, water-soluble materials and/or bio-degradable materials. Preferably a material of the oral hygiene device in particular comprises at least one masterbatch. The masterbatch may in particular be configured to support bio-degradation, and may in particular be an additive for a degradation of plastic. The masterbatch preferably does not contain artificial colors, so as to ensure degradability. Furthermore, in particular additives like filling materials or foaming agents and/or expanding agents are conceivable. Possible filling materials may be, for example, glass fibers, glass balls or carbon fibers. It is moreover also possible to use renewable filling materials based on wood chips, especially pine chips, bamboo fibers, paper, cellulose, hemp fibers, rice husks, sugar cane fibers, etc. In addition to the above-mentioned effects, the filling materials may in particular also provide volume substitution. The filling materials may have a material fraction of 20% to 40% (mass percentage) relative to the “normal” material components. In particular, the oral hygiene device may be produced at least partly in a thermoplast-foam-injection-molding method, wherein in particular an expanding agent has been added as a foaming agent. This in particular allows realizing an airy volume body having a reduced weight while retaining its full outer volume. Foaming agents are preferably used as additives both in the hard component and in the sustainable materials. In addition, a foaming agent may also be used as an additive in the soft component. In such so-called chemical foaming a foaming agent is added, which is usually based on citric acid and is present in a masterbatch-like form. Adding to the “normal” material component is done in a quantity of maximally 20% (mass percent), maximally 15% and most preferentially of 7% to 12%. This enables creating volumes which are lighter than customarily filled volumes by up to 20%.

In particular, a simple and/or slim design of the oral hygiene device is provided. In particular, at least section-wise a low material thickness is provided, in particular for an improvement of degradability and for a reduction of resource consumption. Preferentially the wall thickness of the material volume body is in particular in a range from 0.6 mm to 5.5 mm, preferably from 1.5 mm to 4 mm, and particularly preferentially from 2 mm to 3.5 mm. With a sustainability concept, a great variety of methods may be applied for a furnishing with bristles, in particular the same methods as with customary brushes. However, in particular an anchor-free method is desirable. Anchor-free methods are very suitable as they permit a production of completely metal-free oral hygiene devices. Examples for this are the afore-described methods AFT, IMT and/or PTt as well as providing injection-molded bristles. However, alternatively customarily punched bristles are also conceivable here. However, customary bristle regions made via anchor-punching are less suitable due to the metal anchor used therein. The metal anchor may therefore be substituted by an anchor that is made of a hard component or of a sustainable material. In the sustainability concept for oral hygiene devices in particular an eco-touch is provided on the brush body. This is in particular a purely psychological component for marketing purposes. In particular, no smooth surfaces are provided, which means there are in particular no polished surfaces in the injection-molding tool. In particular, a rough or matted surface is to be created. The surface roughness is preferably between Rz=6.3 and Rz=25. For this purpose, in particular rough, eroded surfaces are provided in the injection-molding tool. Furthermore, in particular a reduced volume is provided, for example, in particular by the afore-described bionic structure and/or the afore-described hollow-space structure. In this way material reduction is achievable. Generally, material reduction will lead to quicker degradability of the oral hygiene device if bio-degradable materials are used. Material reduction furthermore leads to material saving, thus also supporting the ecological idea, there being low resource consumption and/or energy and material consumption. Material reduction is preferably brought about, in particular in the way described above, in the region of the handle unit; it is however also possible to extend the structures into the application unit.

Beyond this it is in particular proposed that the oral hygiene device has a center of gravity that is situated, measured from the underside, at 40% to 70% of the total length of the oral hygiene device. As a result of material reduction, in particular in the handle unit, the center of gravity is displaced relative to customary products. In the material reduction mentioned, the center of gravity is in particular displaced toward the application unit, respectively toward the head region, as the handle unit is substantially reduced and therefore has less weight. In this case the center of gravity is situated, measured from the underside, in particular after 40% to 70%, preferably after 42% to 60% and particularly preferentially after 45% to 55% of the total length of the oral hygiene device.

The implementations described above in particular in particular allow providing an advantageously lightweight oral hygiene device. With the background of the sustainability concept for the oral hygiene device, this enables achieving quicker degradability and compostability. In addition, both handling and injury risk are improved for the user's benefit.

Furthermore an, in particular already existing, recycling cycle may be provided for the oral hygiene device. In particular for products made of PA, Polyester (like for example PBT, PET, PTT, etc.), PE or PP, a closed cycle may be provided. Such a closed cycle in particular comprises the following steps: production of the product, usage, collection, grinding and sorting, granulating, in particular melting and comminuting, and then production of the product from the start. In particular for products implemented of PET an open cycle may be provided. Such an open cycle in particular comprises the following steps: production of the product, usage, collection, like for example by a PET bottle collection, grinding and sorting, granulating, in particular melting and comminuting, and then production of the product from the start. It would herein in particular also be conceivable that new recycling cycles are opened or that the oral hygiene devices are integrated in existing cycles, like for example a PET bottle cycle. This is more and more the case for PE and PP.

The base body of the oral hygiene device is in particular made of only one component. It would however also be conceivable that the oral hygiene device is made of several components. However, preferably at least one component is a sustainable material, like for example a degradable or recycled material. For a two-component or multi-component oral hygiene device it would in particular be conceivable that at least a portion of the structures is implemented of a soft component or coated with a soft component. Soft components may herein in particular be used, for example, for tongue cleaners, cleaning and massaging elements, mucous-membrane protection or gripping zones, in particular thumb grips. For this purpose, corresponding regions, like recesses and/or through holes, are provided in the handle unit and/or in the application unit. In contrast to recycled materials, new materials and/or high-quality components may be applied in particular in positions in which the human body, in particular the oral cavity, is contacted, which means in particular in places where the characteristics of the material are required in a narrower range and/or with closer tolerances. New components and/or high-quality components are in particular applied with the functional elements at the body. Examples for this are in particular components at the brush head, which ensure the punching and/or the pull-out weights, or which ensure the welding in the case of AFT. Further examples at the neck region are in particular components ensuring stability under load and/or ensuring a passing of the notch test, and/or ensuring flexibility. For example, it would be conceivable that bodies are made of new components and a filling is made of sustainable components. Corresponding bodies may be produced in particular in a co-injection procedure or in a two-component or multi-component procedure, in which the enveloping body and an inner body are made of different components. Alternatively, corresponding bodies could in particular be produced by filling hollow spaces realized in the base body, with sustainable components. Alternatively, first an inner body could be injection-molded of a sustainable material and then the enveloping body could be injection-molded around the inner body. In the case of a three-component oral hygiene device, it would in particular be conceivable that PP and TPE are used in a material connection and are combined with sustainable material, with the sustainable material entering no material connection with PP and TPE. The sustainable material could be injection-molded before or after the PP, respectively the TPE.

It is moreover proposed that the material volume body of the handle unit is at least to a large extent implemented of a plastic that is based on renewable materials. Preferably the material volume body of the handle unit is made of a bio-plastic. This in particular allows providing an advantageously ecological oral hygiene device. In particular, environmentally aware disposal of the oral hygiene device is achievable.

Beyond this further product variants are conceivable for the sustainability concept of the oral hygiene device. It is in particular conceivable that the bristles and the base body are punched from bio-plastic. It would herein be conceivable that metal anchors are applied, wherein it is possible to create a sustainable product except for said metal anchors. It is also possible to substitute the metal anchor by a sustainable material, for example by a bio-plastic, a degradable plastic or a recycled plastic. This would preferably be a hard material. It would furthermore be conceivable that the bristles, the base body and an AFT platelet are made of bio-plastic. In this case no anchor wire would be required and a completely metal-free brush can be produced.

In further product variants for the sustainability concept of the oral hygiene device degradable materials may be applied for the base body, respectively the handle unit, and for the bristles. For example, bristles made of chitosan would be used. Thus the entire brush would be degradable with the exception of the metal anchor if a metal anchor is used.

In regard to manufacturing technology, a further product variant for the sustainability concept of the oral hygiene device is the usage of a degradable or compostable filled material component, which is implemented as a combination of sustainable material components and cellulose fibers (paper). Herein it is advantageous that an injection-molding application and/or a processing by injection-molding is possible; this may also be referred to as paper injection-molding, depending on a percentage.

Furthermore, a one-component oral hygiene device would be conceivable, in which everything, in particular the handle unit and the bristles, is made of the same plastic and no metal anchor is used, like for example a base body made of polyester, in particular PET, and bristles made of polyester, in particular PET, if required an anchor that is also made of polyester, in particular PET. A corresponding oral hygiene device would in particular be suitable for the PET collection. Alternative materials for a one-component oral hygiene device are, for example, PE, PP, PBT, PTT or PA, in particular PA 6.10, PA 6.12. Preferably the one-component oral hygiene device is produced so as to be anchor-free, like for example in an AFT, PTt, Inmold or IAP procedure. If the bristle bundles are inserted by customary anchor-punching, the anchor is preferably made of the same material as the base body and the bristles. For example, the base body, the anchors and the bristles might in particular be made of PET, PP, PBT or PTT.

With a one-component brush there will be better recyclability as fewer different material components are used, such that the separation of the constituents requires less effort or is not necessary.

As all the constituents of a one-component brush are made of the same material component, it is advantageously possible that the materials form a better connection during processing than is the case when different materials are used. This is in particular important for bristle fastening. As a result, the pull-out weights for bristle bundles/bristles are advantageously greater, and the toothbrush is thus more robust in the usage while the bristles provide better and gentler cleaning.

In the case of a one-component brush the weight percentage of a same or “same-type” material component is more than 90%, preferably more than 97%, particularly preferentially more than 99%. Same-type material components that may be used are, for example, material components of polyester, like PET, PBT. Examples for one-component brushes:
An anchor-punched toothbrush with a handle body of PBT and filaments of PA is implemented of the same material component, except for the filaments and the anchor-punching wire. Thus 90% of the same material component are achieved.
An anchor-punched toothbrush with a handle body of PBT and filaments of PET is implemented of the same material component, except for the anchor-wire. Thus about 98% of the same material component are achieved.
A toothbrush produced in an anchor-free manner with a handle body of PBT and filaments of PET is made by approximately 100% of the same material component.

Of course, with all material components for the one-component brush the coloring is also important. The so-called masterbatch—the carrier of the colorants—may be made of different material components, wherein not any material component is suitable for any color, and thus not any material component is suitable to be mixed into a further material component (e. g. for the handle body). Therefore, there will be a reduction of the percentage, depending on a material combination.

In accordance with the explanations given above, the product may be produced of existing/customary material components in a combination with sustainable material components. As has been mentioned above, sustainable material components may be, for example, bio-based or recycling-based. The entire product thus preferably has different fractions of the different material components. For example, the handle unit may be made of a hard component of a bio-based material, and may be combined with a soft component of a customary material. The bristles may in particular be produced of a recycled material component.

The invention is furthermore based on an oral hygiene means according to the preamble of claim 1, in particular according to one of claims 1 to 13. It is proposed that the oral hygiene device comprises at least one first material and at least one second material that is different from the first material, wherein the second material is configured to be at least partly separated from the first material, in particular after a usage period of the oral hygiene device. Preferably the first material is at least partly configured to be disposed of separately from the second material. Preferably at least a portion of the first material can be separated homogeneously from the second material, wherein in particular a portion of the first material may remain in a connection with the second material. Thus, for example, in the case of a simple oral hygiene device, in particular a single-punched brush, the head region of the application unit can be separated off. Preferably after the separation no re-connection is intended, which enables faultless and danger-free usage. The handle unit and the neck region are made only of the first material, in particular a plastic, the head region being implemented of several materials, in particular at least the first material and the second material. In particular, a base body of the head region is, for example, made of a plastic, the bristles are made of a further plastic and the anchors for fixing the bristles are made of metal. In the case of oral hygiene devices made of several components, in particular hard components and soft components, a connection of the components may be realized merely via a form-fit connection. For example, the soft component may be separated, respectively cut, in one point and may then be pulled off. The separation of components does not necessarily have a destructive effect on one of the components but may also be realized manually with a limited force input. Alternatively popular auxiliary means may be used, like for example scissors, screw-drivers, knives, bottle openers. This will in particular result in two parts which are pure, respectively made of one material, and which may then be disposed of, respectively recycled, according to their destinations. A metal-containing brush head may also be separated off and may then be fed not to recycling but to waste. The individual parts and sections of the oral hygiene device are in particular made in such a way that they are optimally separable. This in particular allows providing an advantageously ecological oral hygiene device. In particular, environmentally aware disposal of the oral hygiene device is achievable. The separation serves in particular for a material separation of different materials and/or different plastics. It is in particular possible to create parts made of a pure material and parts made of different materials.

It is also proposed that the oral hygiene device comprises at least one marked predetermined separation point, respectively severing point, for an, in particular homogeneous, separation of at least one subregion with the first material, in particular the handle unit, from a subregion with the second material, in particular the application unit. By a “predetermined separation point” is in particular, in this context, a point and/or a region of the oral hygiene device to be understood in which the oral hygiene device is configured for an, in particular destructive, separation of the oral hygiene device into at least two parts. The oral hygiene device is in particular configured for a separation after a usage period and before disposal. The predetermined separation point may in particular be realized just as a marking and as a predetermined breaking point which breaks in a defined manner in case of an overload, or can be separated in a different suitable manner.

The predetermined breaking point may comprise, for example, an indentation, a perforation or a scratch track. Due to an indentation effect, the oral hygiene device is decisively weakened in the predetermined breaking point. If the predetermined breaking point is realized as a marking, in particular an external marking is provided which marks a separation position. The marking may for example indicate the position where, for example, the head region is to be separated off. Furthermore, the individual material components may be lettered with material identification. Thus, for example, the material name, like for example TPE, PP, PE or the like, may be applied on each material. Alternatively or additionally, the material recycling mark and/or a recycling code may be applied on each material. This in particular allows providing an advantageously ecological oral hygiene device. In particular, an environmentally aware separate disposal of the oral hygiene device is achievable. In particular, an at least partly homogeneous disposal of the oral hygiene device is achievable.

Furthermore, it is proposed that the application unit comprises at least one head region and at least one neck region, wherein the predetermined separation point is arranged in the neck region and is configured for a separation at least of the handle unit from a head region of the application unit. Preferably the predetermined separation point extends transversely to a longitudinal axis of the handle unit. The predetermined separation point is in particular arranged on a side of the neck region that faces toward the head region. This in particular allows providing an advantageously ecological oral hygiene device. In particular, an environmentally aware separate disposal of the oral hygiene device is achievable. In particular, an at least partly homogeneous disposal of the oral hygiene device is achievable. In particular, a defined separation of the head region, which often contains materials like metal, is achievable.

It is moreover proposed that the predetermined separation point is formed by a predetermined breaking point, which is configured to break in case of a defined load of the application unit against a bristle load direction of the application unit. Preferably the predetermined separation point is implemented by an indentation on a rear side or on a side of the oral hygiene device. Preferentially the predetermined separation point is implemented by an indentation on a rear side of the neck region of the application unit. Preferably the indentation is formed on a side that faces away from the bristle load direction. However, principally a different implementation of the predetermined breaking point, deemed expedient by someone skilled in the art, would also be conceivable. The predetermined breaking point may, for example, comprise an indentation, a perforation, a scratch track, or the like. The predetermined breaking point is in particular implemented by a material weakening. The bristle load direction in particular extends perpendicularly to a longitudinal axis of the handle unit and at least substantially parallel to an averaged bristle extent. The bristle load direction in particular extends in a direction from a free end of the bristles to a fastened end of the bristles. The bristle load direction in particular corresponds to a load direction of the head region of the oral hygiene device during a cleaning process, in particular while the head region is pressed to a tooth. In this way in particular an at least partly homogeneous disposal of the oral hygiene device is achievable. In particular, a defined and simple separation of a portion, in particular the head region, which often contains materials like metal, is achievable. In particular, toolless dividing of the oral hygiene device is achievable. In particular, an environmentally aware separate disposal of the oral hygiene device is achievable.

It is also proposed that the predetermined separation point is implemented by a marking of an intended separation point. Preferably, the type of separation and the auxiliary means possibly required therefor are indicated near the separation point. Preferably the marking is in particular realized by an external marking, which indicates a separation position. The marking may, for example, indicate the position where, for example, the head region is to be separated off. The marking may be realized, for example, in the form of a printing, by injection-molding, by a circumferential slight indentation, and/or by a circumferential elevation. In this way in particular an at least partly homogeneous disposal of the oral hygiene device is achievable. In particular, a defined and simple separation of a part, in particular of the head region, which often contains materials like metal, is achievable. Furthermore, a stability of the oral hygiene device is not affected by the marking. In particular, an environmentally aware separate disposal of the oral hygiene device is achievable.

The oral hygiene device according to the invention shall herein not be limited to the applications and implementations described above. In particular, for the purpose of implementing a functionality that is described here, the oral hygiene device according to the invention may comprise a number of individual elements, components and units that differs from a number given here, and/or may comprise any expedient combination of said elements, components and units. Moreover, in regard to the value ranges given in the present disclosure, values within the limits mentioned shall be considered to be disclosed and to be applicable according to requirements.

The implementation variants shown in the present document are of course to be understood by way of example. In the context of the invention, the individual realizations and elements of these implementation variants may be combined with other implementation variants without leaving the scope of this invention.

### DRAWINGS

Further advantages will become apparent from the following description of the drawings.

In the drawings eighteen exemplary embodiments of the invention are illustrated. The drawings, the description and the claims contain a plurality of features in combination. Someone skilled in the art will purposefully also consider the features separately and will find further expedient combinations.

It is shown in:

FIG. 1A a front side of an oral hygiene device according to the invention, in a schematic perspective view,

FIG. 1B a rear side of the oral hygiene device according to the invention, in a schematic perspective view,

FIG. 1C a rear side of the oral hygiene device according to the invention, in a schematic view,

FIG. 1D a side of the oral hygiene device according to the invention, in a schematic view,

FIG. 1E a front side of the oral hygiene device according to the invention, in a schematic view,

FIG. 1F an underside of the oral hygiene device according to the invention, in a schematic view,

FIG. 1G an upper side of the oral hygiene device according to the invention, in a schematic view,

FIG. 2A a front side of an alternative oral hygiene device according to the invention with an application unit and with a handle unit comprising a material volume body and a hollow-space structure, in a schematic perspective view,

FIG. 2B a side of the alternative oral hygiene device according to the invention, in a schematic view,

FIG. 2C a front side of the alternative oral hygiene device according to the invention, in a schematic view,

FIG. 3A a front side of a further alternative oral hygiene device according to the invention with an application unit and with a handle unit comprising a material volume body and a hollow-space structure, in a schematic perspective view,

FIG. 3B a rear side of the further alternative oral hygiene device according to the invention, in a schematic perspective view,

FIG. 4 a front side of a further alternative oral hygiene device according to the invention with an application unit and with a handle unit comprising a material volume body and a hollow-space structure, in a schematic view,

FIG. 5A a front side of a further alternative oral hygiene device according to the invention with an application unit and with a handle unit comprising a material volume body and a hollow-space structure, in a schematic view,

FIG. 5B a side of the further alternative oral hygiene device according to the invention, in a schematic view,

FIG. 5C a rear side of the further alternative oral hygiene device according to the invention, in a schematic view,

FIG. 6A a front side of a further alternative oral hygiene device according to the invention with an application unit and with a handle unit comprising a material volume body and a hollow-space structure, in a schematic perspective view,

FIG. 6B a front side of the further alternative oral hygiene device according to the invention, in a schematic view,

FIG. 7A a front side of a further alternative oral hygiene device according to the invention with an application unit and with a handle unit comprising a material volume body and a hollow-space structure, in a schematic perspective view,

FIG. 7B a front side of the further alternative oral hygiene device according to the invention, in a schematic view,

FIG. 8A a front side of a further alternative oral hygiene device according to the invention with an application unit and with a handle unit comprising a material volume body and a hollow-space structure, in a schematic perspective view,

FIG. 8B a front side of the further alternative oral hygiene device according to the invention, in a schematic view,

FIG. 9A a front side of a further alternative oral hygiene device according to the invention with an application unit and with a handle unit comprising a material volume body and a hollow-space structure, in a schematic perspective view,

FIG. 9B a front side of the further alternative oral hygiene device according to the invention, in a schematic view,

FIG. 9C a side of the further alternative oral hygiene device according to the invention, in a schematic view,

FIG. 10A a front side of a further alternative oral hygiene device according to the invention with an application unit and with a handle unit comprising a material volume body and a hollow-space structure, in a schematic perspective view,

FIG. 10B a front side of the further alternative oral hygiene device according to the invention, in a schematic view,

FIG. 10C a side of the further alternative oral hygiene device according to the invention, in a schematic view,

FIG. 11A a front side of a further alternative oral hygiene device according to the invention with an application unit and with a handle unit comprising a material volume body and a hollow-space structure, in a schematic perspective view,

FIG. 11B a rear side of the further alternative oral hygiene device according to the invention with an application unit and with a handle unit comprising a material volume body and a hollow-space structure, in a schematic perspective view,

FIG. 11C a front side of the further alternative oral hygiene device according to the invention, in a schematic view,

FIG. 11D a side of the further alternative oral hygiene device according to the invention, in a schematic view,

FIG. 11E a cross section of the further alternative oral hygiene device according to the invention, in a schematic view,

FIG. 12A a front side of a further alternative oral hygiene device according to the invention with an application unit and with a handle unit comprising a material volume body and a hollow-space structure, in a schematic perspective view,

FIG. 12B a front side of the further alternative oral hygiene device according to the invention, in a schematic view,

FIG. 12C a side of the further alternative oral hygiene device according to the invention, in a schematic view,

FIG. 13A a front side of a further alternative oral hygiene device according to the invention with an application unit and with a handle unit comprising a material volume body and a hollow-space structure, in a schematic perspective view,

FIG. 13B a front side of the further alternative oral hygiene device according to the invention, in a schematic view,

FIG. 13C a side of the further alternative oral hygiene device according to the invention, in a schematic view,

FIG. 14A a front side of a further alternative oral hygiene device according to the invention with an application unit and with a handle unit comprising a material volume body and a hollow-space structure, in a schematic perspective view,

FIG. 14B a front side of the further alternative oral hygiene device according to the invention, in a schematic view,

FIG. 14C a side of the further alternative oral hygiene device according to the invention, in a schematic view,

FIG. 15A a front side of a further alternative oral hygiene device according to the invention with an application unit and with a handle unit comprising a material volume body and a hollow-space structure, in a schematic perspective view,

FIG. 15B a front side of the further alternative oral hygiene device according to the invention, in a schematic view,

FIG. 15C a side of the further alternative oral hygiene device according to the invention, in a schematic view,

FIG. 16A a front side of a further alternative oral hygiene device according to the invention with an application unit and with a handle unit comprising a material volume body and a hollow-space structure, in a schematic perspective view,

FIG. 16B a front side of the further alternative oral hygiene device according to the invention, in a schematic view,

FIG. 16C a side of the further alternative oral hygiene device according to the invention, in a schematic view,

FIG. 17A a front side of a further alternative oral hygiene device according to the invention with an application unit and with a handle unit comprising a material volume body and a hollow-space structure, in a schematic perspective view,

FIG. 17B a rear side of the further alternative oral hygiene device according to the invention with an application unit and with a handle unit comprising a material volume body and a hollow-space structure, in a schematic perspective view,

FIG. 17C a front side of the further alternative oral hygiene device according to the invention, in a schematic view,

FIG. 17D a side of the further alternative oral hygiene device according to the invention, in a schematic view,

FIG. 17E a rear side of the further alternative oral hygiene device according to the invention, in a schematic view,

FIG. 18A a front side of a further alternative oral hygiene device according to the invention with an application unit and with a handle unit comprising a material volume body and a hollow-space structure, in a schematic perspective view,

FIG. 18B a rear side of the further alternative oral hygiene device according to the invention with an application unit and with a handle unit comprising a material volume body and a hollow-space structure, in a schematic perspective view,

FIG. 18C a front side of the further alternative oral hygiene device according to the invention, in a schematic view,

FIG. 18D a side of the further alternative oral hygiene device according to the invention, in a schematic view, and

FIG. 18E a rear side of the further alternative oral hygiene device according to the invention, in a schematic view.

### DESCRIPTION OF THE EXEMPLARY EMBODIMENTS

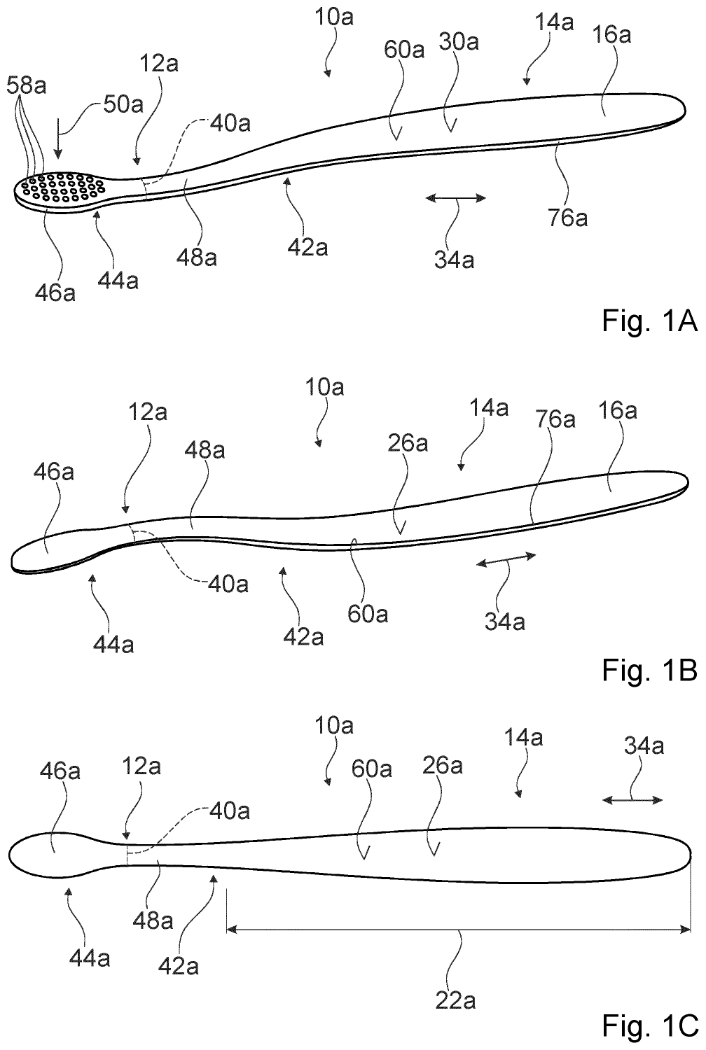

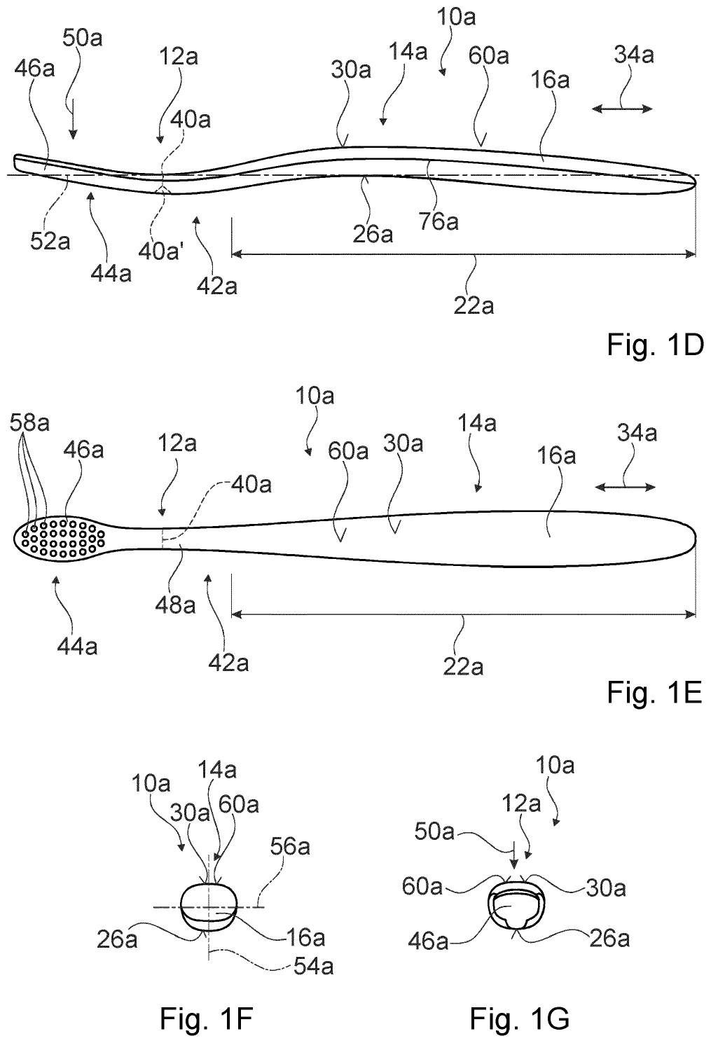

FIG. 1A shows a front side 30a of an oral hygiene device 10a in a schematic perspective view. The oral hygiene device 10a is in the present case embodied as a toothbrush. The oral hygiene device 10a may as well be embodied as a one-way toothbrush or as an exchangeable-head toothbrush. The oral hygiene device 10a could also be embodied as a flosser, as a single-tuft brush, as an interdental cleaner, as a tongue cleaner, or something like that. Furthermore, combined oral hygiene devices are conceivable, combining at least two different functions, for example a toothbrush with a tongue cleaner, a toothbrush with massaging elements, an interdental cleaner with a flosser, or more of the like.

The oral hygiene device 10a comprises at least one application unit 12a. Furthermore the oral hygiene device 10a comprises at least one handle unit 14a. The at least one handle unit 14a is made of a single material. The handle unit 14a is made of a hard component. However, it would principally also be conceivable that the handle unit 14a is made partially of a soft component and partially of a hard component. Generally an implementation with one or several hard components and/or one or several soft components is also possible.

The oral hygiene device 10a is in particular implemented in a manner that is ergonomic and resource-efficient. In particular, except for cleaning elements and anchors for fastening the cleaning elements, the oral hygiene device 10a is made of only one component. The application unit 12a and the handle unit 14a form a base body of the oral hygiene device 10a and are together made of only one component. The application unit 12a and the handle unit 14a are implemented integrally. The oral hygiene device 10a is implemented of a 1K brush, in particular a one-material brush.

In the following, FIGS. 1A to 1G will be referred to, which show different views of the oral hygiene device 10a. Due to the different views, some elements are not shown in all of the figures and are therefore not given reference numerals in all of the figures. FIG. 1B shows a rear side 26a of the oral hygiene device 10a in a schematic perspective view. FIG. 1C shows the rear side 26a of the oral hygiene device 10a in a schematic view. FIG. 1D shows a side, in particular a lefthand longitudinal side, of the oral hygiene device 10a in a schematic view. FIG. 1E shows the front side 30a of the oral hygiene device 10a in a schematic view. FIG. 1F shows an underside of the oral hygiene device 10a in a schematic view. FIG. 1G shows an upper side of the oral hygiene device 10a in a schematic view.

The oral hygiene device 10a has a longitudinal axis 52a, a height axis 54a and a width axis 56a. The longitudinal axis 52a is arranged parallel to a main extent direction 34a of the oral hygiene device 10a. If the oral hygiene device 10a is laid onto a planar surface with its rear side 26a such that the longitudinal axis 52a is arranged parallel to the surface, the height axis 54a is arranged perpendicularly to the longitudinal axis 52a and perpendicularly to the surface and to the width axis 56a. The width axis 56a is arranged perpendicularly to the longitudinal axis 52a and perpendicularly to the height axis 54a. In the present case the oral hygiene device 10a has a length, in particular parallel to the longitudinal axis 52a and measured parallel to the support surface, in a range from 140 mm to 210 mm, and preferably from 165 mm to 185 mm. The oral hygiene device 10a furthermore has a maximum height, in particular parallel to the height axis 54a and measured perpendicularly to the support surface, in a range from 12 mm to 25 mm, and preferably from 15 mm to 19 mm. A pure body thickness of the oral hygiene device 10a, in particular parallel to the height axis 54a, is in the handle region between a free end and a neck base between 6 mm and 10 mm, preferably between 7 mm and 9 mm. A minimum body thickness of the oral hygiene device 10a in a neck region 48a is in particular in a range from 4 mm to 10 mm, preferably from 5 mm to 7 mm. A minimum height of the oral hygiene device 10a is situated in a head region 46a and amounts to between 3 mm and 8 mm, preferably between 4 mm and 6 mm. The oral hygiene device 10a furthermore has a width in its widest point, in particular parallel to the width axis 56a, that is in a range from 10 mm to 25 mm, and preferably from 13 mm to 18 mm. From an underside to an upper side, a maximum width of the oral hygiene device 10a is arranged in the first 30% of the main extent of the oral hygiene device 10a. The weight of the oral hygiene device 10a is between 8 g and 25 g, preferably between 10 g and 18 g.

The at least one application unit 12a comprises the head region 46a. The head region 46a constitutes a brush head of the oral hygiene device 10a. In the present case, the head region 46a is realized as a toothbrush head. The head region 46a in particular comprises a base body that is realized as a bristle carrier. A base body of the head region 46a is completely made of a hard component. It would however also be conceivable that the base body of the head region 46a is made of a hard component and a soft component. The base body of the head region 46a realizes a bristle carrier. The head region 46a of the oral hygiene device 10a has a width of 8 mm to 17 mm, and preferably of 10 mm to 15 mm. The oral hygiene device 10a moreover comprises a cleaning zone (not shown in detail), which is accommodated in the head region 46a and comprises a plurality of bristle bundles. For the sake of better overview, the bristle bundles are not shown in FIGS. 1A to 1G. On the front side 30a of the head region 46a, at least one recess 58a is formed. The at least one recess 58a is configured to receive a bristle bundle. The head region 46a has a plurality of recesses 58a. The recesses 58a are implemented by bristle holes. The recesses 58a have in the main region a diameter of 1.2 mm to 2 mm, and preferentially of 1.4 mm to 1.8 mm. Preferably the recesses 58a have a bevel at their inlet. The bevel is in particular realized as a cone or as a rounding. Furthermore, the recesses 58a in particular taper conically at a lower end. The recesses 58a are in particular formed like a truncated cone. The recesses 58a in particular have a conicity of 20° to 50°, preferably 30° to 40°, per side. At a closed lower end, the recesses 58a in particular still have a diameter of 0.4 mm to 1 mm, preferentially of 0.55 mm to 0.80 mm. Furthermore, the recesses 58a in particular in each case have a narrowing that is realized as a diameter reduction. The narrowings serve for improving the pull-out weights. During production, the narrowings are forcibly demolded when the punching dies are pulled out. The narrowings are in particular arranged in the middle of the cylindrical portion of the recesses 58a. The narrowings induce a section-wise reduction of the diameter by 3% to 10%, preferably by 4% to 5%. The distances of the recesses 85a are in particular larger than in customary brushes. The distance between bristle hole edges of the recesses 58a is 0.5 mm to 2 mm, preferably 0.8 mm to 1.4 mm. The distances from the recesses 58a to an edge of the head region 46a, in particular a distance from an outer edge of the head region 46a to the outer bristle hole edges of the recesses 58a, is 1 mm to 2.2 mm, preferably 1.2 mm to 1.8 mm. Principally the recesses 58a may also be implemented in different shapes. Possible bristles are any suitable bristles, which may be punched on, for example, in an anchor-punching method as has been described above. The inserted bristles are made of an at least partially plant-based material. The bristles are made of PA 6.10, which is produced by approximately 50% to 70% of renewable raw materials and is based on castor oil, of PA 6.12 and/or of PA 10.10, which is produced by up to 100% of renewable raw materials and is based on castor oil. The bristles are in particular cut to be rather short, in particular because of the large distances of the recesses 58a and because of the bristle material used. The material of the bristles in particular has different characteristics than customary bristles and is in particular less stable. Due to the smaller length, in particular augmented stability is achievable. The length of the bristles is in particular 8 mm to 15 mm, preferably 10 mm to 12 mm. The bristles are fixed in the recesses 58a by means of an anchor wire. The anchor wire is in particular implemented of a metallic anchor wire. However, a synthetic anchor would principally also be possible. The anchor wire is rilled in a three-fold manner on both sides. When using recycling materials, in particular a longer anchor wire is employed than with other materials. The anchor wire has a length of 1.5 mm to 2.5 mm, preferably of 1.7 mm to 2.1 mm. The bristle bundles in particular have a pull-out weight of 2 kg. The construction of the head region 46a, respectively the base body of the head region 46a, is different in other bristle-furnishing methods. Principally applying AFT would also be conceivable. In this way an anchor-free oral hygiene device 10a—and thus an oral hygiene device 10a without metal—could be provided as the anchor wire can be dispensed with. In the case of AFT, in the head region 46a a recess is provided which is configured to receive a platelet in parallel to the handle unit 14a. The platelet is in particular produced by an injection-molding process, the platelet being already furnished with bristles before fastening. The platelet is configured to be anchored, in particular via welding, in the recess of the head region 46a. Bristle bundles may differ regarding their length, their composition, their number of bristles, a bristle material, a color, a surface structuring, and more of the like. It is also possible for angles included by the bristles and/or the bristle bundles with each other or with a surface of the base body of the head region 46a to vary between bristles and/or between bristle bundles. In the present case the application unit 12a further comprises the at least one neck region 48a, which in particular connects the head region 46a to the handle unit 14a. The neck region 48a forms a neck.

The application unit 12a is arranged on the upper side of the oral hygiene device 10a. The application unit 12a forms an uppermost point of the oral hygiene device 10a. The application unit 12a is completely made of a hard component. It would however also be conceivable that the application unit 12a is made partly of a soft component and partly of a hard component. Regarding suitable soft and hard components, the above description is referred to. Principally the application unit 12a may comprise at least one tongue cleaner element. The tongue cleaner element may in particular have nubs and/or lamellae.

Preferably the tongue cleaner element is arranged on the rear side of the head region 46a. In particular, said tongue cleaner element may be arranged on a ring that is implemented of a soft component and/or on an island that is implemented of a hard component.

The neck region 48a forms a transition between the application unit 12a and the handle unit 14a. The neck region 48a is implemented of the hard component. The lower end of the neck region 48a is realized so as to be at least partially springy.

The handle unit 14a comprises a material volume body 16a. The handle unit 14a comprises at least one gripping surface 60a, which forms a surface of the material volume body 16a. The gripping surface 60a extends on the front side 30a from the neck region 48a to the lower end of the oral hygiene device 10a on the underside. The gripping surface 60a forms a cambered, relatively concave, shape along the longitudinal axis 52a. On the rear side 26a, the cambered shape is realized inversely along the longitudinal axis 52a. In a middle or rear region of the gripping surface 60a, in particular a lettering and/or a logo could be arranged. The lettering and/or the logo may in particular be applied on the oral hygiene device 10a via indentation. The lettering and/or the logo are/is preferably arranged in the rear gripping region of the handle unit 14a. A depth of the indentation is between 0.2 mm and 0.8 mm, preferably between 0.3 mm and 0.6 mm. In particular, neither printing nor stamping is provided as this could damage the environment. Stampings could, for example, contain a metallic film. The gripping surface 60a is free of a set-off thumb grip. The handle unit 14a has continuous roundings. The handle unit 14a has continuously planar surfaces without interruptions or sharp edges. Surface lines in particular extend without offset. The roundings and surface transitions of the handle unit 14a are implemented having large radii in the longitudinal and transverse directions. There are small radii only at the ends and sidewise from the front side 30a to the rear side 26a. A maximum width of the oral hygiene device 10a from the underside to an upper side is located in the first 30% of the main extent of the oral hygiene device 10a. Beyond the maximum width, the body of the oral hygiene device 10a decreases in width continuously rearwards to the rear end. Beyond the maximum width, the body of the oral hygiene device 10a decreases in width continuously frontwards to the application unit 12a, until reaching the width of the handle unit 14a and of the neck region 48a up to the base of the head region 46a. The handle unit 14a has an approximately even material thickness in its height, in particular parallel to the height axis 54a. In the neck region 48a the material thickness decreases from the handle unit 14a to the material thickness of the head region 46a. The material thickness of the head region 46a is smaller than a material thickness of the handle unit 14a. The material thickness of the head region 46a is implements the small height of the oral hygiene device 10a. The even material thickness of the oral hygiene device 10a provides advantages in bio-degradation as the body is degraded in an advantageously even manner and remains in one piece to the end.

The material volume body 16a of the handle unit 14a is at least to a large extent made of a bio-degradable, in particular compostable, material and/or of a recycled material. The material volume body 16a of the handle unit 14a is at least to a large extent made of a plastic that is based on renewable raw materials. The material is implemented by a plastic. The material is implemented by a bio-plastic, which is in particular based on renewable materials, and/or by a bio-degradable plastic. The entire handle unit 14a and the application unit 12a are implemented of a bio-plastic. A material that is preferably made use of is in particular Grilamid, in particular from the company EMS, which is based on castor oil, Arboblend, in particular from the company Technaro, which is based on cellulose, castor, sugar or glucose, and/or Biograde, in particular from the company FKuR Kunststoff GmbH, which is based on wood, respectively cellulose. The bristles are, as has been already explained, of PA 6.10, which is made by approximately 50% to 70% of renewable materials and is based on castor oil, of PA 6.12 and/or of PA 10.10, which is made by up to 100% of renewable materials and is based on castor oil.

The oral hygiene device 10a further comprises a first material and at least one second material that differs from the first material. In particular, the oral hygiene device 10a moreover comprises a third material. In particular after a usage period of the oral hygiene device 10a, at least the second material, in particular the second material and the third material, is/are configured to be separated from the first material. The first material is configured at least partly for a disposal separately from the second material. A portion of the first material is separable from the second material in a homogeneous manner, wherein in particular a portion of the first material remains connected to the second material. The oral hygiene device 10a is configured to be severed between the head region 46a and the neck region 48a of the application unit 12a. The handle unit 14a and the neck region 48a are made only of the first material, namely the bio-plastic, wherein the bristles, which are made of a third material, are non-releasably connected at the head region 46a, which is made of the first material, by means of anchors, which are made of the second material, namely a metal. For optimum recycling, the head region 46a must therefore be disposed of separately from the handle unit 14a and the neck region 48a. It would however also be conceivable that the bristles are also made of the first material.

The oral hygiene device 10a comprises a predetermined separation point 40a for a homogeneous separation of a subregion 42a with the first material, in particular the handle unit 14a, from a subregion 44a with the second material. The first subregion 42a is implemented by the handle unit 14a and the neck region 48a of the application unit 12a. The second subregion 44a is implemented of the head region 46a of the application unit 12a, the bristles and the anchors, wherein at least the anchors are made of the second material. The predetermined separation point 40a is arranged in the neck region 48a and is configured for a separation of the handle unit 14a from the head region 46a of the application unit 12a. The predetermined separation point 40a extends transversely to the longitudinal axis 52a. The predetermined separation point 40a is arranged on a side of the neck region 48a that faces toward the head region 46a. The predetermined separation point 40a is exemplarily realized by a marking of an intended separation point. The marking is implemented of an external marking indicating a separation position. The marking indicates the position where, for example, the head region 46a is to be separated off. The marking is realized as a printing. It would however also be conceivable that the marking is realized as a circumferential indentation and/or a circumferential elevation. It would however also be conceivable that the predetermined separation point 40a′ is realized by a predetermined breaking point, which is configured to break in the case of a defined load on the application unit 12a counter to a bristle load direction 50a of the application unit 12a. A predetermined separation point 40a′ realized as a predetermined breaking point is schematically indicated in FIG. 1D. The predetermined separation point 40a′ is implemented by a notch on a rear side of the neck region 48a of the oral hygiene device 10a. The notch is arranged on a side that faces away from the bristle load direction 50a. However, principally a different implementation of the predetermined breaking point, deemed expedient by someone skilled in the art, is also conceivable. The predetermined breaking point may, for example, comprise a perforation, a scratch track, or something like that.

The production of the oral hygiene device 10a is brought about via two negative molds which together form a cavity. For this purpose, the oral hygiene device 10a has a shape-separation line 76a. The shape-separation line 76a extends over the entire length of the oral hygiene device 10a. The shape-separation line 76a has a curved shape over the length of the oral hygiene device 10a, the curved shape at least essentially following the shape of the oral hygiene device 10a. The shape-separation line 76a extends at a middle height zone of the oral hygiene device 10a. The shape-separation line 76a extends along the widest area in the cross section of the oral hygiene device 10a. This advantageously allows achieving favorable demoldability in the injection-molding tool. Advantageously, the negative molds may thus be removed from the oral hygiene device 10a without having to overcome an undercut.

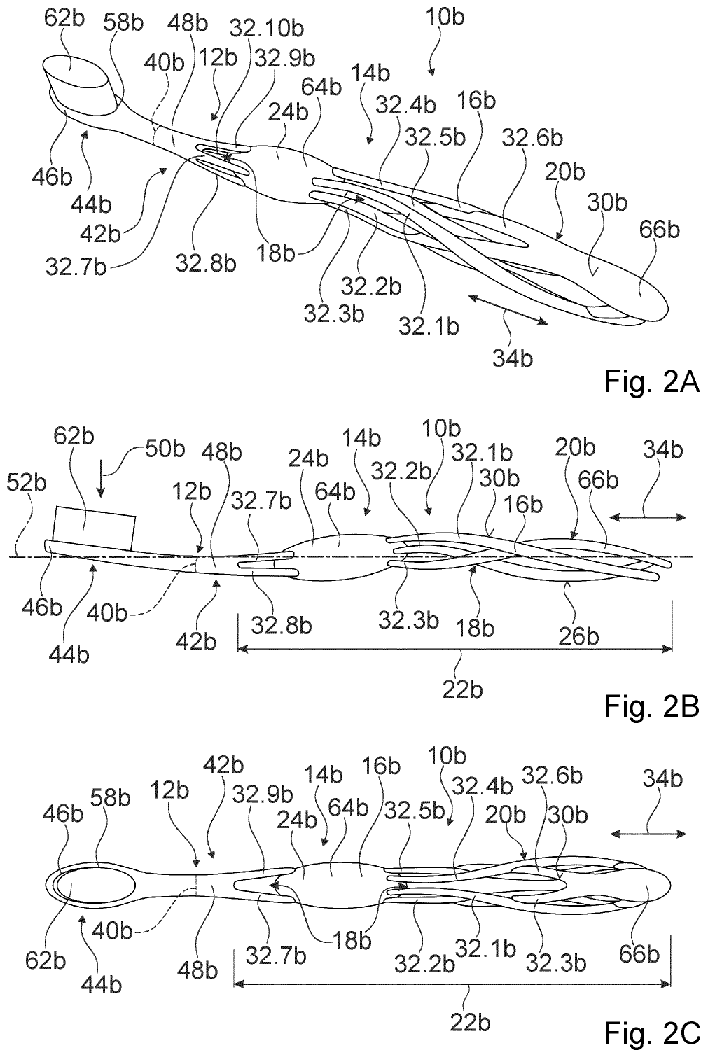

In FIGS. 2A to 11E further exemplary embodiments of the invention are shown. The following descriptions are essentially limited to the differences between the exemplary embodiments, wherein regarding components, features and functions that remain the same the description of the other exemplary embodiments, in particular of FIGS. 1A to 1G, may be referred to. In order to distinguish between the exemplary embodiments, the letter a that has been added to the reference numerals of the exemplary embodiment of FIGS. 1A to 1G has been substituted by the letters b to k in the reference numerals of FIGS. 2A to 11E. Regarding components having the same denomination, in particular components having the same reference numerals, principally the drawings and/or the description of the other exemplary embodiments, in particular of FIGS. 1A to 1G, may be referred to.

FIG. 2A shows a front side 30b of an oral hygiene device 10b with an application unit 12b and with a handle unit 14b comprising a material volume body 16b. The handle unit 14b is connected with the application unit 12b. The handle unit 14b and the application unit 12b are implemented integrally. The at least one application unit 12b comprises a head region 46b. The head region 46b forms a brush head of the oral hygiene device 10b. The head region 46b in particular comprises a base body that is embodied as a bristle carrier. The oral hygiene device 10b furthermore comprise a cleaning zone 62b, which is accommodated in the head region 46b and comprises a plurality of bristle bundles. For the sake of a better overview, in the FIGS. 2A to 2C the bristle bundles are schematically illustrated as a volume body. On the front side 30b of the head region 46b at least one recess 58b is formed. The at least one recess 58b is configured for receiving individual bristle bundles and/or a bristle platelet comprising bristle bundles.

The handle unit 14b further comprises at least one essential hollow-space structure 18b, which is at least substantially delimited by the material volume body 16b. The hollow-space structure 18b is implemented by a hollow space or several hollow spaces in the handle unit 14b. In the present case the hollow-space structure 18b is implemented by exactly two hollow spaces. The hollow-space structure 18b extends over a substantial portion of a main extent 22b of the handle unit 14b. The hollow-space structure 18b is realized in two parts, a first part of the hollow-space structure 18b extending over a front portion of the handle unit 14b that faces toward the application unit 12b and a second part of the hollow-space structure 18b extending over a rear portion of the handle unit 14b that faces away from the application unit 12b. The first part of the hollow-space structure 18b extends up to a neck region 48b of the application unit 12b.

The material volume body 16b comprises a platform 64b. The platform 64b serves for a marking. The platform 64b furthermore serves as a finger support, preferably as a thumb support. The platform 64b forms a thumb-gripping region 24b of the material volume body 16b. The platform 64b is realized by a filled body. The platform 64b is realized by an elliptic body, in particular an ellipsoid. However, principally a different shape of the platform 64b, deemed expedient by someone skilled in the art, would also be conceivable. The material volume body 16b further comprises an at least substantially bionic structure 20b. The material volume body 16b comprises a bionic structure 20b. The bionic structure 20b at least partially delimits the hollow-space structure 18b directly. The bionic structure 20b is directly adjacent to the hollow-space structure 20b. The bionic structure 20b extends over a substantial portion of the main extent 22b of the handle unit 14b. The bionic structure 20b extends over at least 70% of the main extent 22b of the handle unit 14b. In a thumb-gripping region 24b of the handle unit 14b, the bionic structure 20b is realized so as to be section-wise interrupted. The bionic structure 20b is interrupted by the platform 64b. The bionic structure 20b directly adjoins the platform 64b on both sides. The bionic structure comprises in at least one region at least three strand elements 32.1b, 32.2b, 32.3b, 32.4b, 32.5b, 32.6b, which are twisted relative to one another. In the rear handle region the bionic structure 20b exemplarily comprises precisely six strand elements 32.1b, 32.2b, 32.3b, 32.4b, 32.5b, 32.6b, which are twisted relative to one another. In the rear handle region, which is arranged on a side of the platform 64b that faces away from the application unit 12b, the bionic structure 20b comprises precisely six strand elements 32.1b, 32.2b, 32.3b, 32.4b, 32.5b, 32.6b, which are twisted relative to one another. The strand elements 32.1b, 32.2b, 32.3b, 32.4b, 32.5b, 32.6b form a reticulate structure. The strand elements 32.1b, 32.2b, 32.3b, 32.4b, 32.5b, 32.6b are at least partially intertwined with one another. The strand elements 32.1b, 32.2b, 32.3b, 32.4b, 32.5b, 32.6b partially enclose the hollow-space structure 18b. The strand elements 32.1b, 32.2b, 32.3b, 32.4b, 32.5b, 32.6b are implemented by webs which form an outer envelope of the hollow-space structure 18b. Furthermore, the strand elements 32.1b, 32.2b, 32.3b, 32.4b, 32.5b, 32.6b extend at least partially through the hollow-space structure 20b. The strand elements 32.1b, 32.2b, 32.3b, 32.4b, 32.5b, 32.6b are implemented by fine webs having a small cross section. An orientation of the strand elements 32.1b, 32.2b, 32.3b, 32.4b, 32.5b, 32.6b is essentially along a longitudinal axis 52b of the oral hygiene device 10b. The strand elements 32.1b, 32.2b, 32.3b, 32.4b, 32.5b, 32.6b intersect along the longitudinal direction of the handle unit 14b. Beyond this, a plateau 66b is built into the bionic structure 20b of the material volume body 16b, the plateau 66b being realized so as to be quasi planar between two strand elements 32.3b, 32.6b. The plateau 66b may be used for a lettering or may in particular serve ergonomic purposes, in particular for improved holding. The plateau 66b is formed at a lower end of the handle unit 14b. The strand elements 32.1b, 32.2b, 32.3b, 32.4b, 32.5b, 32.6b are spaced apart from one another in at least one cross section that is perpendicular to a main extent direction 34b of the handle unit 14b. Furthermore, in at least one cross section that is perpendicular to the main extent direction 34b of the handle unit 14b, the strand elements 32.1b, 32.2b, 32.3b, 32.4b, 32.5b, 32.6b are partly interconnected. The strand elements 32.1b, 32.2b, 32.3b, 32.4b, 32.5b, 32.6b intersect in at least one point, wherein the strand elements 32.1b, 32.2b, 32.3b, 32.4b, 32.5b, 32.6b are connected to one another in the intersection point. Preferably the strand elements 32.1b, 32.2b, 32.3b, 32.4b, 32.5b, 32.6b extend from the platform 64b separately along the longitudinal axis 52b, wherein respectively three strand elements 32.1b, 32.2b, 32.3b, 32.4b, 32.5b, 32.6b are arranged on each side. In a middle region the strand elements 32.1b, 32.2b, 32.3b, 32.4b, 32.5b, 32.6b of each side intersect at least partially, the sides remaining separate from each other. In a rear region the strand elements 32.1b, 32.2b, 32.3b, 32.4b, 32.5b, 32.6b converge, wherein a strand element 32.3b of the lefthand side and a strand element 32.6b of the righthand side converge and form the plateau 66b. The plateau 66b is arranged on the front side 30b, the two strand elements 32.3b, 32.6b that form the plateau 66b being connected to the platform 64b on a rear side 26b (FIGS. 2A, 2B, 2C).

Furthermore, the bionic structure 20b comprises in at least one region four further strand elements 32.7b, 32.8b, 32.9b, 32.10b. The bionic structure 20b exemplarily comprises four further strand elements 32.7b, 32.8b, 32.9b, 32.10b in the front handle region. In the front handle region, which is arranged on a side of the platform 64b that faces toward the application unit 12b, the bionic structure 20b comprises exactly four further strand elements 32.7b, 32.8b, 32.9b, 32.10b. The further strand elements 32.7b, 32.8b, 32.9b, 32.10b form a reticulate structure. The further strand elements 32.7b, 32.8b, 32.9b, 32.10b form a cage-like structure. The further strand elements 32.7b, 32.8b, 32.9b, 32.10b extend substantially parallel to one another. The further strand elements 32.7b, 32.8b, 32.9b, 32.10b partially enclose the hollow-space structure 18b. The further strand elements 32.7b, 32.8b, 32.9b, 32.10b are realized by webs which form an outer envelope of the hollow-space structure 18b. The further strand elements 32.7b, 32.8b, 32.9b, 32.10b partially form an outer envelope of the material volume body 16b. An orientation of the further strand elements 32.7b, 32.8b, 32.9b, 32.10b is substantially along a longitudinal axis 52b of the oral hygiene device 10b. The further strand elements 32.7b, 32.8b, 32.9b, 32.10b are furthermore arranged between the head region 46b and the platform 64b, at least partly in the neck region 48b (FIGS. 2A, 2B, 2C).

The bionic structure 20b is produced in an injection-molding procedure. The bionic structure 20b is produced via mutually contacting cores and additional core pullings. The bionic structure 20b is no longer demoldable only in one axis, therefore the additional core pullings are necessary. Alternatively, 3D printing procedures would also be conceivable for the production.

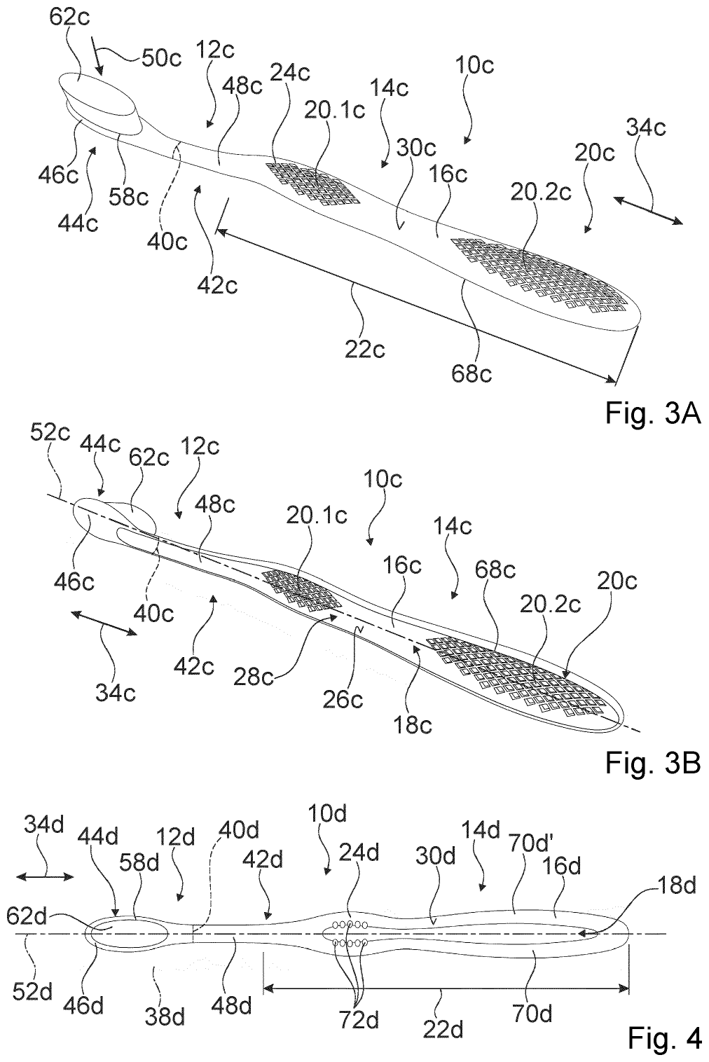

FIG. 3A shows a front side 30c of an oral hygiene device 10c with an application unit 12c and with a handle unit 14c comprising a material volume body 16c. The handle unit 14c is connected with the application unit 12c. The handle unit 14c and the application unit 12c are implemented integrally. The at least one application unit 12c comprises a head region 46c. The head region 46c forms a brush head of the oral hygiene device 10c.

The head region 46c in particular comprises a base body that is embodied as a bristle carrier. The oral hygiene device 10c furthermore comprises a cleaning zone 62c, which is accommodated in the head region 46c and comprises a plurality of bristle bundles. For the sake of a better overview, in FIGS. 3A and 3B the bristle bundles are schematically illustrated as a volume body. On the front side 30c of the head region 46c at least one recess 58c is formed. The at least one recess 58c is configured for receiving individual bristle bundles and/or a bristle platelet comprising bristle bundles.

The handle unit 14c furthermore comprises at least one essential hollow-space structure 18c, which is at least substantially delimited by the material volume body 16c. The hollow-space structure 18c is implemented by a hollow space in the handle unit 14c. In the present case the hollow-space structure 18c is implemented by exactly one hollow space. The hollow-space structure 18c extends over a substantial portion of a main extent 22c of the handle unit 14c. The hollow-space structure 18c extends from a rear end of the handle unit 14c to a neck region 48c of the application unit 12c.

The material volume body 16c further comprises an at least substantially bionic structure 20c. The material volume body 16c comprises a bionic structure 20c. The bionic structure 20c at least partly delimits the hollow-space structure 18c directly. The bionic structure 20c is directly adjacent to the hollow-space structure 18c. The bionic structure 20c extends over a substantial portion of the main extent 22c of the handle unit 14c. The bionic structure 20c extends over at least 30% of the main extent 22c of the handle unit 14c. The bionic structure 20c is implemented by a lattice structure. The bionic structure 20c comprises a plurality of regularly arranged webs which respectively delimit a recess towards the sides. The webs are interconnected to form a pattern. The webs are implemented integrally. The recesses are arranged in a defined grid pattern and have an at least substantially identical cross-section shape. By way of example, the recesses are realized in a lozenge-shape. The arrangement of the recesses forms a regular pattern. The recesses are implemented by through holes. The bionic structure 20c, which is implemented by a lattice structure, comprises several separate sub-structures 20.1c, 20.2c. The bionic structure 20c, which is implemented by a lattice structure, comprises exactly two separate sub-structures 20.1c, 20.2c, which are separated by a structure-free region of the material volume body 16c. A first sub-structure 20.1c of the bionic structure 20c is arranged in a thumb-gripping region 24c of the material volume body 16c. The first sub-structure 20.1c forms a surface structure of the thumb-gripping region 24c. A second sub-structure 20.2c of the bionic structure 20c is arranged at a rear end of the material volume body 16c. Between 5 and 18 parallel webs, preferably 7 to 13 parallel webs, are arranged per each sub-structure.

The material volume body 16c comprises the thumb-gripping region 24c. The hollow-space structure 18c is substantially open toward a rear side 26c of the oral hygiene device 10c that faces away from the thumb-gripping region 24c. In a plane that is perpendicular to a main extent direction 34c of the handle unit 14c, the material volume body 16c engages around the hollow-space structure 18c substantially in a C shape. A geometric center of the hollow-space structure 18c is surrounded by the material volume body 16c over an angle range of at least 200°. A volume of the hollow-space structure 18c is larger than a volume of the material volume body 16c, wherein in each point of the hollow-space structure 18c there is an imaginary straight line through the point, which goes through the material volume body 16c, then through the point and then once more through the material volume body 16c. The material volume body 16c is implemented in a thin-walled fashion. The material volume body 16c is produced in an injection-molding procedure. The material volume body 16c is formed like a bent plate. The bend is substantially transverse to a longitudinal axis 52c of the oral hygiene device 10c. The material volume body 16c has a mostly bent cross-section shape, such that a voluminous outer shape is created. In a plane that is perpendicular to the main extent direction 34c, the material volume body 16c has a substantially C-shaped cross section, which is open rearwards. On a side that faces away from the thumb-gripping region 24c, the material volume body 16c forms a substantially concave receiving region 28c, which delimits the hollow-space structure 18c.

The material volume body 16c has a cross-section shape that is mostly bent concavely to a rear side 26c, such that a voluminous outer shape is created. The hollow-shape structure 18c is formed by the concave bend of the material volume body 16c. The material volume body 16c is recessed from the rear, the recess being formed by the hollow-space structure 18c. The hollow-space structure 18c is implemented by the bend of the material volume body 16c. The hollow-space structure 18c extends exclusively in the handle unit 14c. However, it would also be conceivable that the hollow-space structure 18c continues via the neck region 48c into the application unit 12c. The material volume body 16c further comprises a stabilizing rim 68c on a free edge. The rim 68c has a greater material thickness than the remaining material volume body 16c. The material volume body 16c has a thin wall thickness. The thin wall thickness extends into the neck region 48c of the application unit 12c. The wall thickness of the material volume body 16c is 1 mm to 5.5 mm, preferably 2 mm to 4 mm.

The hollow-space structure 18c is substantially closed on a front side 30c that faces toward the thumb-gripping region 24c. On a front side 30c the hollow-space structure 18c is delimited by the material volume body 16c. The material volume body 16c has a cross-section shape that is bent to a front side 30c in a convex manner. On a front side 30c the hollow-space structure 18c is realized such that it is partly open only in the region of the bionic structure 20c.

FIG. 4 shows a front side 30d of an oral hygiene device 10d with an application unit 12d and with a handle unit 14d comprising a material volume body 16d. The handle unit 14d is connected with the application unit 12d. The handle unit 14d and the application unit 12d are implemented integrally. The at least one application unit 12d comprises a head region 46d. The head region 46d forms a brush head of the oral hygiene device 10d. The head region 46d in particular comprises a base body that is realized as a bristle carrier. The oral hygiene device 10d furthermore comprises a cleaning zone 62d, which is accommodated in the head region 46d and comprises a plurality of bristle bundles. For the sake of a better overview, in FIG. 4 the bristle bundles are shown as a volume body. On the front side 30d of the head region 46d at least one recess 58d is formed. The at least one recess 58d is configured for receiving individual bristle bundles and/or a bristle platelet comprising bristle bundles.

The handle unit 14d furthermore comprises at least one essential hollow-space structure 18d, which is at least substantially delimited by the material volume body 16d. The hollow-space structure 18d is implemented by a hollow space in the handle unit 14d. In the present case the hollow-space structure 18d is implemented by exactly one hollow space. The hollow-space structure 18d extends over a substantial portion of a main extent 22d of the handle unit 14d. The hollow-space structure 18d extends from a rear end of the handle unit 14d to a neck region 48d of the application unit 12d.

In at least one plane that is parallel to a main extent plane 38d of the handle unit 14d, the hollow-space structure 18d is completely enclosed by the material volume body 16d. In the main extent plane 38d of the handle unit 14d, the hollow-space structure 18d is completely enclosed by the material volume body 16d. The material volume body 16d is implemented by a ring extending around the hollow-space structure 18d. The hollow-space structure 18d is implemented by a slit that is surrounded by the material volume body 16d. The hollow-space structure 18d is implemented by an 8-shaped slit. The slit is oriented along a longitudinal axis 52d of the handle unit 14d. From a front side 30d to a rear side of the oral hygiene device 10d, the hollow-space structure 18d is delimited sideways by the material volume body 16d. The material volume body 16d is formed by two lateral longitudinal webs 70d, 70d′, which are respectively connected at a front end and a rear end. The frame enclosing the hollow-space structure 18d, which is embodied by the material volume body 16d, is implemented in a closed fashion. The application unit 12d is implemented as a solid body. In a thumb-gripping region 24d, in the region of the hollow-space structure 18d, the material volume body 16d has a surface structure in the inlets of the slit. On the front side 30d the material volume body 16d has several projections 72d which form the surface structure. The shape of the material volume body 16d is realized in a rounded fashion. The longitudinal webs 70d, 70d′ of the material volume body 16d have an essentially round cross section. The hollow-space structure 18d that is realized as a slit has a length of 30 mm to 180 mm, preferably of 60 mm to 150 mm. The hollow-space structure 18d that is realized as a slit has a width of 3 mm to 15 mm, preferably of 5 mm to 10 mm. A height of the hollow-space structure 18d that is realized as a slit in particular at least approximately corresponds to a width of the hollow-space structure 18d.

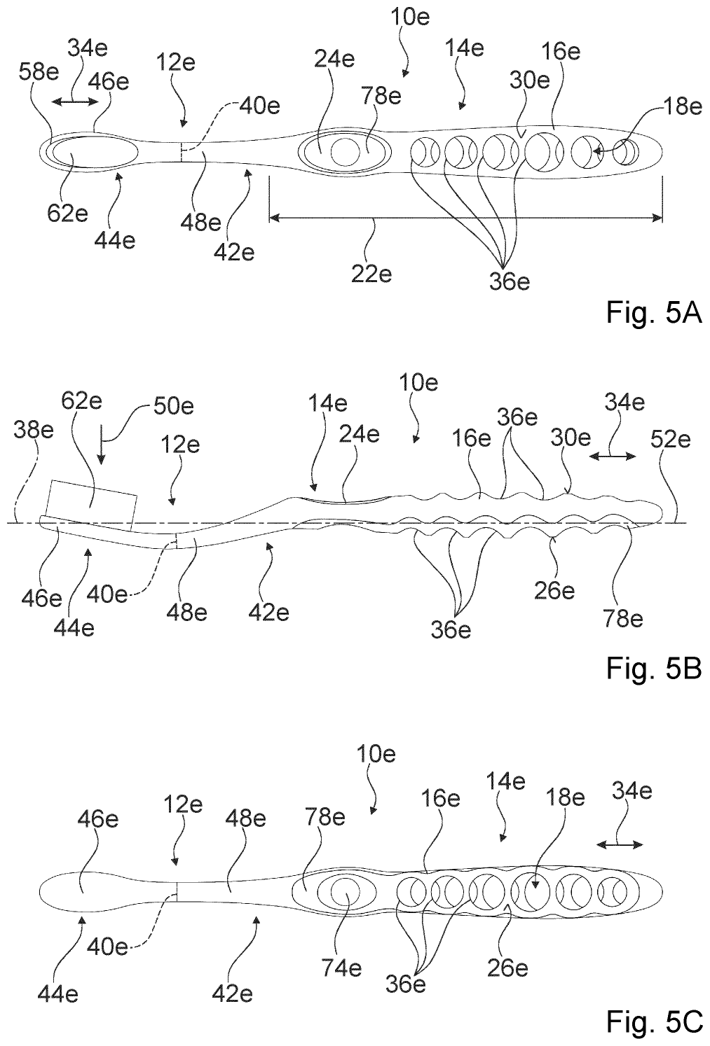

FIGS. 5A to 5C show a front side 30e of an oral hygiene device 10e with an application unit 12e and with a handle unit 14e comprising a material volume body 16e. The handle unit 16e is connected with the application unit 12e. The handle unit 14e and the application unit 12e are implemented integrally. The at least one application unit 12e comprises a head region 46e. The head region 46e forms a brush head of the oral hygiene device 10e. The head region 46e in particular comprises a base body that is embodied as a bristle carrier. The oral hygiene device 10e further comprises a cleaning zone 62e, which is accommodated in the head region 46e and comprises a plurality of bristle bundles. For the sake of a better overview, in FIGS. 5A to 5C the bristle bundles are shown as a volume body. On the front side 30e of the head region 46e at least one recess 58e is formed. The at least one recess 58e is configured for receiving individual bristle bundles and/or a bristle platelet comprising bristle bundles.

The handle unit 14e further comprises at least one essential hollow-space structure 18e, which is delimited at least substantially by the material volume body 16e. The hollow-space structure 18e is implemented by a hollow space in the handle unit 14e. In the present case the hollow-space structure 18e is implemented by exactly one hollow space. The hollow-space structure 18e extends over a substantial portion of a main extent 22e of the handle unit 14e. The hollow-space structure 18e extends from a rear end of the handle unit 14e up to a neck region 48e of the application unit 12e.

In at least one plane that is parallel to a main extent plane 38e of the handle unit 14e, the hollow-space structure 18e is completely enclosed by the material volume body 16e. In the main extent plane 38e of the handle unit 14e, the hollow-space structure 18e is completely enclosed by the material volume body 16e. In at least one cross section that is perpendicular to a main extent direction 34e of the handle unit 14e, the hollow-space structure 18e is surrounded by the material volume body 16e. The material volume body 16e comprises a recess 36e, via which the hollow-space structure 18e is connected to an environment. The material volume body 16e comprises a plurality of defined recesses 36e. With the exception of the recesses 36e, the material volume body 16e delimits the hollow-space structure 18e completely. The recesses 36e are implemented in a non-connected manner and in each case have an area of maximally 1.5 cm². The hollow-space structure 18e is arranged in the voluminous portions of the handle unit 14e. In a region delimiting the hollow-space structure 18e, the material volume body 16e has a low wall thickness. The recesses 36e have different orientations. The recesses 36e are implemented in a circle-shaped manner. On a front side 30e, six recesses 36e are arranged. The recesses 36e on the front side 30e have different diameters, wherein a diameter of the recesses 36e increases toward a center of the handle unit 14e. On a rear side 26e, six recesses 36e are arranged. The recesses 36e on the rear side 26e have different diameters, wherein a diameter of the recesses 36e increases toward a center of the handle unit 14e. The recesses 36e of the front side and the rear side are arranged offset from one another. The material volume body 16e further comprises a thumb-gripping region 24e. The thumb-gripping region 24e is formed by a concave hollow in the handle unit 14e. On the rear side 26e of the oral hygiene device 10e, a deepening 74e with a through hole is arranged, which corresponds to the thumb-gripping region 24e. The recesses 36e are arranged only on a side of the thumb-gripping region 24e that faces away from the application unit 12e. The hollow-space structure 18e extends through the material volume body 16e on a side of the thumb-gripping region 24e that faces away from the application unit 12e.

The recesses 36e are arranged at approximately equal distances in a row along a longitudinal axis 52e of the handle unit 14e. The recesses 36e of the front side 30e and the recesses 36e the rear side 26e are arranged offset from one another. The recesses 36e, respectively the hollows they induce in the wall of the material volume body 16e, are spaced apart from one another by webs of the material volume body 16e. In the illustrated implementation, five webs are formed on the front side 30e and five webs are formed on the rear side 26e. After penetrating the wall of the material volume body 16e, the recesses 36e end in the hollow-space structure 18e. Due to the recesses 36e the hollow-space structure 18e is open toward the environment. In one possible implementation items can be laid into the hollow-space structure 18e.

In the hollow-space structure 18e conically converging transverse ribs (not shown in detail) are arranged, which are oriented transversely to the longitudinal axis 52e. These transverse ribs are due to the manufacturing process.

In the present case, in FIGS. 5A to 5C an exemplary embodiment is shown which is producible with one material component or several material components. The marked volumes are realized in a further material component 78e. On the rear side 26e the further material component 78e forms the geometry around the recesses 36e, and thus forms part of the rear side 26e. In the thumb-gripping region 24e a deepening 74e with a pass-through opening is created, through which the further material component 78e is guided from the rear side 26e to the front side 30e. The thumb-gripping region 24e, respectively the deepening 74e with the pass-through opening, is at least partially covered in the further material component 78e.

On the rear side 26e, the further material component 78e may form the webs between the recesses 36e partially or entirely. The further material component 78e may either be applied on a “carrier element” of the volume body 16e and form the webs, or the further material component 78e forms the webs on its own, without additional material components.

The oral hygiene device 10e is produced in an injection-molding procedure. The recesses 36e that are open toward the front side 30e of the oral hygiene device 10e are formed by conically tapering finger elements, while the recesses 36e that are open toward the rear side 26e are also formed by conically tapering finger elements. The finger elements respectively engage in each other and contact each other in the hollow-space structure 18e in order to exclude a flowthrough of material, in particular plastic. In the finished oral hygiene device 10e the mutually contacting finger elements form the recesses 36e and the hollow-space structure 18e. A cavity that is filled with material, in particular plastic, during production defines the shape of the material volume body 16e of the handle unit 14e and of the application unit 12e.

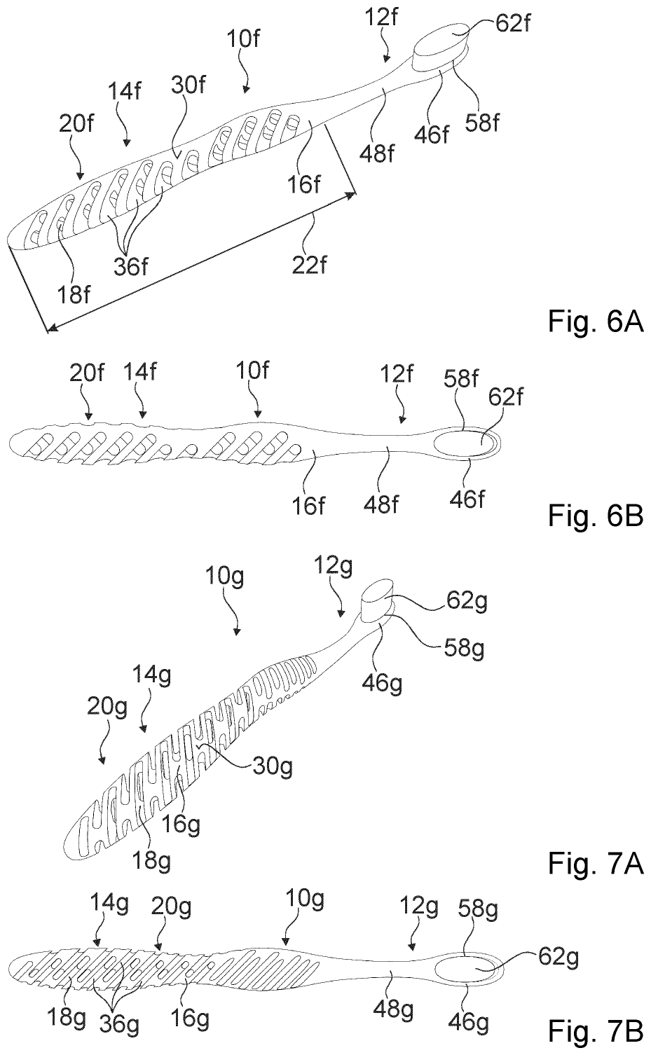

FIGS. 6A and 6B show a further implementation. FIG. 6A shows a front side 30f of an oral hygiene device 10f with an application unit 12f and with a handle unit 14f comprising a material volume body 16f. The handle unit 14f is connected with the application unit 12f. The handle unit 14f and the application unit 12f are implemented integrally. The at least one application unit 12f comprises a head region 46f. The head region 46f forms a brush head of the oral hygiene device 10f. The head region 46f in particular comprises a base body that is embodied as a bristle carrier. The oral hygiene device 10f further comprises a cleaning zone 62f, which is accommodated in the head region 46f and comprises a plurality of bristle bundles. For the sake of a better overview, in FIGS. 6A and 6B the bristles bundles are schematically shown as a volume body. On the front side 30f of the head region 46f at least one recess 58f is formed. The at least one recess 58f is configured for receiving individual bristle bundles and/or a bristle platelet comprising bristle bundles.

The handle unit 14f further comprises at least one essential hollow-space structure 18f, which is at least substantially delimited by the material volume body 16f. The hollow-space structure 18f is implemented by several hollow spaces in the handle unit 14f. In the present case the hollow-space structure 18f is implemented by a hollow space formed over different recesses 36f. The hollow-space structure 18f extends over a substantial portion of a main extent 22f of the handle unit 14f. The hollow-space structure 18f is realized in a one-part implementation and extends to a neck region 48f of the application unit 12f.

The material volume body 16f further comprises an at least substantially bionic structure 20f. The material volume body 16f comprises a bionic structure 20f. The bionic structure 20f at least partially delimits the hollow-space structure 18f directly. The bionic structure 20f is formed by means of different recesses 36f. The recesses 36f are molded both from the front side 30f and from the rear side 26f. The recesses 36f extend into the body from an outer side. In FIGS. 6A and 6B the recesses 36f realized in a slit-like manner. The recesses 36f of the front side 30f and the rear side 26f intersect and at least partially merge with one another. The slit-shaped recesses 36f are oriented at an angle with respect to the main extent direction 34f, wherein the recesses 36f of the front side 30f and the recesses 36f of the rear side 26f are arranged symmetrically with respect to an orientation relative to the main extent direction 34f. As a result of such an arrangement of the recesses 36f, the stability of the entire body is ensured despite material is saved and the body is not flexible.

Furthermore, the recesses 36f are open on the front side 30f as well as on the rear side 26f to the lefthand side or to the righthand side, wherein the recesses 36f on the front side 30f are open toward one side and the recesses 36f on the rear side 26f are open toward the other side. As a result, sidewise on the left and on the right, at the transition to the front side 30f, respectively to the rear side 26f, there is in each case a contiguous closed portion extending from the underside to the upper side, i. e. to the application unit 12f.

The recesses 36f are preferably realized in the handle unit 14f and they end in the thumb-gripping region 24f, respectively they are not implemented up to the neck region 48f.

The bionic structure 20f is produced in an injection-molding procedure. The bionic structure 20f is produced via mutually contacting cores. The bionic structure 20f is demoldable along an axis. Alternatively, 3D printing procedures would also be conceivable for a production.

FIGS. 7A and 7B show a further implementation. FIG. 7A shows a front side 30g of an oral hygiene device 10g with an application unit 12g and with a handle unit 14g comprising a material volume body 16g. The handle unit 14g is connected with the application unit 12g. The handle unit 14g and the application unit 12g are implemented integrally. The at least one application unit 12g comprises a head region 46g. The head region 46g forms a brush head of the oral hygiene device 10g. The head region 46g in particular comprises a base body that is embodied as a bristle carrier. The oral hygiene device 10g further comprises a cleaning zone 62g, which is accommodated in the head region 46g and comprises a plurality of bristle bundles. For the sake of a better overview, in FIGS. 7A and 7B the bristle bundles are depicted schematically as a volume body. On the front side 30g of the head region 46g at least one recess 58g is formed. The at least one recess 58g is configured for receiving individual bristle bundles and/or a bristle platelet comprising bristle bundles.

The handle unit 14g comprises several hollow-space structures 18g, which are at least substantially delimited by the material volume body 16g. The hollow-space structure 18g is implemented by several hollow spaces in the handle unit 14g. In the present case the hollow-space structure 18g is formed in respectively one recess 36g. The hollow-space structure 18g extends over a substantial portion of a main extent 22b of the handle unit 14g. The hollow-space structure 18g extends to a neck region 48g of the application unit 12g.

The material volume body 16g further comprises an at least substantially bionic structure 20g. The material volume body 16g comprises a bionic structure 20g. The bionic structure 20g at least partially delimits the hollow-space structure 18g directly. The bionic structure 20g is realized by different recesses 36g. The recesses 36g are molded from the front side 30g as well as from the rear side 26g. The recesses 36g extend from into the body an outside. The recesses 36g in FIGS. 7A and 7B are realized in a slit-shaped manner. The recesses 36g of the front side 30g and of the rear side 26g partly contact each other, thus forming breakthroughs between the front side 30g and the rear side 26g. The slit-shaped recesses 36g are oriented at an angle to a main extent direction, wherein the recesses 36g of the front side 30g and the recesses 36g of the rear side 26g are arranged parallel to the orientation relative to the main extent direction. Due to this arrangement of the recesses 36g, an at least partially flexible body is implemented. The recesses 36g are respectively arranged alternatingly in a one-sided or two-sided fashion. “One-sided” means in the present case only from the front side 30g or from the rear side 26g. “Two-sided” means that a recess 36g is implemented in a same position from the front side 30g and from the rear side 26g.

Furthermore, the recesses 36g are open on the front side 30g and on the rear side 26g, to the lefthand side or to the righthand side respectively.

The recesses 36g are preferably formed in the handle unit 14g, and they end in the thumb-gripping region 24g, and/or are not implemented up to the neck region 48g. The depth of the recesses 36g is preferably reduced in a region of the transition from the handle unit 14g to the neck region 48g. In this way the material volume body 16g is fuller and the stability of the body is augmented.

The bionic structure 20g is produced in an injection-molding procedure. The bionic structure 20g is produced via mutually contacting cores. The bionic structure 20g can be demolded along an axis. Alternatively, 3D printing procedures would also be conceivable for a production.

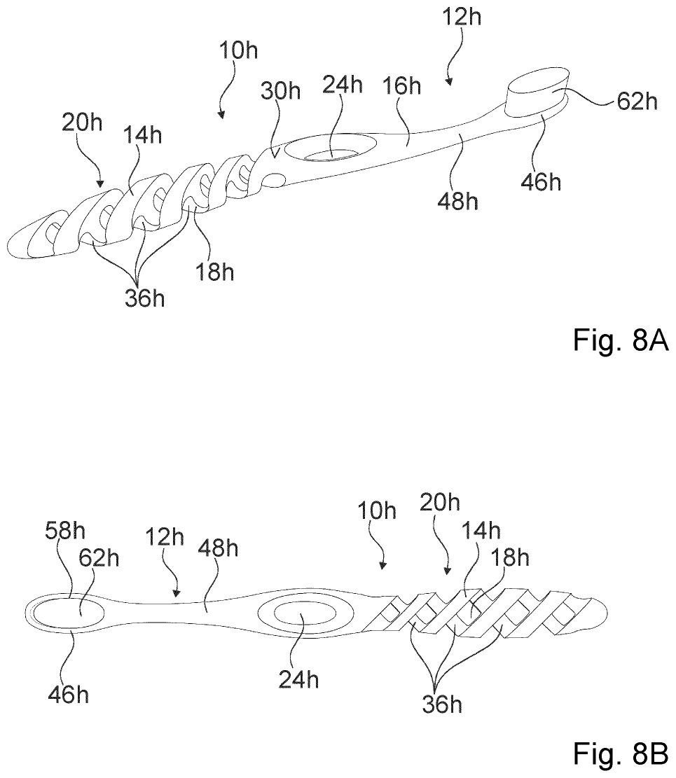

FIGS. 8A and 8B show a further implementation. FIG. 8A shows a front side 30h of an oral hygiene device 10h with an application unit 12h and with a handle unit 14h comprising a material volume body 16h. The handle unit 14h is connected with the application unit 12h. The handle unit 14h and the application unit 12h are implemented integrally. The at least one application unit 12h comprises a head region 46h. The head region 46h forms a brush head of the oral hygiene device 10h. The head region 46h in particular comprises a base body that is embodied as a bristle carrier. The oral hygiene device 10h further comprises a cleaning zone 62h, which is accommodated in the head region 46h and comprises a plurality of bristle bundles. For the sake of a better overview, in FIGS. 8A and 8B the bristle bundles are depicted schematically as a volume body. On the front side 30h of the head region 46h at least one recess 58h is formed. The at least one recess 58h is configured for receiving individual bristle bundles and/or a bristle platelet comprising bristle bundles.

The handle unit 14h comprises one or several hollow-space structure/s 18h, which is/are substantially delimited by the material volume body 16h. The hollow-space structure 18h is implemented by several hollow spaces in the handle unit 14h. The hollow-space structure 18h extends over a substantial portion of a main extent of the handle unit 14h. The hollow-space structure 18h extends to a neck region 48h of the application unit 12h.

The material volume body 16h further comprises an at least substantially bionic structure 20h. The material volume body 16h comprises a bionic structure 20h. The bionic structure 20h at least partially delimits the hollow-space structure 18h directly. The bionic structure 20h is formed by a contiguous recess 36h in the shape of a double helix. The recesses 36h are thus formed both from the front side 30h and from the rear side 26h. The recesses 36h extend into the body from an outside. The recesses 36h of the front side 30h and the rear side 26h partially contact each other, thus forming breakthroughs between the front side 30h and the rear side 26h. The slit-shaped recesses 36h are oriented at an angle to a main extent direction, the recesses 36h of the front side 30h and the recesses 36h of the rear side 26h being arranged crosswise relative to the orientation with respect to the main extent direction, in the shape of a double helix.

The recesses 36h are formed in the handle unit 14h and they end in the thumb-gripping region 24h, and/or they are not implemented up to the neck region 48h. Preferably the recesses 36h are formed in the handle unit 14h. In the thumb-gripping region 24h a pass-through opening is formed which is implemented in a rounded shape, thus forming the structure for the thumb support.

The bionic structure 20h is produced in an injection-molding procedure. The bionic structure 20h is produced via mutually contacting cores. The bionic structure 20h can be demolded along an axis. Alternatively, 3D printing procedures would also be conceivable for a production.

In addition to the hard component that was already discussed, further components may be employed, for example soft components. The soft component may be used, for example, for filling the thumb gripping region 24h on the surface, thus creating improved haptics in this region. The soft component may herein be arranged in a deepening and may be guided through said deepening from the front side 30h to the rear side 26h, thus improving haptics on both sides of the thumb-gripping region 24h.

The implementations shown in FIGS. 6 to 8 are producible by multi-component injection molding. Besides the afore-described hard component further components may be employed. For example, a soft component may be used. The soft component may fill part of the recesses 36f, 36g, 36h and may exit to the grippable surface, thus changing optic and haptic characteristics of the product. For example in the implementation illustrated in FIGS. 6A and 6B, the recesses 36f situated next to the thumb-gripping region 24f may be filled with a soft component. As a result, grippability will be improved and the thumb will lie stably on the product.

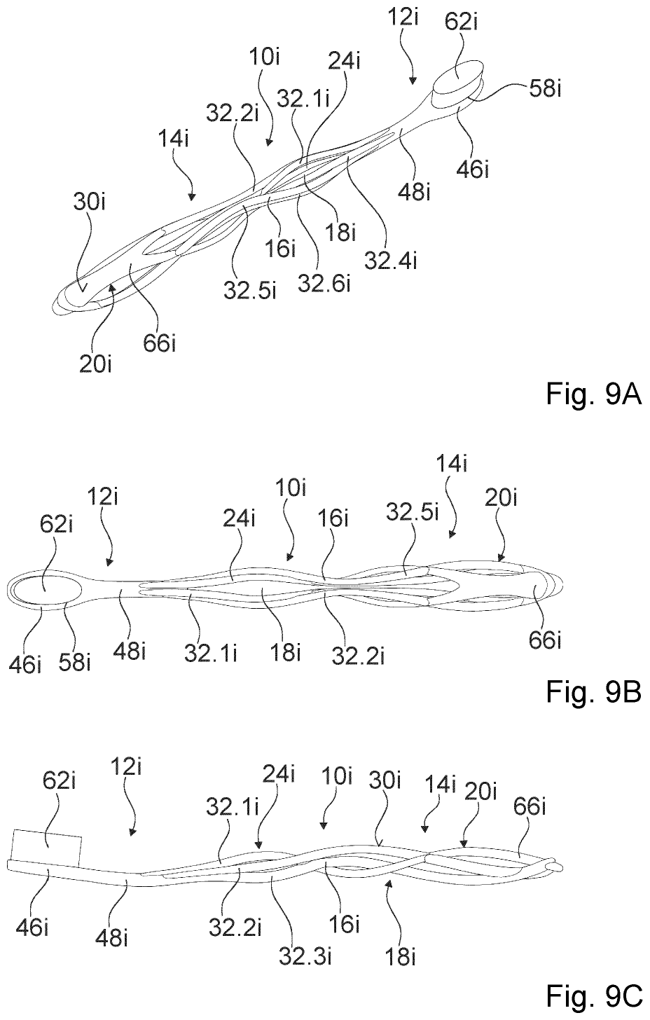

In FIGS. 9A, 9B and 9C a further implementation is shown. FIG. 9A shows a front side 30i of an oral hygiene device 10i with an application unit 12i and with a handle unit 14i comprising a material volume body 16i. The handle unit 14i is connected with the application unit 12i. The handle unit 14i and the application unit 12i are implemented integrally. The at least one application unit 12i comprises a head region 46i. The head region 46i forms a brush head of the oral hygiene device 10i. The head region 46i in particular comprises a base body that is embodied as a bristle carrier. The oral hygiene device 10i further comprises a cleaning zone 62i, which is accommodated in the head region 46i and comprises a plurality of bristle bundles. For the sake of a better overview, in FIGS. 9A to 9C the bristle bundles are depicted schematically as a volume body. On the front side 30i of the head region 46i at least one recess 58i is formed. The at least one recess 58i is configured for receiving individual bristle bundles or a platelet comprising bristle bundles.

The handle unit 14i further comprises at least one essential hollow-space structure 18i, which is at least substantially delimited by the material volume body 16i. The hollow-space structure 18i is implemented by a hollow space or several hollow spaces in the handle unit 14i. In the present case the hollow-space structure 18i is implemented by one hollow space. The hollow-space structure 18i extends over a substantial portion of a main extent of the handle unit 14i. The hollow-space structure 18i is realized in a one-part implementation. The hollow-space structure 18i extends to a neck region 48i of the application unit 12i.

The material volume body 16i further comprises an at least substantially bionic structure 20i. The material volume body 16i comprises a bionic structure 20i. The bionic structure 20i at least partially delimits the hollow-space structure 18i directly. The bionic structure 20i is directly adjacent to the hollow-space structure 18i. The bionic structure 20i extends over a substantial portion of the main extent of the handle unit 14d. The bionic structure 20i extends over at least 70% of the main extent of the handle unit 14d. In at least one region the bionic structure 20i comprises at least three strand elements 32.1i, 32.2i, 32.3i, 32.4i, 32.5i, 32.6i, which are twisted relative to one another. In the rear handle region the bionic structure 20i exemplarily comprises exactly six strand elements 32.1i, 32.2i, 32.3i, 32.4i, 32.5i, 32.6i which are twisted relative to one another. The bionic structure 20i comprises exactly six strand elements 32.1i, 32.2i, 32.3i, 32.4i, 32.5i, 32.6i which are twisted relative to one another. The strand elements 32.1i, 32.2i, 32.3i, 32.4i, 32.5i, 32.6i form a reticulate structure. The strand elements 32.1i, 32.2i, 32.3i, 32.4i, 32.5i, 32.6i are at least partially intertwined with one another. The strand elements 32.1i, 32.2i, 32.3i, 32.4i, 32.5i, 32.6i partially enclose the hollow-space structure 18i. The strand elements 32.1i, 32.2i, 32.3i, 32.4i, 32.5i, 32.6i are implemented by webs forming an outer envelope of the material volume body 16i. The strand elements 32.1i, 32.2i, 32.3i, 32.4i, 32.5i, 32.6i form an outer envelope of the material volume body 16i. Furthermore, the strand elements 32.1i, 32.2i, 32.3i, 32.4i, 32.5i, 32.6i extend at least partially through the hollow-space structure 18i. The strand elements 32.1i, 32.2i, 32.3i, 32.4i, 32.5i, 32.6i are implemented by thin webs having a small cross section. The strand elements 32.1i, 32.2i, 32.3i, 32.4i, 32.5i, 32.6i are oriented substantially along a longitudinal axis of the oral hygiene device 10i. The strand elements 32.1i, 32.2i, 32.3i, 32.4i, 32.5i, 32.6i intersect along the longitudinal direction of the handle unit 14i.

In the thumb-gripping region 24i the strand elements 32.1i, 32.2i, 32.3i, 32.4i, 32.5i, 32.6i are shaped so as to form a hollow for the thumb support. For this purpose, viewed from the underside, the strand elements 32.1i, 32.2i, 32.3i, 32.4i, 32.5i, 32.6i diverge and then converge, such that the hollow is formed.

Beyond this a plateau 66i is built into the bionic structure 20i of the material volume body 16i, the plateau 66i being implemented approximately planar between two strand elements 32.1i, 32.4i. The plateau 66i may be used for a lettering or may in particular serve ergonomic purposes, in particular for improved holding. The plateau 66i is implemented at a lower end of the handle unit 14i. In at least one cross section perpendicular to a main extent direction 34i of the handle unit 14i, the strand elements 32.1i, 32.2i, 32.3i, 32.4i, 32.5i, 32.6i are spaced apart from one another. Furthermore, the strand elements 32.1i, 32.2i, 32.3i, 32.4i, 32.5i, 32.6i are partially connected to one another in at least one cross section perpendicular to the main extent direction 34i of the handle unit 14i. In a rear region the strand elements 32.1i, 32.2i, 32.3i, 32.4i, 32.5i, 32.6i converge, wherein one strand element 32.1i of the lefthand side and one strand element 32.4i of the righthand side converge and form the plateau 66i. The plateau 66i is arranged on the front side 30i (cf. FIGS. 9A, 9B, 9C).

The bionic structure 20i is produced in an injection-molding procedure. The bionic structure 20i is produced by means of mutually contacting cores and additional core pullings. The bionic structure 20i cannot be demolded in only one axis, therefore the additional core pullings are necessary. Alternatively, 3D printing procedures would also be conceivable for a production.

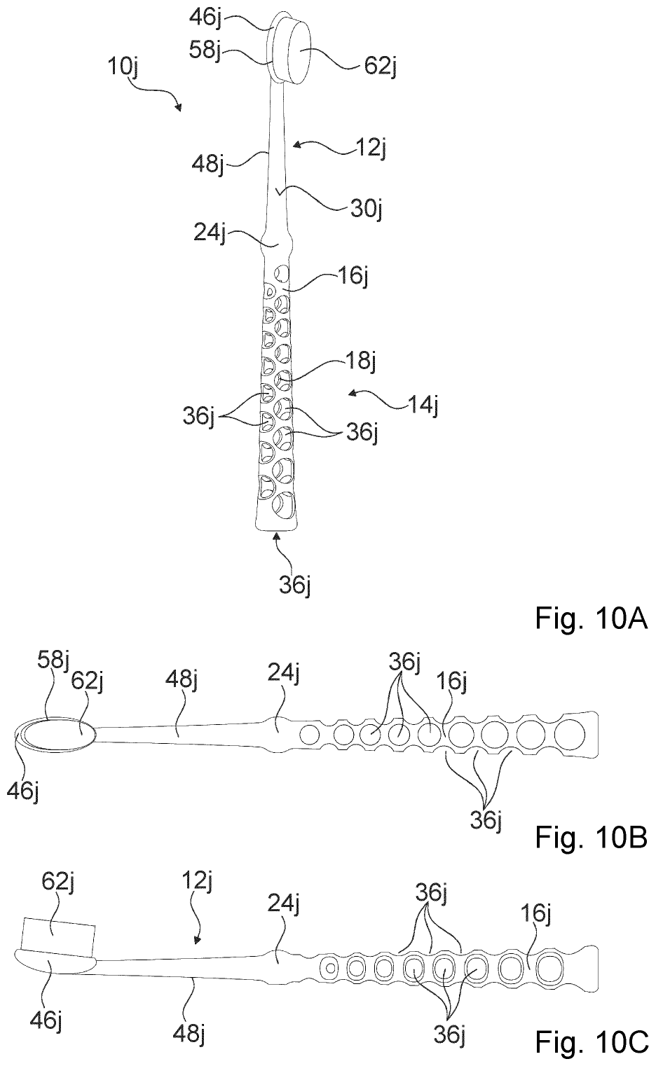

FIGS. 10A and 10B show a front side 30j of an oral hygiene device 10j with an application unit 12j and with a handle unit 14j comprising a material volume body 16j. The handle unit 14j is connected with the application unit 12j. The handle unit 14j and the application unit 12i are implemented integrally. The at least one application unit 12j comprises a head region 46j. The head region 46j forms a brush head of the oral hygiene device 10j. The head region 46j in particular comprises a base body which is embodied as a bristle carrier. The oral hygiene device 10j further comprises a cleaning zone 62j, which is accommodated in the head region 46j and comprises a plurality of bristle bundles. For the sake of a better overview, in FIGS. 10A to 10C the bristle bundles are depicted as a volume body. On the front side 30j of the head region 46j at least one recess 58j is formed. The at least one recess 58j is configured for receiving individual bristle bundles or a bristle platelet comprising bristle bundles.

The handle unit 13j further comprises at least one essential hollow-space structure 18j, which is at least substantially delimited by the material volume body 16j. The hollow-space structure 18j is implemented by a hollow space in the handle unit 14j. In the present case the hollow-space structure 18j is implemented by exactly one hollow space. The hollow-space structure 18j extends over a substantial portion of a main extent of the handle unit 14j. The hollow-space structure 18j extends from a rear end of the handle unit 14j to a thumb-gripping region 24j of the application unit 12j.

The hollow-space structure 18j is enclosed by the material volume body 16j. The material volume body 16j comprises recesses 36j, which are offset all around and which enter the hollow-space structure 18j from an outside. The volume body 16j comprises at least one recess 36j via which the hollow-space structure 18j is connected to an environment. The material volume body 16j has several defined recesses 36j. With the exception of the recesses 36j, the material volume body 16j delimits the hollow-space structure 18j completely. The recesses 36j are implemented in a non-connected fashion and respectively have an area of maximally 1.5 cm². The hollow-space structure 18j is arranged in the voluminous portions of the handle unit 14j. The material volume body 16j has a small wall thickness in a region delimiting the hollow-space structure 18j. The recesses 36j have different orientations. The recesses 36j are realized in a circular shape. On a front side 30j six recesses 36j are arranged. The recesses 36j on the front side 30j have different diameters, wherein a diameter of the recesses 36j increases toward a middle of the handle unit 14j. On a rear side six recesses 36j are arranged. The recesses 36j on the rear side have different diameters, wherein a diameter of the recesses 36j increases toward a middle of the handle unit 14j. The recesses 36j of the front side 30j and of the rear side and on the lefthand and righthand sides are arranged offset from one another. The material volume body 16j further comprises a thumb-gripping region 24j. The thumb-gripping region 24j is formed by a sphere-shaped elevation extending around the body in the handle unit 14j. The recesses 36j are arranged at approximately equal distances from each other in a row along a longitudinal axis of the handle unit 14j. The recesses 36j are arranged offset from one another. The recesses 36j, respectively the cavities caused by the recesses 36j in the wall of the material volume body 16j, are spaced apart from one another by webs of the material volume body 16j. After penetrating the wall of the material volume body 16j, the recesses 36j end in the hollow-space structure 18j. The hollow-space structure 18j is open toward the environment via the recesses 36j. In one possible implementation, objects can be laid into the hollow-space structure 18j. There is also a recess 36j arranged on the underside of the handle unit 14j.

The bionic structure 20j is produced in an injection-molding procedure. The bionic structure 20j is produced via mutually contacting cores and additional core pullings. The bionic structure 20j cannot be demolded in only one axis, therefore the additional core pullings are necessary. Alternatively 3D printing procedures would also be conceivable for a production.

The implementation variant according to FIGS. 10A to 10C may also be realized with one or several further material components. For example, a soft component may fill a portion of the hollow-space structure 18j and may exit to the surface of the handle unit 14j through the recesses 36j. Herein, for example, a spherical closure may be created, bringing certain haptic characteristics on the surface. Furthermore, for example, the closure of the body on the underside may be provided with a rim that is made of a soft component.

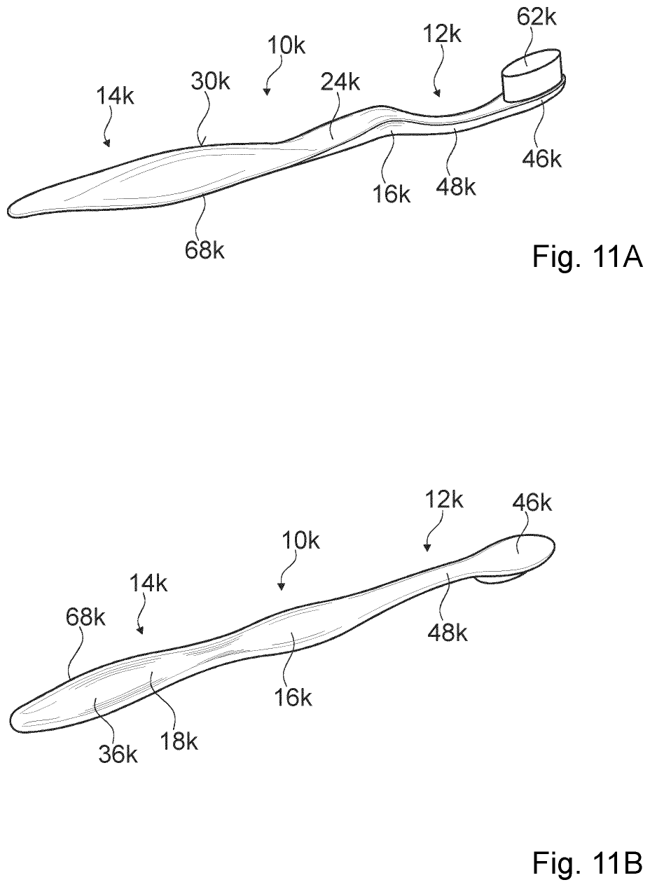

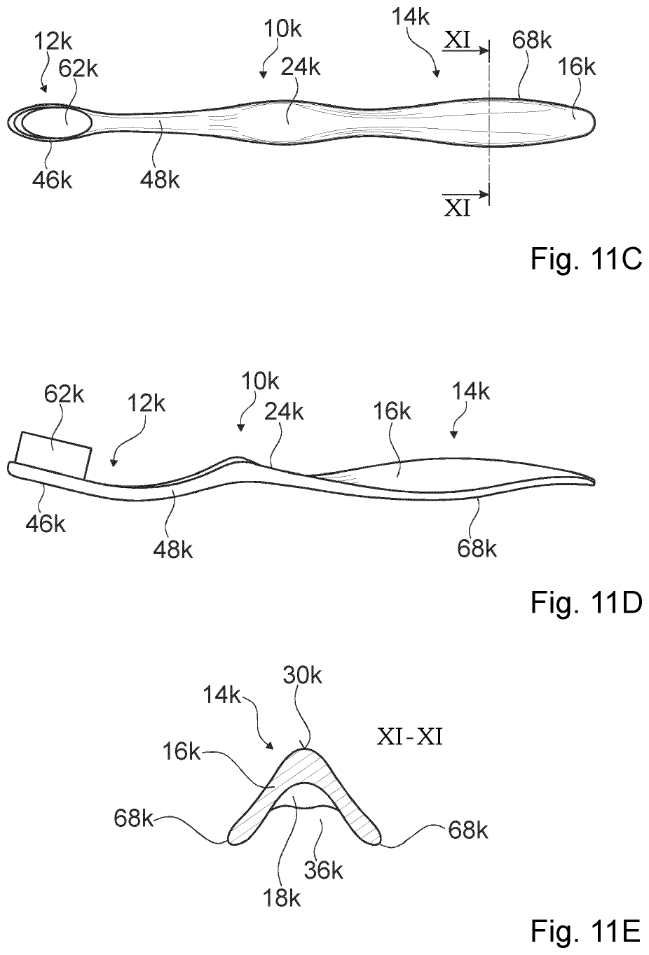

FIGS. 11A and 11 E show a front side 30k of an oral hygiene device 10k with an application unit 12k and with a handle unit 14k comprising a material volume body 16k. The handle unit 14k is connected with the application unit 12k. The handle unit 14k and the application unit 12k are implemented integrally. The at least one application unit 12k comprises a head region 46k. The head region 46k forms a brush head of the oral hygiene device 10k. The head region 46k in particular comprises a base body that is realized as a bristle carrier. The oral hygiene device 10k further comprises a cleaning zone 62k, which is accommodated in the head region 46k and comprises a plurality of bristle bundles. For the sake of a better overview, in FIGS. 11A to 11D the bristle bundles are shown as a volume body. On the front side 30k of the head region 46k at least one recess is formed. The at least one recess is configured for receiving individual bristle bundles or a bristle platelet comprising bristle bundles.

The handle unit 14k further comprises at least one essential hollow-space structure 18k, which is at least substantially delimited by the material volume body 16k. The hollow-space structure 18k is implemented by a hollow space in the handle unit 14k. In the present case the hollow-space structure 18k is implemented by exactly one hollow space.

The hollow-space structure 18k extends over a substantial portion of a main extent of the handle unit 14k. The hollow-space structure 18k extends from a rear end of the handle unit 14k to a thumb-gripping region 24 of the application unit 12k.

The hollow-space structure 18k is enclosed by the material volume body 16k. The material volume body 16k has recesses 36k, which are offset all around and which enter the hollow-space structure 18k from an outside. The volume body 16k comprises at least one recess 36k via which the hollow-space structure 18k is connected to an environment. With the exception of the recesses 36k, the material volume body 16k delimits the hollow-space structure 18k completely. The hollow-space structure 18k is arranged in the voluminous portions of the handle unit 14k. The material volume body 16k has a small wall thickness in a region delimiting the hollow-space structure 18k. The material volume body 16k further comprises a thumb-gripping region 24k. The thumb-gripping region 24k is implemented by a hollow in the handle unit 14k.

The body is produced in an injection-molding procedure. Alternatively, 3D printing procedures would also be conceivable for a production.

The implementation variant according to FIGS. 11A to 11 E may also be implemented with one or several further material components. For example, a soft component may fill a portion of the hollow-space structure 18k, exiting to the surface of the front side 30k of the handle unit 14k through breakthroughs. In this way it is, for example, possible to create a spherical closure that brings certain haptic characteristics to the surface. Thus, for example, improved haptics may be created in the thumb-gripping region 24k.

The material volume body 16k comprises at least one thumb-gripping region 24k, wherein the hollow-space structure 18k is at least substantially open toward a rear side that faces away from the thumb-gripping region 24k. Preferably, in a plane that is perpendicular to the main extent direction of the handle unit 14k, the material volume body 16k engages around the hollow-space structure 18k at least substantially in a C shape. A volume of the hollow-space structure 18k is in particular larger than a volume of the material volume body 16k, wherein in particular in each point of the hollow-space structure 18k there is an imaginary straight line through the point, which goes through the material volume body 16k, then through the point and then once again through the material volume body 16k. The material volume body 16k is in particular implemented in a thin-walled fashion. The material volume body 16k is in particular formed like a bent plate. Preferably the material volume body 16k is produced in an injection-molding procedure. The material volume body 16k is in particular realized by something like a plate which is bent. The bend is in particular substantially transverse to the longitudinal axis of the handle unit 14k. The material volume body 16k in particular has a mostly bent cross-section shape, thus creating a voluminous outer shape. Preferentially the material volume body 16k is recessed from behind, the recess 36k being realized by the hollow-space structure 18k.

The hollow-space structure 18k is in particular formed by the bend of the material volume body 16k. However, the head region 46k of the application unit 12k is preferably implemented as a solid body, in particular for a bristle fixing with anchor punching or for welding. The material volume body 16k furthermore in particular comprises a stabilizing rim 68k on a free edge. The rim 68k may in particular have a greater material thickness than the remaining material volume body 16k. The material volume body 16k in particular has a thin wall thickness. The thin wall thickness in particular extends into the neck region 48k of the application unit 12k. The thin wall thickness is, for example, brought about by recesses 36k on the rear side.

On a side facing away from the at least one thumb-gripping region 24k, the material volume body 16k forms a substantially concave receiving region, which delimits the hollow-space structure 18k. The material volume body 16k in particular has a cross-section shape that is mostly bent concavely to a rear side, thus also creating a voluminous outer shape (cf. FIG. 11E). The hollow-space structure 18k is in particular realized by the concave bend of the material volume body 16k. The material volume body 16k has a cross-section shape that is mostly bent convexly to a front side 30k (cf. FIG. 11E).

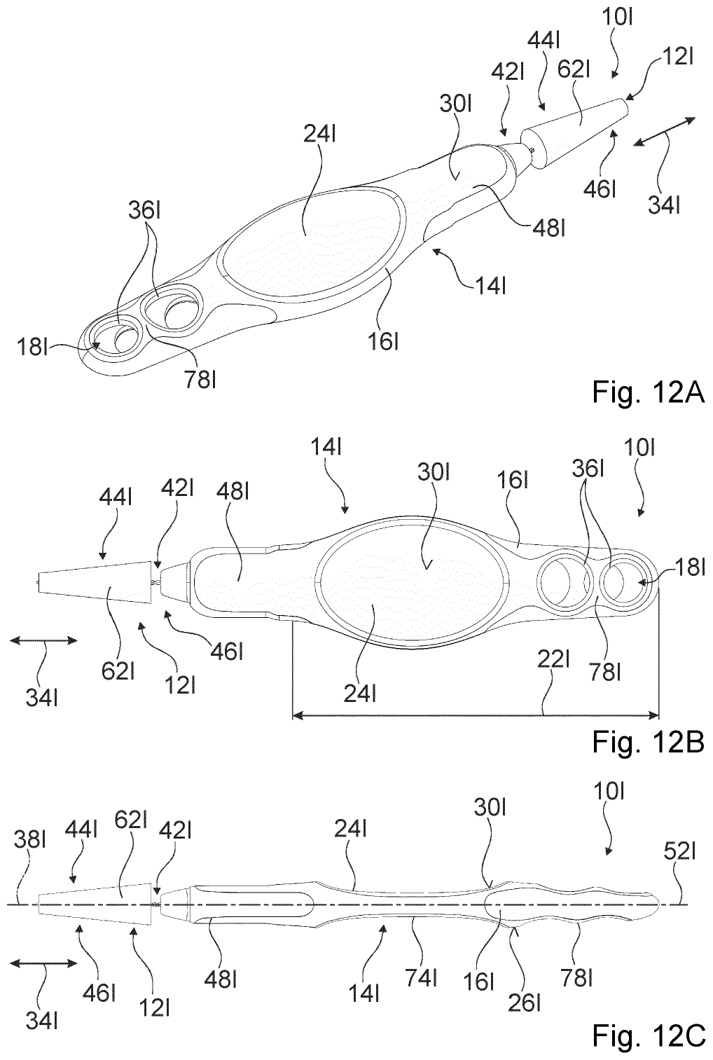

FIGS. 12A and 12B show a front side 30l of an oral hygiene device 10l with an application unit 12l and with a handle unit 14l comprising a material volume body 16l. The oral hygiene device 10l is in the present case embodied as an interdental brush. The handle unit 14l is connected with the application unit 12l. The handle unit 14l and the application unit 12l are implemented in a connected manner. The application unit 12l, realized as a twisted-in interdental brush, is overmolded with the handle unit 14l. The at least one application unit 14l comprises a head region 46l. The head region 46l forms a brush head of the oral hygiene device 10l. The head region 46l in particular comprises a base body that is embodied as a twisted wire, the cleaning elements/bristles being fixed, respectively clamped, between the two wires. For the sake of a better overview, in FIGS. 12A and 12B a cleaning zone 62l is depicted as a volume body.

The handle unit 14l further comprises at least one essential hollow-space structure 18l, which is at least substantially delimited by the material volume body 16l. The hollow-space structure 18l is implemented by a hollow space in the handle unit 14l. In the present case the hollow-space structure 18l is implemented by exactly one hollow space. The hollow-space structure 18l extends over a portion of a main extent 22l of the handle unit 14l. The hollow-space structure 18l extends from a rear end of the handle unit 14l to a thumb-gripping region 24l of the application unit 12l.

In at least one plane parallel to a main extent plane 38l of the handle unit 14l, the hollow-space structure 18l is completely enclosed by the material volume body 16l. In the main extent plane 38l, the hollow-space structure 18l is completely enclosed by the material volume body 16l. In at least one cross section perpendicular to a main extent direction 34l of the handle unit 14l, the hollow-space structure 18l is surrounded by the material volume body 16l. The volume body 16l has a recess 36l via which the hollow-space structure 18l is connected to an environment. The material volume body 16l has several defined recesses 36l. Except for the recesses 36l, the material volume body 16l delimits the hollow-space structure 18l completely. The recesses 36l are implemented in a non-connected manner and respectively have an area of maximally 1.5 cm². The hollow-space structure 18l is arranged in the voluminous portions of the handle unit 14l. The material volume body 16l has a small wall thickness in a region delimiting the hollow-space structure 18l. The recesses 36l have different orientations. The recesses 36l are implemented in a circular shape. On a front side 30l two recesses 36l are arranged. The recesses 36l on the front side 30l have different diameters, wherein a diameter of the recesses 36l increases toward a middle of the handle unit 14l. On a rear side 26l two recesses 36l are arranged. The recesses 36l on the rear side 26l have different diameters, wherein a diameter of the recesses 36l increases toward a middle of the handle unit 14l. The recesses 36l of the front side 30l and of the rear side 26l are arranged offset from one another. The material volume body 16l further comprises a thumb-gripping region 24l. The thumb-gripping region 24l is realized by a concave hollow in the handle unit 14l. A deepening 74l that corresponds to the thumb-gripping region 24l is arranged on the rear side 26l of the oral hygiene device 10l. The recesses 34l are arranged only on a side of the thumb-gripping region 24l that faces away from the application unit 12l. The hollow-space structure 18l extends through the material volume body 16l on a side of the thumb-gripping region 24l that faces away from the application unit 12l.

The recesses 36l of the front side 30l and of the rear side 26l are arranged offset from one another. The recesses 36l, respectively the concavities they cause in the wall of the material volume body 16l, are spaced apart from one another by webs of the material volume body 16l. In the implementation shown, a web is formed on the front side 30l and on the rear side 26l a web is formed as well. After penetrating the wall of the material volume body 16l, the recesses 36l end in the hollow-space structure 18l. The hollow-space structure 18l is open toward the environment via the recesses 36l. In one possible implementation items can be laid into the hollow-space structure 18l.

In the hollow-space structure 18l conically converging transverse ribs (not shown) are arranged, which are oriented transversely to the longitudinal axis 52l. These transverse ribs are caused by the production process.

FIG. 12C shows the implementation of FIGS. 12A and 12B in a view from a side.

In the present case, FIGS. 12A to 12C show an implementation which may be produced in ore or several material components. The marked volumes are realized with a further material component 78l. The further material component 78l forms, on the front side 30l as well as on the rear side 26l, the geometry around the recesses 36l, thus forming a portion of the respective surface. In the thumb-gripping region 24l a deepening 74l with a pass-through opening through the body has been created, through which the further material component 74l is guided from the rear side 26l to the front side 30l. The thumb-gripping region 24l, respectively the deepening 74l with the pass-through opening, is at least partially covered in the further material component 78l.

The further material component 78l may form the webs partly or completely on the rear side 26l between the recesses 36l. Either the further material component 78l can be applied onto a “carrier element” of the volume body 16l or the further material component 78l forms the webs on its own without additional material components.

The oral hygiene device 10l is produced in an injection-molding procedure. The recesses 36l, which are open toward the front side 30l of the oral hygiene device 10l, are formed by conically converging finger elements while the recesses 36l, which are open toward the rear side 26l of the oral hygiene device 10l, are also formed by conically converging finger elements. The finger elements respectively engage into one another in the hollow-space structure 18l and touch each other so as to prevent a flow-through of material, in particular plastic. In the finished oral hygiene device 10l, the mutually touching finger elements form the recesses 36l and the hollow-space structure 18l. A cavity filled with a material, in particular plastic, during production defines the shape of the material volume body 16l of the handle unit 14l.

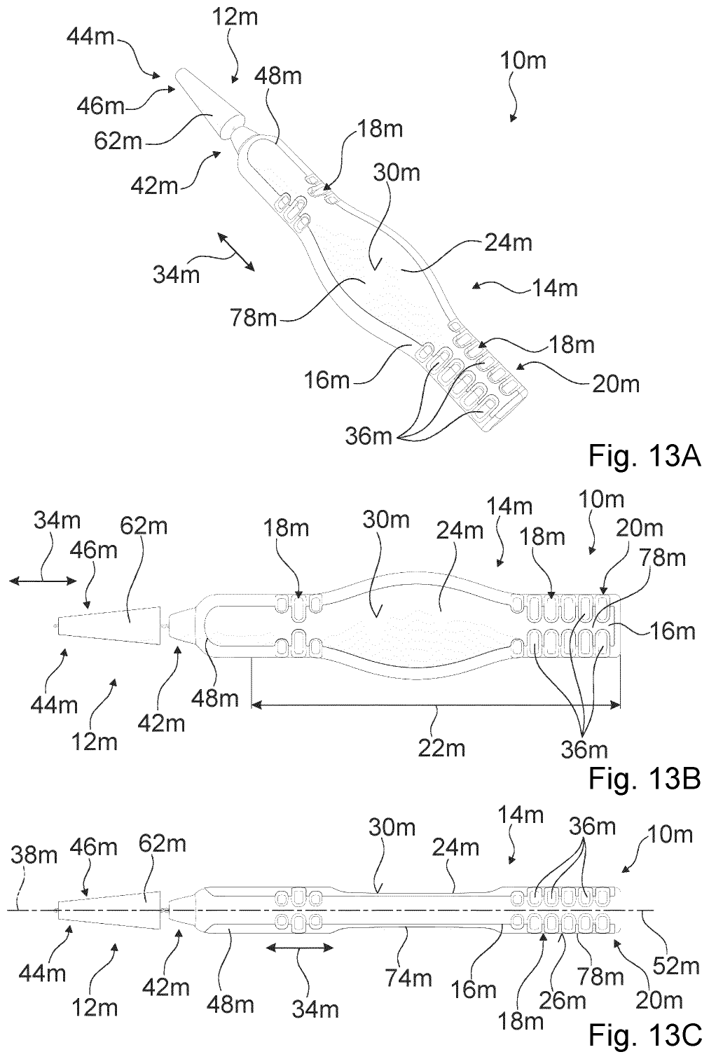

FIGS. 13A and 13B show a further exemplary embodiment. FIG. 13A shows a front side 30m of an oral hygiene device 10m with an application unit 12m and with a handle unit 14m comprising a material volume body 16m. The oral hygiene device 10m is in the present case embodied as an interdental brush. The handle unit 14m is connected with the application unit 12m. The handle unit 14m and the application unit 12m are realized in a connected manner. The application unit 12m, having the form of a twisted-in interdental brush, is overmolded with the handle unit 14m. The at least one application unit 12m comprises a head region 46m. The head region 46m forms a brush head of the oral hygiene device 10m. The head region 46m in particular comprises a base body that is implemented as a twisted wire, the cleaning elements/bristles being fixed, respectively clamped, between the two wires. For the sake of a better overview, in FIGS. 13A and 13B a cleaning zone 62m is depicted as a volume body.

The handle unit 14m further comprises at least one essential hollow-space structure 18m, which is at least substantially delimited by the material volume body 16l and which is composed of individual hollow spaces. The hollow-space structure 18m is implemented by several hollow spaces in the handle unit 14m. In the present case the hollow-space structure 18m is implemented by individual hollow spaces, each of which is formed from a recess 36m. The hollow-space structure 18m extends over a substantial portion of a main extent 22m of the handle unit 14m.

The material volume body 16m further comprises an at least substantially bionic and/or herringbone-patterned structure 20m. The bionic and/or herringbone-patterned structure 20m is formed by different recesses 36m. The recesses 36m are formed both from a front side 30m and from a rear side 26m. The recesses 36m extend into the body from an outside. The recesses 36m in FIGS. 13A and 13B are implemented in a slit-shape. The recesses 36m of the front side 30m and of the rear side 26m are implemented mirror-symmetrically and are respectively situated perpendicularly to the longitudinal axis in a plane. The recesses do not merge into one another. The slit-shaped recesses 36m are oriented perpendicularly to the main extent direction 34m. As a result of this arrangement of the recesses 36m, the stability of the entire body is given despite material saving.

The recesses 36m are furthermore open on the front side 30m as well as on the rear side 26m to the lefthand side or to the righthand side respectively. Therefore sidewise, on the left and on the right at a transition to the front side 30m, respectively to the rear side 26m, there is respectively one contiguous closed portion extending from the underside to the upper side, i. e. to the application unit 12m. Furthermore, on the front side 30m and on the rear side 26m there is respectively one contiguous closed portion extending from the underside to the upper side.

The recesses 36m are preferably formed in the handle unit 14m, and they end in the thumb-gripping region 24m, respectively are not continued into a neck region 48m.

FIG. 13C shows the implementation of FIGS. 13A and 13B in a view from the side.

The bionic and/or herringbone-patterned structure 20m is produced in an injection-molding procedure. The bionic and/or herringbone-patterned structure 20m is produced via cores. The bionic and/or herringbone-patterned structure 20m is demoldable along an axis. Alternatively, 3D printing procedures would also be conceivable for a production.

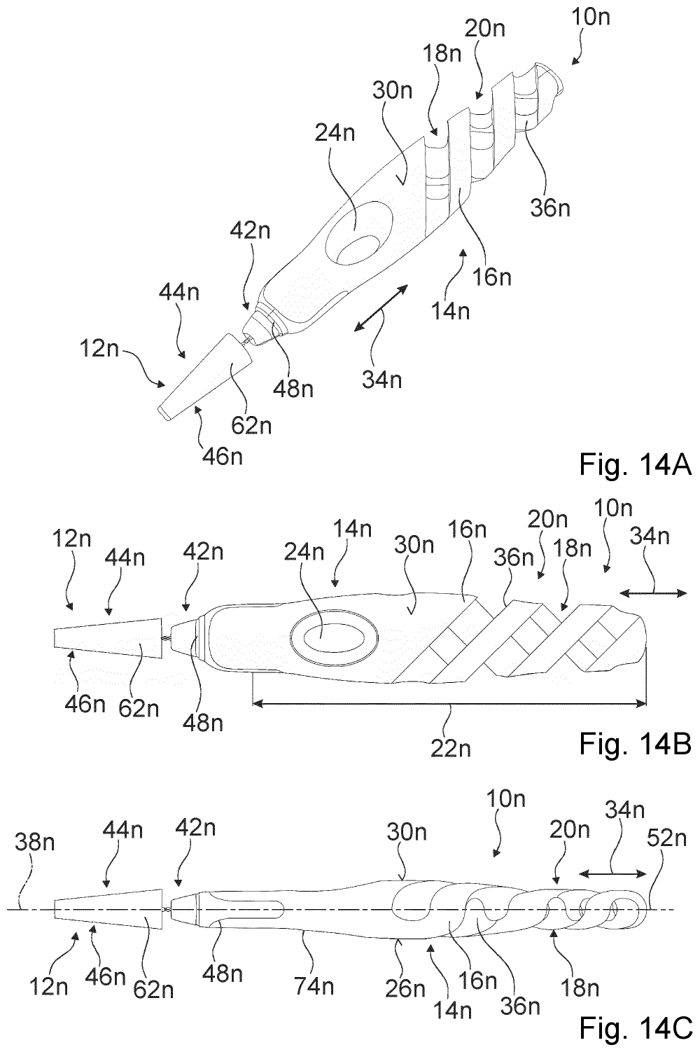

FIGS. 14A and 14B show a further implementation. FIG. 14A shows a front side 30n of an oral hygiene device 10n with an application unit 12n and with a handle unit 14n comprising a material volume body 16n. The oral hygiene device 10n is in the present case embodied as an interdental brush. The handle unit 14n is connected with the application unit 12n. The handle unit 14n and the application unit 12n are implemented in a connected fashion. The application unit 12n, having the form of a twisted-in interdental brush, is overmolded with the handle unit 14n. The at least one application unit 12n comprises a head region 46n. The head region 46n forms a brush head of the oral hygiene device 10n. The head region 46n in particular comprises a base body that is embodied as a bristle carrier. The head region 46m in particular comprises a base body that is embodied as a twisted wire, the cleaning elements/bristles being fixed, respectively clamped, between the two wires. For the sake of a better overview, in FIGS. 14A and 14B a cleaning zone 62n is depicted as a volume body.

The handle unit 14n comprises one or several hollow-space structure/s 18n, which is/are at least substantially delimited by the material volume body 16n. The hollow-space structure 18n is implemented by several hollow spaces in the handle unit 14n. The hollow-space structure 18n extends over a substantial portion of a main extent of the handle unit 14n. The hollow-space structure 18n extends up to a thumb-gripping region 24n of the application unit 12n.

The material volume body 16n further comprises an at least substantially bionic structure 20n. The material volume body 16n comprises a bionic structure 20n. The bionic structure 20n at least partially delimits the hollow-space structure 18n directly. The bionic structure 20n is realized by a continuous recess 36n in the shape of a double helix. The recesses 36n are thus molded from a front side 30n as well as from a rear side 26n. The recesses 36n extend into the body from an outside. The recesses 36n of the front side 30n and of the rear side 26n partly touch each other, thus forming breakthroughs between the front side 30n and the rear side 26n. The slit-shaped recesses 36n are oriented at an angle to a main extent direction, the recesses 36n of the front side 30n and the recesses 36n of the rear side 26n being arranged crosswise with respect to the orientation relative to the main extent direction, in the shape of a double helix.

The recesses 36n are formed in the handle unit 14n and they end in the thumb-gripping region 24n, respectively are not continued into a neck region 48n. Preferably the recesses 36n are formed in the handle unit 14n. In the thumb-gripping region 24n a pass-through opening is implemented, which is shaped in a rounded manner and thus forms the structure for the thumb support.

FIG. 14C shows the exemplary embodiment of FIGS. 14A and 14b in a view from the side.

The bionic structure 20n is produced in an injection-molding procedure. The bionic structure 20n is produced via mutually touching cores. The bionic structure 20n is demoldable along an axis. Alternatively, 3D printing procedures would also be conceivable for a production.

In addition to the discussed hard component, further components may be employed, for example soft components. The soft component may be used, for example, for filling the thumb-gripping region 24n on the surface, thus creating improved haptics in this region.

The soft component may herein be arranged in a deepening and may be guided through said deepening from the front side 30n to the rear side 26n, thus improving haptics on both sides of the thumb-gripping region 24n.

The exemplary embodiments shown in FIGS. 12 to 14 may be produced in a multi-component injection molding. In addition to the discussed hard component, further components may be employed. For example, a soft component may be used. The soft component may fill part of the recesses 36l, 36m, 36n and may exit to the grippable surface, thus changing optic and haptic characteristics of the product. For example, in the implementation of FIGS. 12A and 12B the recesses 36l situated closest to the thumb-gripping region 24l may be filled with a soft component. In this way grippability will be improved and the thumb will lie stably on the product.

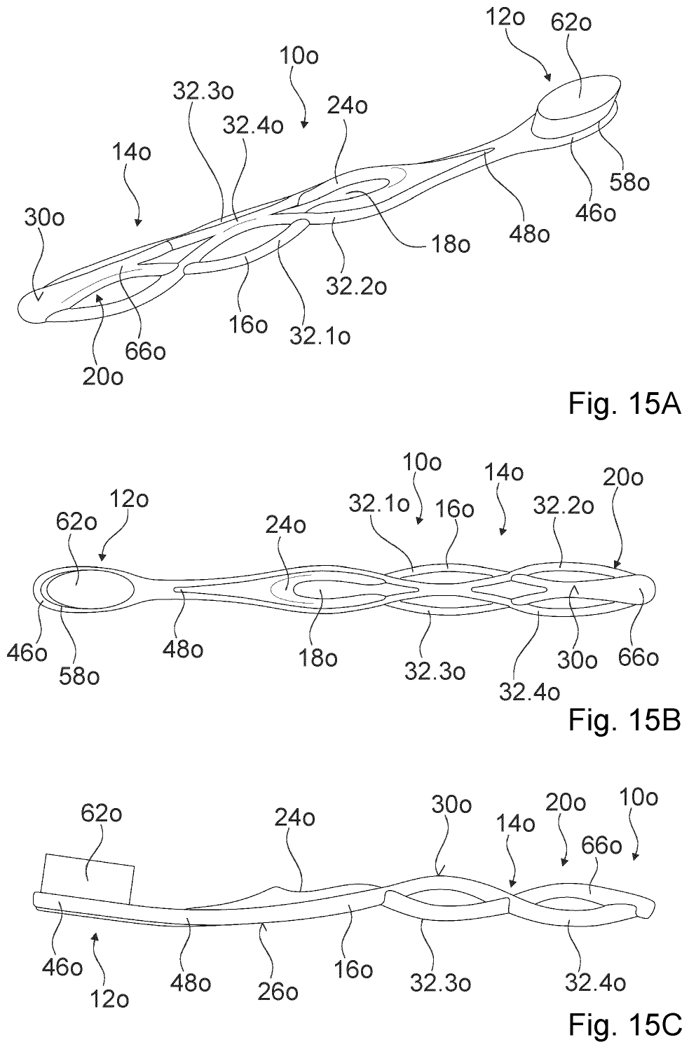

In FIGS. 15A, 15B and 15C a further exemplary embodiment is shown. FIG. 15A shows a front side 30o of an oral hygiene device 10o with an application unit 12o and with a handle unit 14o comprising a material volume boy 16o. The handle unit 14o is connected with the application unit 12o. The handle unit 14o and the application unit 12o are implemented integrally. The at least one application unit 12o comprises a head region 46o. The head region forms a brush head of the oral hygiene device 10o. The head region 46o in particular comprises a base body that is embodied as a bristle carrier. The oral hygiene device 10o further comprises a cleaning zone 62o, which is accommodated in the head region 46o and comprises a plurality of bristle bundles. For the sake of a better overview, in FIGS. 15A to 15C the bristle bundles are depicted schematically as a volume body. On the front side 30o of the head region 46o at least one recess 58o is formed. The at least one recess 58o is configured for receiving individual bristle bundles and/or a bristle platelet comprising bristle bundles.

The handle unit 14b further comprises at least one essential hollow-space structure 18o, which is at least substantially delimited by the material volume body 16o. The hollow-space structure 18o is implemented by one hollow space or several hollow spaces in the handle unit 14o. In the present case the hollow-space structure 18o is implemented by one hollow space. The hollow-space structure 18o extends over a substantial portion of a main extent of the handle unit 14o. The hollow-space structure 18o is realized in a one-part implementation. The hollow-space structure 18o extends to a neck region 48o of the application unit 12o.

The material volume body 16o further comprises an at least substantially bionic structure 20o. The material volume body 16o comprises a bionic structure 20o. The bionic structure 20o at least partially delimits the hollow-space structure 18o directly. The bionic structure 20o is directly adjacent to the hollow-space structure 18o. The bionic structure 20o extends over a substantial portion of the main extent of the handle unit 14o. The bionic structure 20o extends over at least 70% of the main extent of the handle unit 14o. In at least one region the bionic structure 20o comprises at least three strand elements 32.1o, 32.2o, 32.3o, 32.4o which are twisted relative to one another. By way of example, the bionic structure 20n comprises in the rear handle region exactly four strand elements 32.1o, 32.2o, 32.3o, 32.4o which are twisted relative to one another. The bionic structure 20o comprises exactly four strand elements 32.1o, 32.2o, 32.3o, 32.4o which are twisted relative to one another. The strand elements 32.1o, 32.2o, 32.3o, 32.4o form a reticulate structure. The strand elements 32.1o, 32.2o, 32.3o, 32.4o are at least partially intertwined with one another. The strand elements 32.1o, 32.2o, 32.3o, 32.4o partially enclose the hollow-space structure 18o. The strand elements 32.1o, 32.2o, 32.3o, 32.4o are implemented by webs which form an outer envelope of the hollow-space structure 18o. The strand elements 32.1o, 32.2o, 32.3o, 32.4o form an outer envelope of the hollow-space structure 18o. Furthermore, the strand elements 32.1o, 32.2o, 32.3o, 32.4o extend at least partially through the hollow-space structure 18o. The strand elements 32.1o, 32.2o, 32.3o, 32.4o are formed by fine webs having a small cross section. The strand elements 32.1o, 32.2o, 32.3o, 32.4o are oriented substantially along a longitudinal axis of the oral hygiene device 10o. The strand elements 32.1o, 32.2o, 32.3o, 32.4o intersect along the longitudinal direction of the handle unit 14o.

In the thumb-gripping region 24o the strand elements 32.1o, 32.2o, 32.3o, 32.4o are realized such that they form a hollow for the thumb support. For this purpose, viewed from the underside, the strand elements 32.1o, 32.2o, 32.3o, 32.4o diverge and then converge, such that the hollow is formed.

Beyond this a plateau 66o is built into the bionic structure 20o of the material volume body 16o, the plateau 66o being implemented quasi planar between two strand elements 32.1o, 32.4o. The plateau 66o may be used for a lettering or may in particular serve for improving ergonomics, in particular for improved holding. The plateau 66o is arranged at a lower end of the handle unit 14o. The strand elements 32.1o, 32.2o, 32.3o, 32.4o are spaced apart from one another in at least one cross section that is perpendicular to a main extent direction 34o of the handle unit 14o. Furthermore, in at least one cross section that is perpendicular to the main extent direction 34o of the handle unit 14o, the strand elements 32.1o, 32.2o, 32.3o, 32.4o are partially connected to one another. In a rear region the strand elements 32.1o, 32.2o, 32.3o, 32.4o converge, wherein a strand element 32.1o of the lefthand side and a strand element 32.4o of the righthand side converge and form the plateau 66o. The plateau 66o is arranged only on the front side 30o (cf. FIGS. 15A, 15B, 15C).

The bionic structure 20o is produced in an injection-molding procedure. The bionic structure 20o is produced via mutually contacting cores and additional core pullings. The bionic structure 20o cannot be demolded only in one axis, therefore the additional core pullings are necessary. Alternatively, 3D printing procedures would also be conceivable for a production.

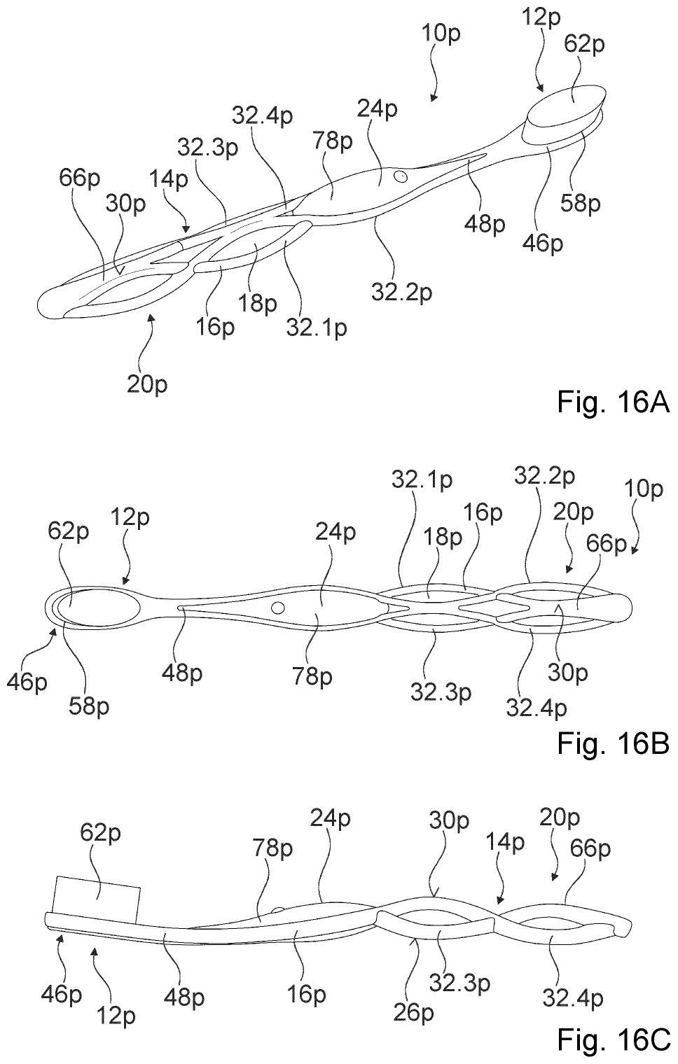

In FIGS. 16A, 16B and 16C a further exemplary embodiment is shown. FIG. 16A shows a front side 30p of an oral hygiene device 10p with an application unit 12p and with a handle unit 14p comprising a material volume body 16p. The handle unit 14p is connected with the application unit 12p. The handle unit 14p and the application unit 12p are implemented integrally. The at least one application unit 12p comprises a head region 46p. The head region 46p forms a brush head of the oral hygiene device 10p. The head region 46p in particular comprises a base body that is embodied as a bristle carrier. The oral hygiene device 10p further comprises a cleaning zone 62p, which is accommodated in the head region 46p and comprises a plurality of bristle bundles. For the sake of a better overview, in FIGS. 16A to 16C the bristle bundles are shown schematically as a volume body. On the front side 30p of the head region 46p at least one recess 58p is formed. The at least one recess 58p is configured for receiving individual bristle bundles and/or a bristle platelet comprising bristle bundles.

The handle unit 14p further comprises at least one essential hollow-space structure 18p, which is at least substantially delimited by the material volume body 16p. The hollow-space structure 18p is implemented by a hollow space or several hollow spaces in the handle unit 14p. In the present case the hollow-space structure 18p is implemented by one hollow space. The hollow-space structure 18p extends over a substantial portion of a main extent of the handle unit 14p. The hollow-space structure 18p is realized in a one-part implementation. The hollow-space structure 18p extends to a neck region 48p of the application unit 12p.

The material volume body 16p further comprises an at least substantially bionic structure 20p. The material volume body 16p comprises a bionic structure 20p. The bionic structure 20p at least partially delimits the hollow-space structure 18p directly. The bionic structure 20p is directly adjacent to the hollow-space structure 18p. The bionic structure 20p extends over a substantial portion of the main extent of the handle unit 14p. The bionic structure 20p extends over at least 70% of the main extent of the handle unit 14p. In at least one region the bionic structure 20p comprises at least three strand elements 32.1p, 32.2p, 32.3p, 32.4p which are twisted relative to one another. By way of example, the bionic structure 20p comprises in the rear handle region exactly four strand elements 32.1p, 32.2p, 32.3p, 32.4p which are twisted relative to one another. The bionic structure 20p comprises exactly four strand elements 32.1p, 32.2p, 32.3p, 32.4p which are twisted relative to one another. The strand elements 32.1p, 32.2p, 32.3p, 32.4p form a reticulate structure. The strand elements 32.1p, 32.2p, 32.3p, 32.4p are at least partially intertwined with one another. The strand elements 32.1p, 32.2p, 32.3p, 32.4p partially enclose the hollow-space structure 18p. The strand elements 32.1p, 32.2p, 32.3p, 32.4p are realized by webs which form an outer envelope of the hollow-space structure 18p. The strand elements 32.1p, 32.2p, 32.3p, 32.4p form an outer envelope of the hollow-space structure 18p. Furthermore, the strand elements 32.1p, 32.2p, 32.3p, 32.4p extend at least partially through the hollow-space structure 18p. The strand elements 32.1p, 32.2p, 32.3p, 32.4p are implemented by fine webs having a small cross section. The strand elements 32.1p, 32.2p, 32.3p, 32.4p are oriented substantially along a longitudinal axis of the oral hygiene device 10p. The strand elements 32.1p, 32.2p, 32.3p, 32.4p intersect along the longitudinal direction of the handle unit 14p.

In the thumb-gripping region 24p, the strand elements 32.1p, 32.2p, 32.3p, 32.4p are overmolded with a further material component 78p, by means of which the thumb support is formed.

Beyond this a plateau 66p is built into the bionic structure 20p of the material volume body 16p, the plateau 66p being implemented quasi planar between two strand elements 32.1p, 32.4p. The plateau 66p can be used for a lettering or may in particular serve ergonomic purposes, in particular for improved holding. The plateau 66p is formed at a lower end of the handle unit 14p. In at least one cross section that is perpendicular to a main extent direction 34p of the handle unit 14p, the strand elements 32.1p, 32.2p, 32.3p, 32.4p are spaced apart from one another. Furthermore, the strand elements 32.1p, 32.2p, 32.3p, 32.4p are partly connected to one another in at least one cross section perpendicular to a main extent direction 34p of the handle unit 14p. The strand elements 32.1p, 32.2p, 32.3p, 32.4p converge in a rear region, wherein a strand element 32.1p of the lefthand side and a strand element 32.4p of the righthand side converge and form the plateau 66p. The plateau 66p is arranged on the front side 30p (cf. FIGS. 16A, 16B, 16C).

The bionic structure 20p is produced in an injection-molding procedure. The bionic structure 20p is produced via mutually contacting cores and additional core pullings. The bionic structure 20p cannot be demolded only in one axis, therefore the additional core pullings are necessary. Alternatively, 3D printing procedures would also be conceivable for a production.

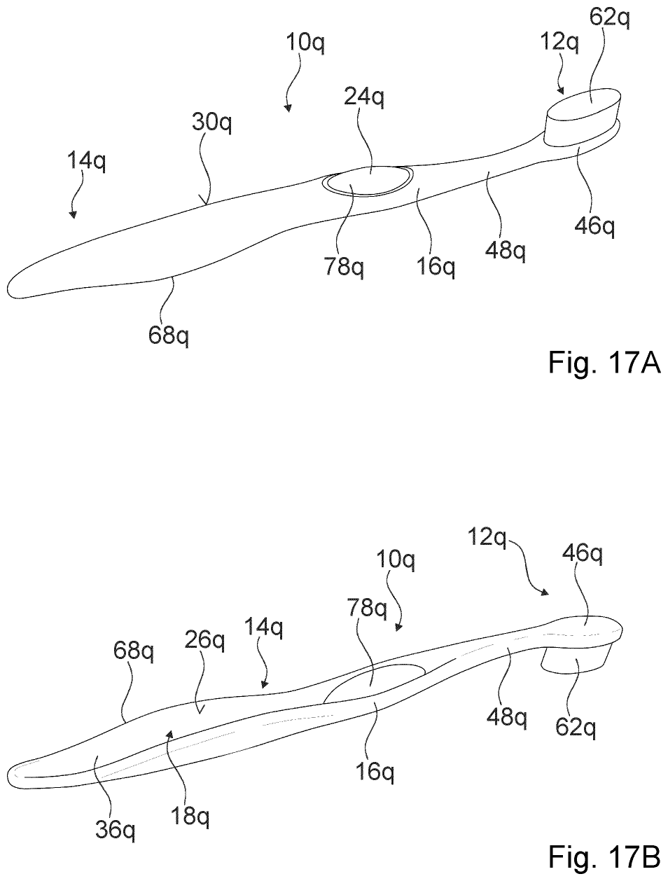

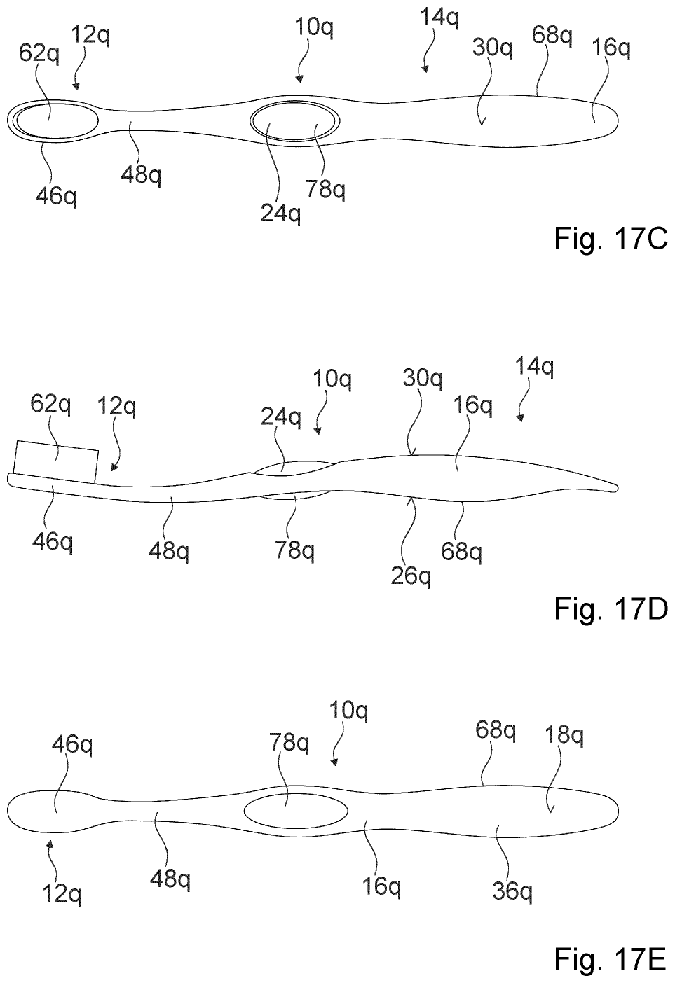

FIGS. 17A and 17E show a front side 30q of an oral hygiene device 10q with an application unit 12q and with a handle unit 14q comprising a material volume body 16q.

The handle unit 14q is connected with the application unit 12q. The handle unit 14q and the application unit 12q are implemented integrally. The at least one application unit 12q comprises a head region 46q. The head region 46q forms a brush head of the oral hygiene device 10q. The head region 46q in particular comprises a base body that is embodied as a bristle carrier. The oral hygiene device 10q further comprises a cleaning zone 62q, which is accommodated in the head region 46q and comprises a plurality of bristle bundles. For the sake of a better overview, in FIGS. 17A to 17E the bristle bundles are depicted as a volume body. On the front side 30q of the head region 46q at least one recess is formed. The at least one recess is configured for receiving individual bristle bundles and/or a bristle platelet comprising bristle bundles.

The handle unit 14q further comprises at least one essential hollow-space structure 18q, which is at least substantially delimited by the material volume body 16q. The hollow-space structure 18q is implemented by a hollow space in the handle unit 14q. In the present case the hollow-space structure 18q is implemented by exactly one hollow space. The hollow-space structure 18q extends over a substantial portion of a main extent of the handle unit 14q. The hollow-space structure 18q extends from a rear end of the handle unit 14q to a thumb-gripping region 24q of the application unit 12q.

The hollow-space structure 18q is enclosed by the material volume body 16q. The material volume body 16q comprises recesses 36q, which are offset all around and which enter the hollow-space structure 18q from an outside. The volume body 16q comprises at least one recess 36q via which the hollow-space structure 18q is connected to an environment. With the exception of the recesses 36q, the material volume body 16q delimits the hollow-space structure 18q completely. The hollow-space structure 18q is arranged in the voluminous portions of the handle unit 14q. The material volume body 16q has a small wall thickness in a region delimiting the hollow-space structure 18q. The material volume body 16q further comprises a thumb-gripping region 24q. The thumb-gripping region 24q is formed by a further material component 78q, which is part of the handle unit 14q. The further material component 78q is implemented extending through the material volume body 16q.

The body is produced in an injection-molding procedure/multi-component injection-molding procedure. Alternatively, 3D printing procedures would also be conceivable for a production.

The implementation variant according to FIGS. 17A to 17E may also be realized with one or several further material component/s 78q. For example, a soft component may fill a portion of the hollow-space structure 18q, exiting through breakthroughs to the surface of the front side 30q of the handle unit 14q. Herein, for example, a spherical closure can be created, which brings certain haptic characteristics onto the surface. In this way it is possible, for example, to provide improved haptics in the thumb-gripping region 24q.

The material volume body 16q comprises at least one thumb-gripping region 24q, wherein the hollow-space structure 18q is at least substantially open toward a rear side that faces away from the thumb-gripping region 24q. Preferably, in a plane that is perpendicular to the main extent direction of the handle unit 14q, the material volume body 16q engages around the hollow-space structure 18q at least substantially in a C shape. A volume of the hollow-space structure 18q is in particular larger than a volume of the material volume body 16q, wherein in particular in each point of the hollow-space structure 18q there is an imaginary straight line through the point, which goes through the material volume body 16q, then through the point and then once more through the material volume body 16q. The material volume body 16q is in particular realized in a thin-walled fashion. The material volume body 16q is in particular shaped like a bent plate. Preferably the material volume body 16q is produced in an injection-molding procedure. The material volume body 16q is in particular implemented by a type of plate that is bent. The bend is in particular transverse to the longitudinal axis of the handle unit 24q. The material volume body 16q in particular has a mostly bent cross-section area, such that a voluminous outer shape is created. Preferentially the material volume body 16q is in particular recessed from behind, the recess 36q being formed by the hollow-space structure 18q. The hollow-space structure 18q is in particular implemented by the bend of the material volume body 16q. However, the head region 46q of the application unit 12q is preferably implemented as a solid body, in particular for bristle fixing in an anchor punching or for welding.

Furthermore, the material volume body 16q in particular has a stabilizing rim 68q at a free edge. The rim 68q may in particular have a greater material thickness than the remaining material volume body 16q. The material volume body 16q in particular has a thin wall thickness. The thin wall thickness in particular extends into the neck region 48q of the application unit 12q. The thin wall thickness is, for example, brought about by recesses 36q on the rear side.

On a side facing away from the at least one thumb-gripping region 24q, the material volume body 16q forms a substantially concave receiving region which delimits the hollow-space structure 18q. The material volume body 16q in particular has a cross-section shape that is mostly bent concavely to a rear side, thus also creating a voluminous outer shape (cf. FIG. 17E). The hollow-space structure 18q is in particular implemented by the concave bend of the material volume body 16q. The material volume body 16q has a cross-section shape that is mostly bent convexly to a front side 30q (cf. FIG. 17E).

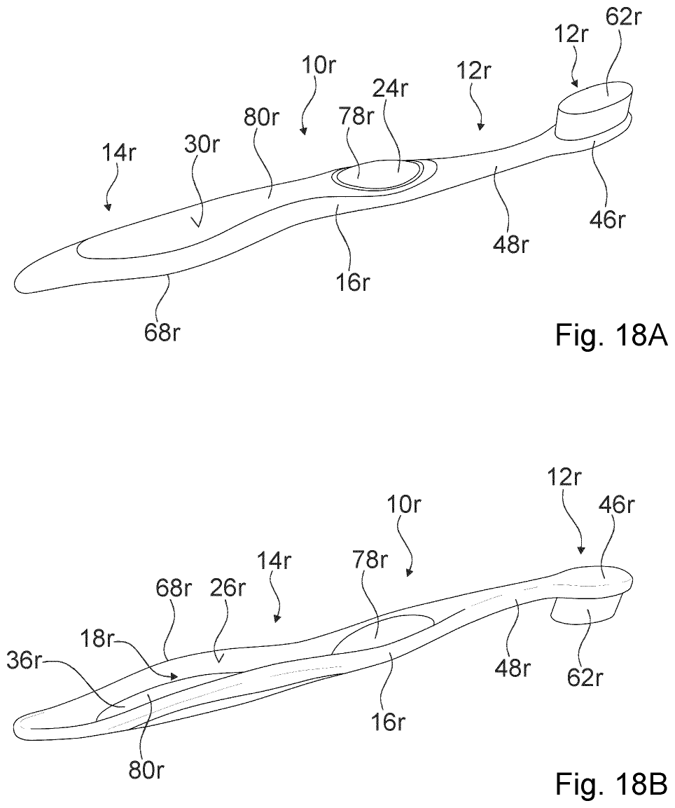

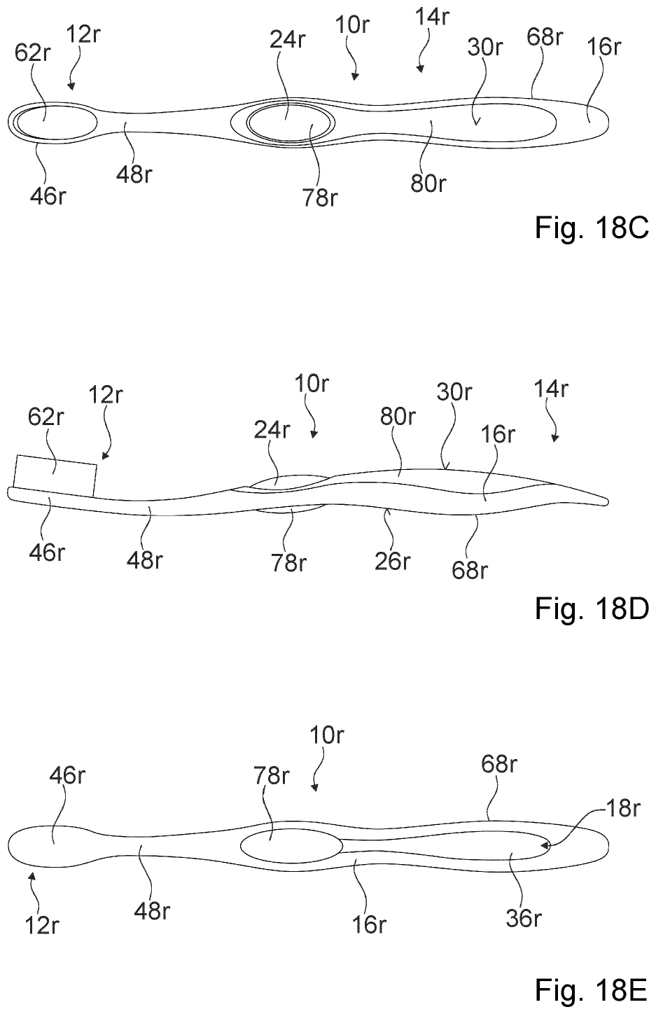

FIGS. 18A and 18E show a front side 30r of an oral hygiene device 10r with an application unit 12r and with a handle unit 14r comprising a material volume body 16r. The handle unit 14r is connected with the application unit 12r. The handle unit 14r and the application unit 12r are implemented integrally. The at least one application unit 12r comprises a head region 46r. The head region 46r forms a brush head of the oral hygiene device 10r. The head region 46r in particular comprises a base body that is implemented as a bristle carrier. The oral hygiene device 10r further comprises a cleaning zone 62r, which is accommodated in the head region 46r and comprises a plurality of bristle bundles. For the sake of a better overview, in FIGS. 18A to 18E the bristle bundles are shown as a volume body. On the front side 30r of the head region 46r at least one recess is formed. The at least one recess is configured for receiving individual bristles and/or a platelet comprising bristle bundles.

The handle unit 14r further comprises at least one essential hollow-space structure 18r, which is at least substantially delimited by the material volume body 16r. The hollow-space structure 18r is implemented by a hollow space in the handle unit 14r. In the present case the hollow-space structure 18r is implemented by exactly one hollow space. The hollow-space structure 18r extends over a substantial portion of a main extent of the handle unit 14r. The hollow-space structure 18r extends from a rear end of the handle unit 14r to a thumb-gripping region 24r of the application unit 12r.

The hollow-space structure 18r is enclosed by the material volume body 16r. The material volume body 16r comprises recesses 36r, which are offset all around and which enter the hollow-space structure 18r from an outside. The volume body 16r comprises at least one recess 36r via which the hollow-space structure 18r is connected to an environment. With the exception of the recesses 36r, the material volume body 16r delimits the hollow-space structure 18r completely. The hollow-space structure 18r is arranged in the voluminous portions of the handle unit 14r. The material volume body 16r has a small wall thickness in a region delimiting the hollow-space structure 18r. The material volume body 16r further comprises a thumb-gripping region 24r. The thumb-gripping region 24r is implemented by a further material component 78r, which forms part of the handle unit 14r. The further material component 78r is implemented extending through the material volume body 16r. Beyond this, the material volume body 16r comprises a further—in the present case third—material component 80r around the thumb-gripping region 24r.

The body is produced in an injection-molding/multi-component injection-molding procedure. Alternatively, 3D printing procedures would also be conceivable for a production.

The implementation variant according to FIGS. 18A to 18E may also be realized with one or several further material component/s 78r, 80r. For example, a soft component may fill part of the hollow-space structure 18r, exiting to the surface of the front side 30r of the handle unit 14r through breakthroughs. Thus, for example, a spherical closure may be created which brings certain haptic characteristics to the surface. In this way, for example, improved haptics may be created in the thumb-gripping region 24r.

The material volume body 16r comprises at least one thumb-gripping region 24r, wherein the hollow-space structure 18r is at least substantially open toward a rear side that faces away from the thumb-gripping region 24r. Preferably, in a plane that is perpendicular to the main extent direction of the handle unit 14r, the material volume body 16r engages around the hollow-space structure 18r at least substantially in a C-shape. A volume of the hollow-space structure 18r is in particular larger than a volume of the material volume body 16r, wherein in each point of the hollow-space structure 18r there is an imaginary straight line through the point, which goes through the material volume body 16r, then through the point and after that goes once more through the material volume body 16r. The material volume body 16r is in particular implemented in a thin-walled fashion. The material volume body 16r is in particular shaped like a bent plate. Preferably the material volume body 16r is produced in an injection-molding procedure. The material volume body 16r is in particular implemented by a type of plate which is bent. The bend is in particular substantially transverse to the longitudinal axis of the handle unit 14r. The material volume body 16r in particular has a mostly bent cross-section shape, such that a voluminous outer shape is created. Preferentially, the material volume body 16r is in particular recessed from behind, the recess 36r being implemented by the hollow-space structure 18r. The hollow-space structure 18r is in particular formed by the bend of the material volume body 16r. However, the head region 46r of the application unit 12r is preferably realized as a solid body, in particular for a bristle fixing in anchor punching or for welding. The material volume body 16r furthermore in particular has a stabilizing rim 68r at a free edge. The rim 68r may in particular have a greater material thickness than the remaining material volume body 16r. The material volume body 16r in particular has a thin wall thickness. The thin wall thickness in particular extends into a neck region 48r of the application unit 12r. The thin wall thickness is, for example, brought about by recesses 36r on the rear side.

On a side facing away from the at least one thumb-gripping region 24r, the material volume body 16r forms a substantially concave receiving region which delimits the hollow-space structure 18r. The material volume body 16r in particular has a cross-section shape that is mostly bent concavely to a rear side, thus also creating a voluminous outer shape (cf. FIG. 18E). The hollow-space structure 18r is in particular implemented by the concave bend of the material volume body 16r. The material volume body 16r has a cross-section shape that is mostly bent convexly to a front side 30r (cf. FIG. 18E).

The descriptions provided for specific figures are of course also transferable to other figures showing the same or similar implementation and in which such implementations are not described in such detail.

### REFERENCE NUMERALS

10 oral hygiene device

12 application unit

14 handle unit

16 volume body

18 hollow-space structure

20 structure

20.1 sub-structure

20.2 sub-structure

22 main extent

24 thumb-gripping region

26 rear side

28 receiving region

30 front side

32.1 strand element

32.2 strand element

32.3 strand element

32.4 strand element

32.5 strand element

32.6 strand element

32.7 strand element

32.8 strand element

32.9 strand element

32.10 strand element

34 main extent direction

36 recess

38 main extent plane

40 predetermined separation point

42 subregion

44 subregion

46 head region

48 neck region

50 bristle load direction

52 longitudinal axis

54 height axis

56 width axis

58 recess

60 gripping surface

62 cleaning zone

64 platform

66 plateau

68 rim

70 longitudinal web

72 projection

74 deepening

76 shape-separation line

78 further material component

80 further material component

1. An oral hygiene device with at least one application unit and with at least one handle unit which is connected to the application unit and which comprises at least one material volume body,
wherein
the handle unit comprises at least one essential hollow-space structure, which is at least substantially delimited by the material volume body and which extends at least over a substantial portion of a main extent of the at least one handle unit.

2. The oral hygiene device according to claim 1,
wherein
the material volume body has an at least substantially bionic structure, which at least partially delimits the hollow-space structure directly.

3. The oral hygiene device according to claim 1, wherein,
the material volume body has an at least substantially bionic structure extending at least over a substantial portion of a main extent of the at least one handle unit.

4. The oral hygiene device according to claim 1, wherein
the material volume body has an at least substantially bionic structure which is formed by a lattice structure.

5. The oral hygiene device according to claim 1, wherein
the material volume body comprises at least one thumb-gripping region, wherein the hollow-space structure is at least substantially open toward a rear side that faces away from the thumb-gripping region.

6. The oral hygiene device according to claim 5,
wherein
the material volume body forms, on a side facing away from the at least one thumb-gripping region, a substantially concave receiving region which delimits the hollow-space structure.

7. The oral hygiene device according to claim 5,
wherein
the hollow-space structure is at least substantially closed on a front side facing toward the thumb-gripping region.

8. The oral hygiene device according to claim 1, wherein
the material volume body engages around the hollow-space structure in a plane that is perpendicular to the main extent direction of the handle unit at least substantially in a C shape.

9. The oral hygiene device according to claim 1, wherein
the material volume body is realized in a thin-walled fashion, wherein a substantial portion of the material volume body is realized with a substantially uniform wall thickness.

10. The oral hygiene device according to claim 1, wherein
a volume of the hollow-space structure is larger than a volume of the material volume body.

11. The oral hygiene device according to claim 1, comprising
a center of gravity that is situated, measured from the underside, at 40% to 70% of the total length of the oral hygiene device.

12. The oral hygiene device according to claim 1, wherein
the material volume body has an at least substantially bionic structure comprising in at least one region at least three strand elements which are twisted relative to one another.

13. The oral hygiene device according to claim 12,
wherein
the at least three strand elements are spaced apart from one another in at least one cross section that is perpendicular to a main extent direction of the handle unit.

14. The oral hygiene device according to claim 1, wherein
in at least one cross section that is perpendicular to a main extent direction of the handle unit, the hollow-space structure is surrounded by the material volume body, the volume body having at least one recess via which the hollow-space structure is connected to an environment.

15. The oral hygiene device according to claim 1, wherein
in in at least one plane that is parallel to a main extent plane of the handle unit, the hollow-space structure is completely surrounded by the material volume body.

16. An oral hygiene device with at least one application unit and with at least one handle unit which is connected to the application unit and which comprises at least one material volume body, wherein
the material volume body of the handle unit is implemented at least to a large extent of a bio-degradable material and/or of a recycled material.

17. The oral hygiene device according to claim 16, wherein
the material volume body of the handle unit is implemented at least to a large extent of a plastic that is based on renewable materials.

18. An oral hygiene device with at least one application unit and with at least one handle unit which is connected to the application unit and which comprises at least one material volume body, comprising
at least one first material and at least one second material that is different from the first material, wherein the second material is configured to be at least partly separated from the first material.

19. The oral hygiene device according to claim 18, comprising
at least one predetermined separation point for a separation of at least one subregion with the first material, from a subregion with the second material.

20. The oral hygiene device according to claim 18, wherein
the application unit comprises at least one head region and at least one neck region, wherein the predetermined separation point is arranged in the neck region and is configured for a separation at least of the handle unit from the head region of the application unit.

21. The oral hygiene device according to claim 18, wherein
the predetermined separation point is implemented by a predetermined breaking point, which is configured to break in case of a defined load of the application unit against a bristle load direction of the application unit.

22. The oral hygiene device according to claim 18, wherein
the predetermined separation point is implemented by a marking of an intended separation point.
